(19) United States
(12) Patent Application Publication
(10) Pub. No.: US 2015/0242525 A1
(43) Pub. Date: Aug. 27, 2015

(54) SYSTEM FOR REFERRING TO AND/OR EMBEDDING POSTS WITHIN OTHER POST AND POSTS WITHIN ANY PART OF ANOTHER POST

(71) Applicant: Pixured, Inc., Zephyr Cove, NV (US)

(72) Inventor: Nick John Perlegos, Zephyr Cove, NV (US)

(21) Appl. No.: 14/592,239

(22) Filed: Jan. 8, 2015

Related U.S. Application Data
(60) Provisional application No. 61/966,645, filed on Feb. 26, 2014.

(51) Int. Cl. G06F 17/30; H04L 12/58; G06N 7/00

(52) U.S. Cl. CPC G06F 17/30893; G06N 7/005; H04L 51/32; G06F 17/30864

(57) ABSTRACT

A computer implemented system and method uses real time interaction of information relating to digital media, people, communities, organizations and things. A database stores a plurality of digital media items each having associated data relating to features of the item. A user device accesses the system or an application program interface (API) that creates a bridge with the system. The user device or API identifies features of the accessed digital media to determine associated data relating to the features of the accessed digital media. This includes comparing information and data with data of the stored digital media items to identify associations between the accessed digital media with data of the stored digital media items, and defining associated digital media items. The system finds and associates information with other information relating to digital media, people, communities, organizations and things and returns information through an API or to a user device.

### BACKROUND OF THE INVENTION

The present inventions relates to a system for embedding the manipulation or addition of information, digital media and/or data to tags and posts. Users interacting with the system disclosed will be able to identify (locate) and embed information, digital media, and/or data (using the system or various API) to tags within posts and tags within tags.

Advancements relating to the web and mobile are making it more possible for people to be attached and connected to the surrounding world, choosing various levels of impact to be actively social throughout the web and world. The disclosed system allows for users to find meaningful information, photos can be taken and shared from anywhere with information traveling faster and becoming more reliable. Users who take photos or view photos with the said invention embark on a very unique experience, taking what a photo says (photo is a thousand words) the meaning, the feelings, the experience of the past (the photo), and redefining how the photo associates with users supporting and producing additional meaning/value to users. These photos make it simpler for users to express themselves while sharing towards new means of communication. The disclosed system also makes use of videos, sound, links, objects, locations, proximity whereby embedding to posts and tags.

While there are many applications where the present invention could be implemented, this invention would be used to create a platform that users and business can use while also providing additional resources that allow developers and advertisers to expand the use and implement development tools into their own technologies.

### SUMMARY OF THE INVENTION

The system relates to a computer implemented embedding the manipulation or addition of information to digital media, posts and tags, comprising of a method relating to a database system storing a plurality of digital media items each having associated digital data relating to features of the digital media item. The system can also make use of a social graphs of users, posts, tags and digital media.

In some embodiments, a user device accessing digital media; the user device, in operative collaboration with the database, identifying one or more features of the accessed digital media to determine associated digital data relating to the features of the accessed digital media; comparing digital data of the accessed digital media with digital data of the stored digital media items to identify associations between the accessed digital media with digital data of the stored digital media items, defining associated digital media items; the database system retrieving the associated digital media items and generating buttons and/or features relating to digital data for the associated digital media items; and transmitting associated digital media items and /or the related buttons and features to the user device.

There is disclosed in accordance with another aspect of the invention, a computer system comprising a database system storing a plurality of digital media items each having associated digital data relating to features of the digital media item. User devices can accesses digital media while also, in operative collaboration with the database system, identifies one or more features of the accessed digital media to determine associated digital data relating to the features of the accessed digital media. This includes comparing digital data of the accessed digital media with digital data of the stored digital media items to identify as associations between the accessed digital media with digital data of the stored digital media items, defining associated digital media items. The database system retrieves the associated digital media items and generating buttons and/or features relating to digital data for the associated digital media items and transmits the associated digital media items and /or the related buttons and features to the user device.

For some, a common problem (for retailers) is how to get customers and people to locate or find more information about the product (maybe seen on a billboard or magazine) or even how to buy the product creating barriers and ineffective ways to advertise. Further features and advantages will be readily apparent from the following description and drawings.

### BRIEF DESCRIPTION OF THE DRAWINGS

Any references with the following drawings as well as additional embodiments thereof, with like references numerical refer to corresponding parts of figures.

FIG. 1 illustrates a method for showing digital data to users and communication through networks.

FIG. 2A is a block diagram illustrating a system communicating or in network with other platforms providers and content.

FIG. 2B is a block diagram illustrating the system in greater detail.

FIG. 2C illustrates a user device couple to one or more networks and components.

FIG. 3 illustrates a simple representation of the system for the web

FIG. 4 illustrates user devices.

FIG. 5A illustrates a user coupled to one or more posts.

FIG. 5B illustrates a simple representation of posts.

FIG. 5C and FIG. 5D illustrates a cross comparison between posts, other naming of items similar to posts performed by users or the system.

FIG. 5E illustrates the coupling of posts, post generated from other posts, posted generated by any part of a post and shares.

FIG. 6A-FIG. 6C illustrate posts linking to other posts and other users.

FIG. 6D illustrates relationships between posts in a system.

FIG. 6E illustrates relationships between tags in a system.

FIG. 6F illustrates relationships between retags in a system.

FIG. 7A illustrates in some embodiments where users can create original tags, add tags with content to tags and text to tags.

FIG. 7B illustrates a similar embodiment to FIG. 7A with the added embodiment of a user adding content (and/or digital media and data) to any or any part of digital media.

FIG. 7C illustrates a flow chart where in some embodiments a user can create posts aided by the disclosed invention.

FIG. 7D illustrates a flow chart where in some embodiments a user can create posts, creates posts referring to or embedded in any or any part of a digital media or content within a post.

FIG. 7E Illustrates one embodiment where a user post at least one photo, document, object, illustration, video, sound, or anything else.

FIG. 7F illustrates a system where one embodiment shows a post coupled by one or more tags by one or more users.

FIG. 8A-FIG. 8G in some embodiments illustrates visually how users and servers process information.

FIG. 9A illustrates objects that are part of the system, these objects are created by one or more users and generated automatically by the system.

FIG. 9B is a diagram that shows an object that is coupled within a system to another object whereby objects acts as a parent class for the child class post.

FIG. 9C illustrates a system that analyzes various tags, tags of tags, retags posts and objects.

FIG. 9D illustrates how any number of objects, tags, posts, can have relationships to and from one or more and combination of other posts, tags objects and retags that are and are not coupled.

FIG. 9E illustrates one or more posts within a system where posts, data, users, objects, digital media, content, tags, and links may be represented with relationships.

FIG. 10A illustrates a post with a series of tags, tags of tags, and retags from a plethora of users.

FIG. 10B illustrates possible relationships formed by tags and retags or formed by coupled posts.

FIG. 10C shows one or more embodiments relating to proximity or location.

FIG. 10D illustrates Posts, tags, retags, and tags of tags relating to one or more objects.

FIG. 10E illustrates a user querying the system for results.

FIG. 11 shows a screen shot of an image and a user interface.

FIG. 12A illustrates advertisements coinciding with posts, objects, tags, apps, and other user actions.

FIG. 12B illustrates methods for creating posts within digital media that may act as advertisements.

FIG. 12C illustrates from a user device embodiments used by the system to track analytics, nearby items with deals, of a promotion.

FIG. 13A-FIG. 13B illustrates real-life examples where the said invention is used by users.

FIG. 14A illustrates viewpoint like a sphere where a user is freely able to explore the entire scene all around.

FIG. 14B illustrates a panoramic image viewable from a user device on mobile or computer.

FIG. 14C illustrates a viewpoint from one eye of a user at a popular location like a mall.

FIG. 14D illustrates a viewpoint displayed on a user device that is in common use.

FIG. 15A-FIG. 15E illustrates from a user device an interactive way for user to view publications or content like magazines, newspapers, brochures and similar.

FIG. 16 illustrates an image on a user device illustrating the user interface.

FIG. 17A illustrates a school setting where students can view problems from a user device.

FIG. 17B illustrates a situation of a slide show or presentation, more specifically aided by the user interface.

FIG. 17C-FIG. 17E could illustrate various examples aided by the system disclosed.

FIG. 18A-FIG. 18B illustrates an example of the system being used between users for messaging.

FIG. 19A illustrates an example of the system and user interface from a user device, where one or more images can be shown to a user that contain information not immediately shown to the user.

FIG. 19B further illustrates the example of FIG. 19A where by selecting regions a popup dialogue windows appears or another user interface activity.

FIG. 20A-FIG. 20B illustrates how a user in embodiments may view one or more posts within digital media like video, motion pictures, and clips.

FIG. 20C illustrates how a user in some embodiments can define a region within a video.

FIG. 21 illustrates how a web site can user meta-tags or meta elements.

### DETAILED DESCRIPTION OF THE INVENTION

The embodiments disclosed below is/are not intended to be exhaustive or limit the invention to the precise form disclosed in the following detailed description. Rather, the embodiment is chosen and described so that others skilled in the art may utilize its teachings.

This application describes a method for creating and/or embedding or referring one or more posts and tags to digital media (photo, albums, video), documents, posts, objects and users, shared with the system whereby further comprising of users where the method adds ease, convenience, and enhanced results (or relationships) to mobile devices, PC's, websites, social networks, third party platforms and databases. Adding, creating and/or embedding one or more posts and/or tags to a digital media may include methods like automatic recognition software, user selection from a person/persons, or information derived by social networks, and not limiting to other methods that regions within digital media may be identified. In some embodiments a business or place where a user will be able (when applies) to have features that call, linking via email, messages, social networks, sharing, search and location. In some embodiments the invention is to help find things faster and in context. In some examples a business can communicate with the disclosed invention or aided by other tools, effectively and consumers can find what they want, while also displaying a banner to their profile for upcoming events, sales, and product lines to also be easily found. The method may further include deals or advertisement that users may take advantage of.

The system in some embodiments include methods that may also include calculating a rating, price, relationship and/or answer to a request with or without data and/or information from a social entity and/or objects. The system may include products, services, applications, solutions, digital media, digital data, and/or data may in some embodiments relate to traits/categories, proximity, habits, insight, ideal prospects, attributes, behaviors, topic, interest, keywords, remarketing, education, work place, origin, location targeting, demographics, adaptive profiling, participation, feeds, trends, postings, photos, blogs, topics, stories, advertisements, comments, current ratings, ownership, values are determined from the identified and/or selected associations of one more users, groups, digital data and/or digital media. In some embodiments include timing components. The system and said method may implement distribution (Gaussian, logistic, lognormal, Weibull), likelihood functions, Bayesian inference and/or timing (decay function) to calculating and/or determine a rating, machine learning, price and/or answer based on multiple variables aided by social ranking. In some embodiments a combinations of and multi-deviations of implemented distribution (Gaussian, logistic, lognormal, Weibull), likelihood functions, Bayesian inference and/or timing. In some embodiments the system may also use SVM (support vector machine) that include various learning models and/or algorithms that analyze data and recognize patterns that are commonly uses for regression analysis. Other examples include approaches like node wise similarities analysis, pattern based approaches additionally the value and/or generated distributions or values (including) variations providing simplified objects or values. In some embodiments include using calculated and/or mathematical techniques to analyze and/or display variables, digital media, data and information. Social networks provide a number of ways to analyze social ranking whereby the said method enlists code to perform operations and analysis while also data relating to values, ranking and scores. The system may include embodiments that calculate the probability that a user or where the user would like and/or relate to and may be within one or more standard deviation and/or deviations (may comprise to include a mean) which may include products, services, applications, solutions, digital media, digital data, and/or data. A user's digital media may be analyzed to determine a user preference from the collected data and information; our method and apparatus may add value, where storing data for a users actual identity or an anid/criptic id. Most if not all, transmission outside our plafform will be a cryptic representation of the user. All information and data may be stored on a remote database or local storage. A very basic example (in coding language python) of user information could in some embodiments contain part of the following code:

class PixuredUser(Document):

user_id = StringField(max_length=50, min_length=6,

required=True, unique = True )

```
password = StringField(required=True) #user login password
  email = EmailField(required=True, unique = True)
  created = DateTimeField( )
  status = ReferenceField(PixuredUserStatus)
  first_name = StringField(max_length=120, required=True)
```

The search is not limited to photos any user input and past interaction with the disclosed invention could be used in search query through the communication network to locate and present the most accurate information to users on their user devices. From the search it can match one or more logos, people, items, objects, locations, signs, landscape, time of day, from the photo and user imputed data, where processing the information and present the user with accurate expandable knowledge to enhance the possibilities with respects to everything within the photo (digital media). Digital data may not be displayed on the first screen so features do not create a nuisance to the user by getting in the way of the user. In some embodiments buttons may be displayed similar to a banner defined by preferences. Features are described throughout the invention. A user may connect with the system via none touch interaction where the UI would be presented with a pop up screen with a list of options for the user. If available location services of the recognized area, this could be a static or live location of the recognized area, feature may connect with many other popular features like internet based maps to provide mapping of the area. Sharing the recognized area of a person, business, restaurant, place, object, (etc.) with communication network involves sharing with emailing, short message service (SMS), chat, social networks, and people within contacts of the phone or relative. All of which can be shared with or of the recognized area. Additional user may also be provided with features made possible by the disclosed software and application. Users may be presented with deals, offers, advertisements, and additional information. These features may also be extended through the communication network to the user device, with the addition of other applications and platforms. Users may edit, copy, share, communicate, change one or more items made available to the said user. In some embodiments, the effects on the network and collected data, may be defined as user profile to show the changes and updates, updating data throughout our network for viable data based regarding large amounts of data, values and weights; efficiency throughout our network, where distant social connection may take longer to update than adjacent or nearby social web connections, including advertisements and where deals help friends (or followers help followers) receives deal and or save. Business may offer features that can provide and link to the storefront page, or any other ecommerce site that the business is associated with. User, businesses and entities may provide objects to sell while also searching a database of items the business sells, while also showing items that are localized and sold by a particular seller, providing a link or location where users may find out more or buy products.

Embodiments may be displayed through a third party website the advertisement that was found on a third party website and provided by an advertiser through the system platform or another platform or system. Additionally the advertiser may offer compensation for some or any part of the advertisers so that the advertiser can host third party site.

In some cases the system may refer to a number of dependencies. These dependencies may be categorized, while also being active with different classes including dependencies that are direct, up level/down level, multi-level and nested. In some embodiments the system primarily uses up-level/down-level dependencies when relating information to media content, digital media and/or posts. Up-level dependencies are referenced by other (one or more other) post, tag, digital media and/or object. Down-level dependencies reference other (one or more other) post, tag, digital media and/or object. In most cases down-level dependencies are created in conjunction with an up-level dependency that exists and in some cases down-level Decencies that have been created may not have an existing up-level dependency, this occurs when the up-level dependency is deleted or removed from the system. In some embodiments a down-level dependency may contain one or more up-level dependency. This occurs with digital media that is contained by the post. For example the post that contains 3 images, where the post is the up-level (and may be a down-level as well) and images that are up-levels to one or more down-level dependencies. When the post is deleted the images simple detach (decouple) from the up-level now the images are just up-level dependencies, from the original of being both up-level and down-level. In some embodiments if a user deletes the images, then any referencing down-level, post, tag, digital media message or advertisement and/or object would detach or decouple.

For example a company advertises a product, if it is something a user can buy a user can link a user to where it can be bought, whether that may be on a social network site, online retailer, or any other storefront that is made available. If it is a place we can find out how to get there, while also viewing digital data and other information that would be associated with digital media and or the relating site. Using a restaurant for example, a user may be connected through other social platforms that offer reservations, rating and review, information, order, ability to takeout, while also finding more information and also providing addition services that enhance users. From restaurants users will be able to view menu's or food, various tags food served, storing information and provide rating for those seeking the information (query) who are within your network and/or who are not within your network. With food users can search for restaurants that serve food that looks appealing, while also showing images posted that are listed with greater value within a user network and presenting any relevant information not in a user network. Features in the said invention may be presented to users surfing the web, using applications or viewing digital media where there is no social connections.

Language, geography, or variations of design do not limit the said invention. Users will be able to favorite associated regions in digital media and photos while also allowing users to share these favorites, to comment on associated regions and keep favorites privately or socially. The said invention may or may not limit users from manipulating photos, adding various filters or making adjustments to contrast, brightness, saturations, hue, etc. in some embodiments users are connected with the ability to associate regions digital media of another user. With the said inventions users will be able create profiles that may be searchable with other platforms.

Additional varying digital media where a User Device with a video (from a capturing, recording, processing, storing, and transmitting a sequence of still images representing scenes in motion additionally with sound effects and dialogue recorded) may be broken down in components. One or more components of still images and/or sound (various processes sound wave).

Hashtags could also be added to photos or posts that contain photos, said hashtag would allow people to pick up trending digital media in social web, throughout the web and communication network. These hashtags could aid in supporting region associations and the buttons and/or buttons with features presented to the users, while also allowing hashtags to be a button and or adding hashtags with the use of a button and/or button with features. Hashtags could be added automatically from the recognized areas while also have a list of preset hashtags that the user could select (these hashtags could be created automatically from the regions).

While the said invention will use various in-house equations, algorithms, logic and software, the said invention could also license and/or use additional technology, equation, algorithms, and software. The said invention would in some embodiments automatically or have one or more users manually input data for associations or distribution of objects. Identifications made automatically of one or more association from digital media or search queries are performed within a server system that has one or more processors and memory storage. The server system can be broken up and processes data with a plurality of processor and memory. The disclosed server system can receive the make the associations automatically and identify while also providing digital data available to a user.

Automatic association may be used to identify logos recognize letters from text, then through one or more processing server conduct the appropriate search of the digital media, other examples would have video parameter then breaking up the video into digital images (by frames) to identify associations, whereby any digital media not associated may be either discarded or data is entered that no associations found. At a later date another search could be performed or a user could manually input data to aid and/or associate a region. Automatic recognition would use a plurality of methods to analyze digital data to build large amounts of data, while also including singling out not possible associations or false identification. Using and defining rules, for example a face association would include symmetry down the middle of the face, two eyes, nose and mouth very similar on both sides. Whereas a logo of a company or lettering where more of a geometric applications would be used. Aiding in associations would include categories and sub categories from any digital media in context, whereby in some embodiment the said invention can create an ordered list or (ranking) of the most likely identifications for associations made within digital media, deciding the type of association then proceeding with the said invention could use a plurality of methods to automatically associate identifications.

Examples may include buttons or features may link the viewing user with additional photos, digital data, digital media of a particular user, users, business, place, object, or relating and or ranked data and content; for example user₁ selects an identification of a user₂ where one or more features are made available, here user₁ can select a feature to view photos associated with user₂. When applying to other application a user₁ could be searching for an article of clothing, where from the digital media for a user taken photo or viewing a web page, a userₘₐᵢₙ features may include “where to buy” the article of clothing, photos of the article of clothing that have been taken, or from an online store a photo could do more than just showing the user a picture. Photos could also be organized by association, for example if a user adds a certain association to the said users favorites list then any photo with that same association has an importance to a user. That may create a more automated feed and more in the context search results. Data can be derived from posts, digital media or files shared with the system whereby the system can identify one or more objects or data within any posts, digital media or file that are shared to the system through the system (or remote system) and/or not shared to the system through the system (or remote system). For example an object within an images may have a barcode, where any part of the barcode may be used to identify the object to use when providing information to one or more users and/or to relate one or more users, objects, posts, and/or digital media within the system.

Tags and posts are treated the same and similar of the disclosed system but in the front-end whereby dealing with user interface. A post has a null parent_id therefore this is treated as a tag referring to a new idea or simply speaking referring to the first topic thread. Therefore a tag with no parent_id in some embodiments referred to as a post. A post can contain one or more documents, photos, videos, sounds, graphics, augmented representation, links, and articles (etc). Furthermore a post can contain other data but not limited by metadata, EXIF data, keyword tags, hashtags and comments, favorite (like), text, links, location, objects, entries, places, and users. A tag has a parent_id (in some embodiment not limited by just one) that refers to another tag, post, user, object, place, and/or entities. Furthermore a tag refer or be embedded within a documents, photos, videos, sounds, graphics, augmented representation, links, articles (etc). additionally a tag can contain post can contain other data but not limited by metadata, EXIF data, keyword tags, hashtags and comments, favorite (like), text, location, objects, links, entries, places, and users.

As used herein, objects generally refer to one or more local business or place, company, organization or institution, brand, product artist, professional & public figure, entertainment cause & community

Local businesses and places may further comprise of, defined by, categorized by and/or relate to one or more (or combination of) but not limited to Airport, Arts, Attractions, Automotive, Bank, Bar, Book Store, Business Services, Church, Club, Community, Concert Venue, Doctor, Education, Entertainment, Event Planning & Services, Financial Services, Food, Government, Grocery, Health, Medicine & Pharmacy, Hospital Clinic, Hotels, Landmarks, Lawyer, Library, Movie Theater, Museum & Art Gallery, Nightlife, Outdoor & Sporting Goods, Pet Services, Professional Services, Public Places, Real Estate, Religious Organization, Restaurants, Schools, Shopping & Retail, Spas, Beauty & Personal Care, Sport Venue, Sports, Recreation & activities, Things to do, Tours & Sightseeing, Transportation, University, and other relating to local business or place.

A company, organization or institution may further comprise of, defined by, categorized by and/or relate to one or more (or combination of) but not limited to Aerospace & Defense, Automobiles & Parts, Bank & Financial Institution, Biotechnology, Cause, Chemicals, Church & Religious Groups, Community Organization, Computer Hardware, Computers & Technology, Consulting & Business Services, Energy & Utility, Engineering & Construction, Farming & Agriculture, Fashion and Beauty, Food & Beverages, Foundation, Government Organization, Health, Medical & Pharmaceuticals, Industrial, Insurance, Internet, Software, Legal & law, Manufacturing, Media, News & Publishing, Mining & Materials, Non-Government Organization, Non-profit Organization, Political Organization, Political Party, Professional services, Religious organization, Retail & Consumer Merchandise, Small Business, Telecommunication, Transport & Freight, Travel & Leisure, University and other relating to a company, organization or institution.

A brand or product may further comprise of, defined by, categorized by and/or relate to one or more (or combination of) but not limited to Antiques & Collection, Apparel & Accessories, Appliances, Arts & Entertainment, Auto, Baby & Kids, Bags, Building Materials, Business & Industrial, Camera & Photo, Commercial Equipment, Computers and Hardware, Education, Electronics, Fashion and Beauty, Financial Services, Food & Beverages, Furniture, Games & Toys, Gifts & Occasions, Health & Beauty, Home Décor, Household Supplies, Jewelry & Watches, Kitchen & Cooking, Luggage, Media, Music, Office Supplies, Outdoor & Sporting Goods, Patio & Garden, Pet supplies and services, Phone & Table, Product & Services, Public figure, Software, Tools & Equipment, Travel, Video Games, Vitamins & Supplements, Website, Wine & Sprites and other relating to a brand or product.

An artist, professional & public figure may further comprise of, defined by, categorized by and/or relate to one or more (or combination of) but not limited to Actor, Artist, Athlete, Author, Business Person, Chef, Coach, Comedian, Dancer, Entertainer, Fictional Character, Government Official, Journalist, Monarch, Movie Character, Musician & Band, News Personality, Pet, Politician, Politician, Producer, Public Figure, Teacher, Writer and other relating to an artist, professional & public figure. Entertainment may further comprise of, defined by, categorized by and/or relate to one or more (or combination of) but not limited to Book Series, Book Store, Concert, Tour, Concert Venue, Fictional Character, Library, Magazine, Movie, Movie Character, Movie Theater, Music Award, Music Chart, Music Video, Professional Sports Team, Radio Station, Record Label, School Sports Team, Song, Studio, TV Show and other relating to entertainment.

A cause or community may further comprise of, defined by, categorized by and/or relate to one or more (or combination of) but not limited to Animals, Charitable, Education, Environment, Foundation, Health, Human Services, International, Public Benefit, Religion and other relating to a cause or community.

Objects can also be embodied with subscriptions, purchases etc. Current systems with advancements in technology allow and enable users to access and share information throughout the web and through mobile devices through various types of networks.

In most cases and from what is currently available, social networks allow for one or more users through a structure of organized data, to interact with one another whereby organizing and enabling individuals, groups and entities to be connected throughout one or more networks integrated into a software platform that can connect with other third-party application.

With various connections and interactions a social network (when set up to do so) can collect data within the system and through other third-party systems. This data can be organized in a social graph whereby the data can be collected, organized to relate whereby serving better results to one or more uses of the system and third party systems.

In some embodiments the system graph illustrates relationships used within the system. For example one or more users, entities, objects, posts, tags, viewed content, locations, proximity, and virtually anything shared with the system and other third-party systems. Anything within the system can be represented by a webpage whereby linking any information while also enabling the user interface in a social environment.

In some embodiments various process allow for crawling and/or scraping of backend data sources like Wikipedia, news articles, freebase or through various third party applications. Objects may be automatically created where no one user can post and/or tag. A user or object (i.e. product, business, band, public figure, or place). When query a system, in some embodiments, a user may be present with one or more results that connect or relates the one or more past interactions with the system. Additionally the results may also include one or more results that may include one or more and/or combination of users, posts, tags, digital media, answers to relating search, proximity, objects and/or advertisements. Whereby shown to the user in one or combination of lists, grids, image views, or cards. The user may be presented with one or more buttons or symbols resulting in the desired results. One or more servers and technologies however not limiting to may include web, http/https, FTP, application, GCI, ASP, HTML, XML, java, JavaScript, C, Objective C, async, Java, AJAX, PHP, Python, ruby, and similar (or not similar). Other data collected would include electronic belongings comprising of software and hardware device. The disclosed system may track posts and tags that are linked to one or more objects or users. An affinity may be determined between one or more users, objects, posts, tags and entities. In some embodiments a tag may be performed on any part of a user's profile, purchase, travel, etc, whereby in some embodiments rewarding users for reviewing a product, or stay at a hotel, dining, or service, travel flight, etc. whereby these rewards may be redeemable or used toward real world items, stays, purchase, services, of gifting one or more points. Tags may also interact with a user's experience on a game or animation. Endorsement of products, restaurants, travel (etc.) to other users or friends may offer more significance which can be measured than a regular advertisement. Post and tags are not limited to the type of or items embedded referred, referenced to or any attachments like digital media, text, objects, metadata, (etc.) Any post to the system may be linked to analytics showing performance. Both natural statistic and paid. Backlinks for posts may include one or more posts refer to other posts

In some embodiments a user could select a feature that is added by a developer or third party. For example a user takes a picture of a car which is identified to be a 1967 Chevelle SS, example of features could be Kelly blue book (to provide more information), eBay (showing search results), cars.com (search results), craigslist (local listings), wiki (showing information), etc. where the features could be presented to the user immediately or through a list of available options. In some embodiments, buttons could be a simple way to add notes to digital media. After user makes a selection from one or more features the user may be presented with responsive data. The responsive data would further enable a user to make a call message, find a rating, order food, nearby location, proximity, etc. Other items shown on digital media referring to or from advertisers and other platforms.

The disclosed invention is described relative to digital media represented in an exemplary embodiment of the invention as a photograph, on a user device. The digital media more generally may include photos, photo albums, video and the like. Digital media also includes digital images, digital video, digital icons, digital illustrations, digital representation of real world places, digital representation of real world businesses and or related.

In some embodiments a computer network that includes various levels of servers and databases. The user device and the front-end processing server interact through the communication network. Digital data is sent from the user through the users device to the front-end processing server, which then the digital data is allocated to one or more parallel servers for processing. Each parallel server could have one specific query search process or multiple designated query search process or random query search process (i.e. remote hosted undedicated servers). In some embodiment, the servers could be broken up to specific tasks of each component or sharded. The parallel search systems individually process the digital data query; if and when the digital data is processed the information is sent to the front-end server system. Sometimes the front-end server could process one or more query on the search. The results sent back from the Parallel query server system or indexed data could include any format digital data (i.e. textual documents, images, video, etc.) The front-end server updates processed information through the communication network to the user device. In some embodiments, the processed data could be stored through the corresponding server databases, front-end database while also storing information on the user device. In some embodiments, parallel servers can interact directly with each other. The query could result in being a text that is found within the digital data. For example a digital image of writing or a phone number could be processed to determine an association. The server system as a whole will send at least one processed digital data back to the user. There is no limit on the number of parallel servers within the server system. In some embodiments the server system could contain a content engine where data is processed and collected between one or more users, associations within digital media, interests, traits, preferences to aid in creating links, relationships and similarities.

Additionally the said invention will use, outsource, best practice, create, license, technology that will enable the use to users. A plethora of technology like CDN, databases, indexes, object stack, cloud, API, SDK, middleware, SQL to serve content to end-users for text, graphics, URLs and scripts, media files, software, documents, applications, e-commerce, portals live streaming media, on-demand streaming media, and social networks. Furthermore some technology may extend to crawling, indexing, and sorting operations while also utilizing available space storage, whereby information and data may be stored on one or more storage systems.

The operating system for each device (i.e. 10S, DRIOID, WINDOWS MOBILE, DARWIN, LINUX, UNIX, OS X, WINDOWS, VxWorks, etc.) the software components and/or drivers that controlled and manage general system responsibilities (i.e., memory, memory management, storage device control, power management, etc.) and while also enabling interactions among various hardware and software components. The user device and/or server system could be equipped with a camera or scanner that would have abilities to capture images (or digital media). Memory would include one or more DRAM, SRAM, DDR RAM while also including solid state drives, non-volatile memory, magnetic disk drive, optical disk storage, flash memory.

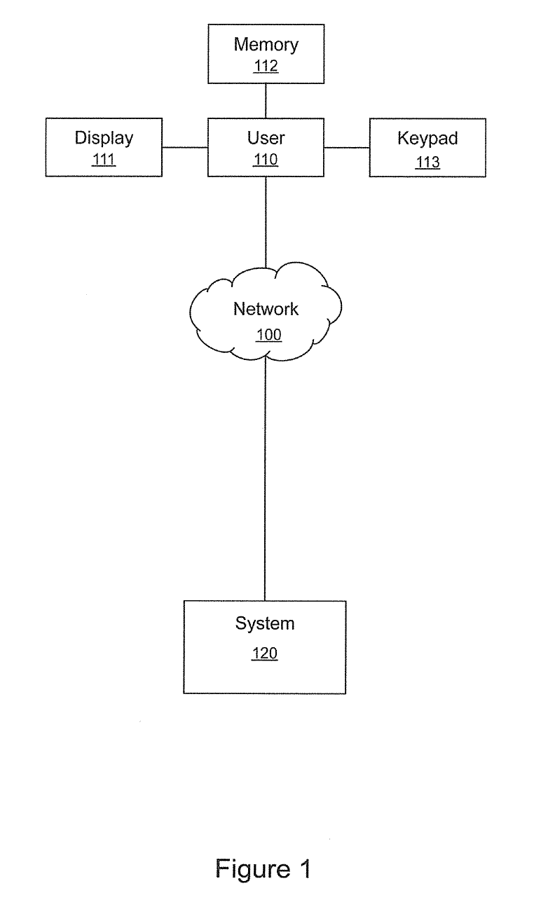

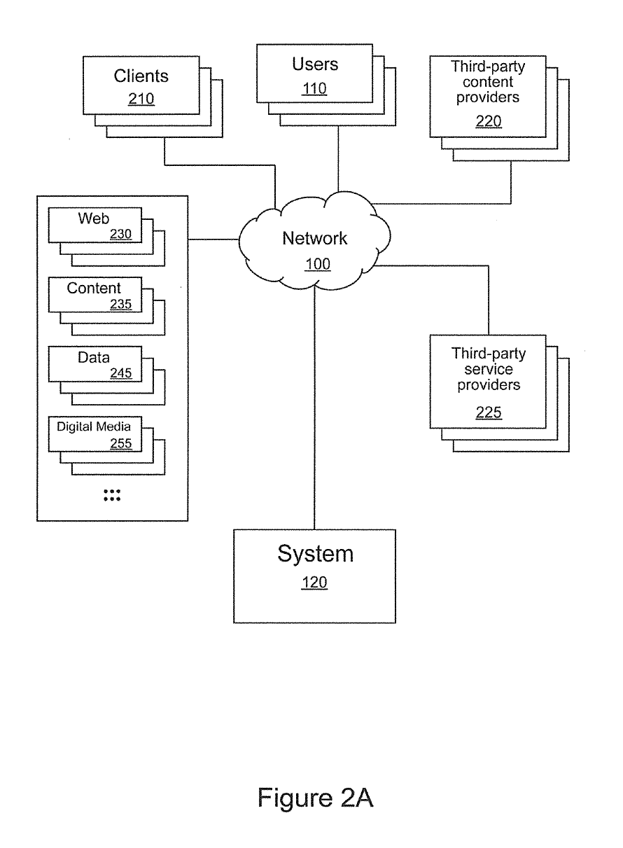

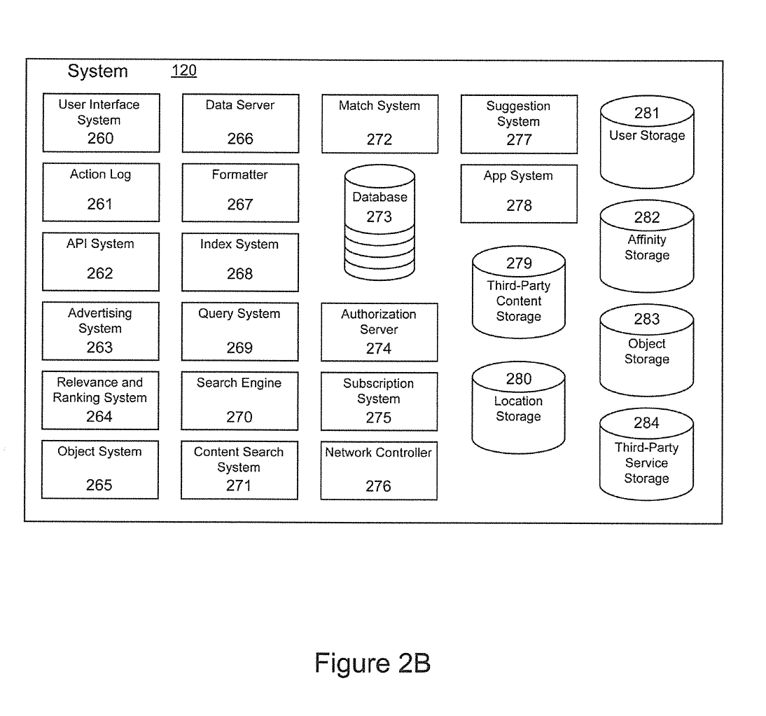

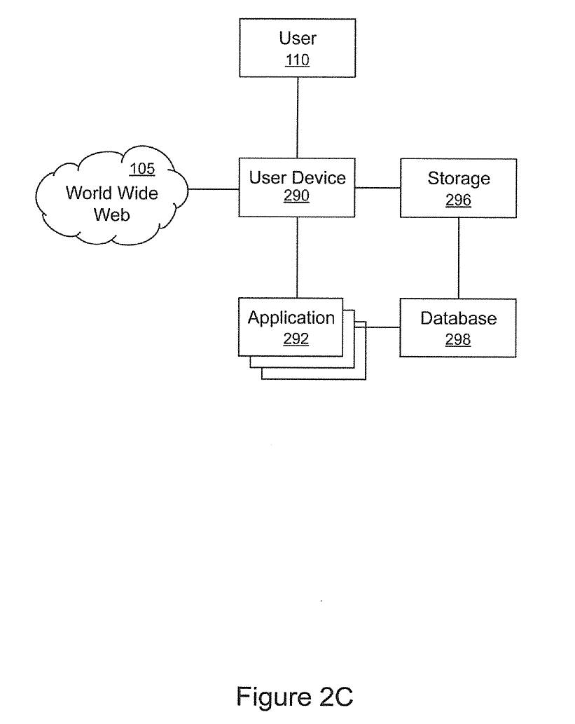

FIG. 1 illustrates a diagram of a network 100 where in some embodiments coupled to a system 120 and a user 110, whereby the user may interact with display 111, memory 112 and/or keyboard 113. The user 110 may interact with one or more user devices that comprise of one or more and/or combination of displays 111, memory 112, and/or keyboard 113. In some embodiments shown in FIG. 2A the system 120 may work in parallel and/or support one or more users 110, Clients 210, Third-party content providers 220 and/or Third-party service providers 225 whereby the coupled system in some embodiments operate through the system 120. The system collects, stores and organized content such as users, user profile, data, information, businesses, inventory, logistics, advertising, articles, digital media such as images, video, sound, documents, and or objects that are created, uploaded, linked, posted, tagged, retagged, defined, or allocated by one or more users 110, Clients 210, Third-party content providers 220 and/or Third-party service providers 225. A system can also find data 245, Digital media 255, content 235, Web (content, sites, links, information, data, etc) 230 by various techniques and by using one or more information/data or services from a third-party (these techniques include scraping and/or crawling data from the World Wide Web).

FIG. 2B illustrates a block diagram of a system 120 that in some embodiments may contain one or more systems, components and/or combination systems, modules, storage, database, servers, and/or software. The said system in one embodiment may include a user interface 260, Action Log 261, API System 262, Advertising System 263, Relevance and Ranking System 264, Object System 265, Data Server 266, Formatter 267, Index System 268, Query System 269, Search System, Search Engine 270, Content Search System 271, Match System 272, Database(s) 273 , Authorization server 274, Subscription System 275, Network Controller 276, Suggestion System 277, App (Application) System 278, Third-Party Content Storage 279, Location Storage 280, User Storage 281, Affinity Storage 282, Object Storage 283, and Third-Party Service Storage 284.

The server system may calculate a user's interaction and response to searches and ranks data information. Components of the systems may include one or more bus, processors, memory, ROM, I/O devices, storage, processing logic, RAM, microprocessors, and interface for communication. The query system 269 embraces a plurality of parts. Examples would include single region query, a multi-region query, query and/or combination of. In some embodiments a query system may include a query optimizer to aid in determining the most efficient way to perform the query. Search engine 270 uses the response from a user query of keywords and digital media (documents, images, video, sound, graphics, commands etc) and retrieves the best results in response to the user query, in some examples results would include webpages, documents, digital images and/or parts of digital images while also including social data as posts, uploads, tags, and retags. Embodiments in the said invention is to provide the best possible results to the user query and interaction with the system. Additionally the system maybe designed and set for users browsing the Internet and/or displaying results that were broadly searched throughout the Internet. Content Search System 271 is a system that searches multiple data types, understanding the similarities of various data types. In some embodiments data is unstructured whereby content may be modified and may include website content. Within the scope of the invention the system may be modified and expanded for use in various ecommerce, logistic, image galleries, forums, applications, etc. other example may include a match system that identifies sorted and unsorted conditions, understanding variations, hits, and landing pages. The said system may include one or more corpus whereby includes large amounts of information relating various subjects. The said inventions would include the World Wide Web and user inputted data, while also including resources and publications of literature, real-time interactions and content, presentations and scientific, etc. In some embodiments a system that browses, finds and stores information from the World Wide Web for example such methods include web crawler, spider, scraping, and/or bot. In some embodiments the web crawler may re-visit or a user/webmaster may choose to be excluded from a crawl list, etc. Within the scope of the said invention the crawling system may include a form of specialized crawling systems that finds data that may not be atomic but could be relevant to some search queries. The said system may also include the fetching of data, information, and digital media while including digital media that comprises of identified parts and/or associations where other embodiments may include predefined criteria for the crawling system. Recognition server identifies objects in digital media and/or digital media as a whole. Model generator specifies search engine index and/or search index structure based on data. While also including logs action logs 261 and/or activity logs, implementation, process, identification, ranking, and/or score, data, information, and digital media while including digital media that comprises of identified parts and/or associations. Whereby including probability (while including hyperbolic, kernel, and/or polynomials) that data, information, and digital media while including digital media comprise of identified parts and/or associations (distribution of objects) will be selected and/or generated for results to user queries. Within the said invention that may additionally include logs, data, models and/or testing including information inputted by one or more user for data, information, and digital media while including digital media that comprises of identified parts and/or associations whereby probability, values and/or scores relevant to the data, information, and digital media while including digital media that comprises of identified parts and/or associations is generated and/or stored. Other features may include various types of languages of data, information, and digital media while including digital media that comprises of identified parts and/or associations to where it may incorporate links that are scored and ranked while also being manipulated and rendered. The system may include already manipulated, added and/or rendered data, information, and digital media while including digital media that comprises of identified parts and/or associations. Trust and/or Authorization server serves as a key server or security for users. The Authorization server 274 is to provide a higher level of security of private/personal information and relationships and is some embodiments separating user data in various layers and location for security. Automatic data collection may run in parallel with recognition server to automatically identify objects data about objects and inputting data directly in various computer and/or server systems. In some embodiments auto generated data may in some embodiments be viewed in a social environment. This may also include identified objects with various barcodes, RFID, biometrics, OCR, acoustical, etc. User Interface System 260 provides ways that user may interact and perform queries. Methods may include browsers, websites and/or applications that users can use. The system may also include various indexes that enable digital media to be indexes in various types of arrays. Whereby also recognizing parts of digital media and associations. Index may include index mapping, subject index, and/or inverted index whereby data sets are created to retrieve data, mapping raw data, and/or content describing of digital media, while other forms may include web indexing. Media rank may include a weight and scoring system in order to measure the importance of digital media. Data server 266 comprises and may comprise of various embodiments including software and hardware to analysis data, store data, archive data, and/or data manipulation. While also including one or more parallel servers that may also include accounting, billing and an advertising platform. One embodiment may comprise of a correction/context system automatically changes or suggests when a user performs a query search whereby showing response to search queries that aid one or more users in finding the best, most relevant, correct and in context results. A Score system or Relevance and Ranking System 264 may include one or more methods of scoring and/or weighting keywords, digital media, and/or parts of digital media. In some embodiments a reputation, relationship and/or relevance score may be given to various distribution of objects, descriptors and/or factors. The said Relevance and Ranking System 264 may work alongside an Advertising Platform/System 263 or Third-party Advertising Platform/System. Database(s) 273 comprises of one or more databases to a collection and organization of data. In some embodiments one or more databases may include index database, score database, unique ID, image data, digital media database, while also including various database and/or database that handle more real-time events compared to informational data (increasing the response). In some embodiments the system may comprise of storage for one or more features within the system like user settings, affinity storage, object storage, third-party service storage, third-party content storage, location storage and app storages, whereby including any embodiments stored in connection with any and/or combination of systems, servers, or functions of the said invention system 120 and/or API system 262. In other embodiments include analytics, data collection, and admin systems provided by the said system and by one or more other third-party platforms or systems.

FIG. 2C illustrates a user operating a user device 290 whereby the user is able through the user device to send and receive data through a network or the World Wide Web 105. The user device 290 may in some embodiments interact with an application 292 that also uses the user device to connect to a system 120 through the network or World Wide Web 105. When a user interacts with an application 292 through a user device the receiving of data may result in persisting storage 296 in the form of a database 298 within the user device 290. For example if a user searches for an image the user device does not need to connect with the system to retrieve the already accessed image and simple recalls the image from the storage of the user device.

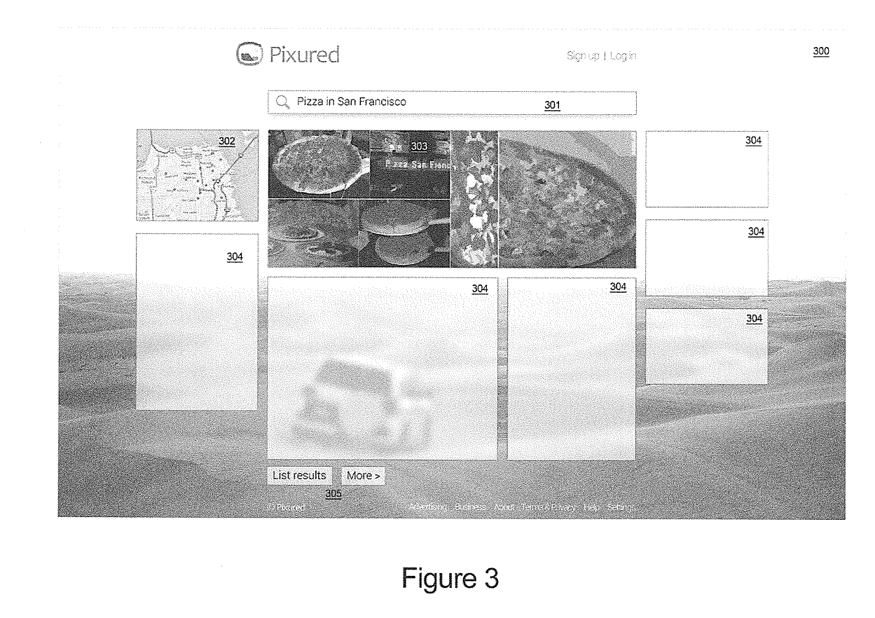

FIG. 3 illustrates a web view viewable from a browser. In some embodiments a user could search for a food item or location. For example a user could input data within a search box 301 the query is sent to the system 120 wherein one or more results will be presented in the web browser 300 to the user. For example the results may include a map or location 302, digital media or posts 303 and other relevant information and advertisements 304. The user can list results and view more on the next set of results 305.

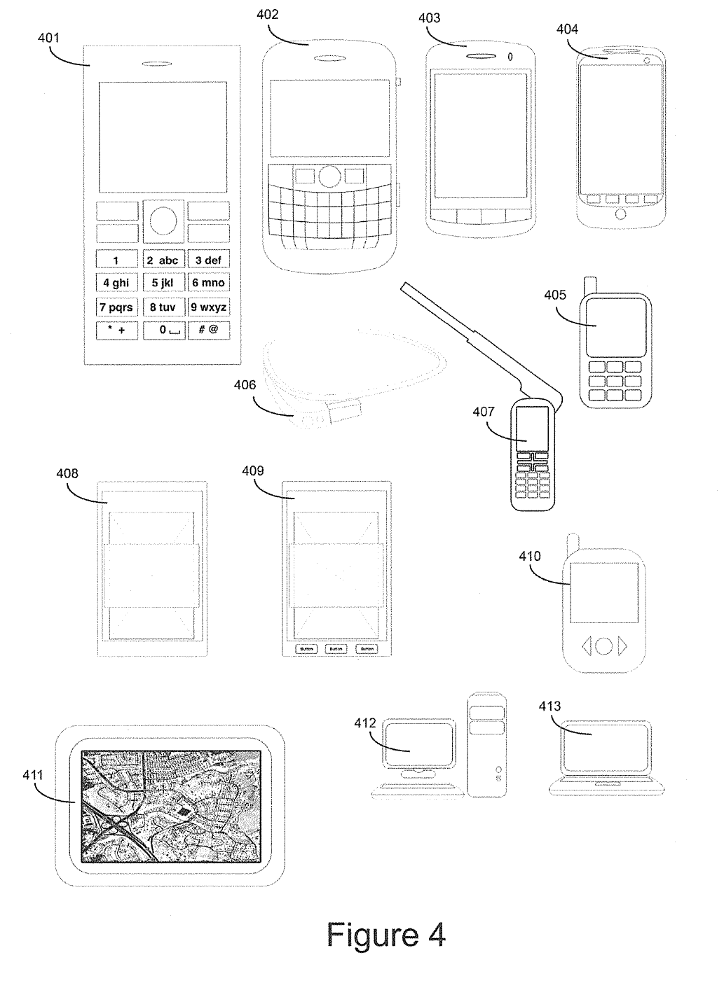

FIG. 4 illustrates examples of user devices that could be used with the invention apparatus. While the said invention may have a focus on devices with touch capabilities, devices with no touch capabilities could take advantage of the invention apparatus. Where users could activate or implement features using their finger, button, scrolling wheeling, mouse, track pad, pen etc., while also not limiting the user to future development of devices that incorporate voice recognition, artificial intelligence, retinal recognition, etc. In some embodiments user devices could represented while not limiting the scope of user device by a touch-less phone (with buttons) 401, a touch-less phone (with scrolling and buttons) 402, touch screen (with buttons) 403, touch screen (with buttons and scrolling) 404, wireless phone 405, headwear accessories (with multifunction capabilities) 406, satellite phone 407, multifunctional touch device (without buttons) 408, multifunctional touch device (with buttons) 409, simple device 410, GPS device 411, desktop computer 412, server, laptop 413, machine, artificial intelligent machine, or smartphone, etc. Devices connected through the communication network using the Internet, cellular connection, satellite connection, intranet, local area networks, wide area networks, wireless networks, and or related. While also when applicable NFC (near field communication).

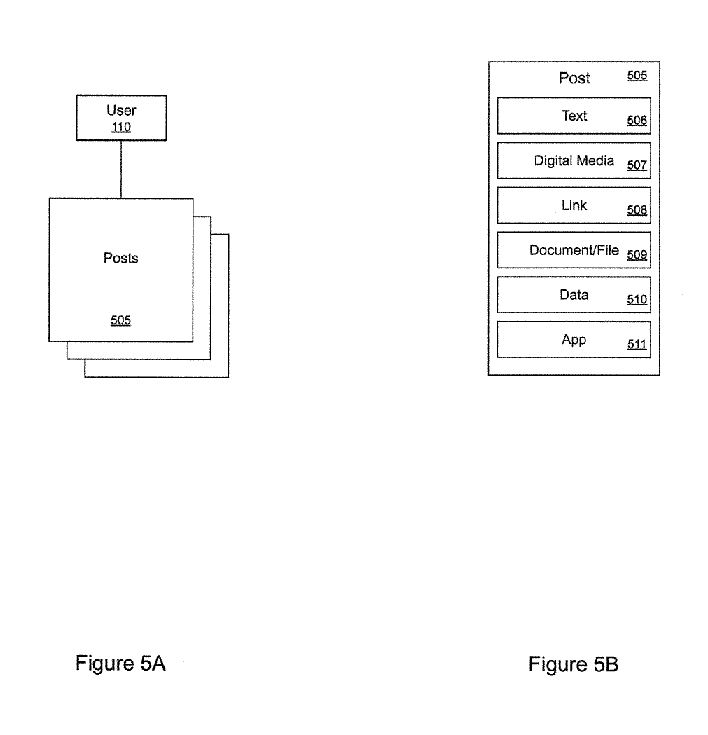

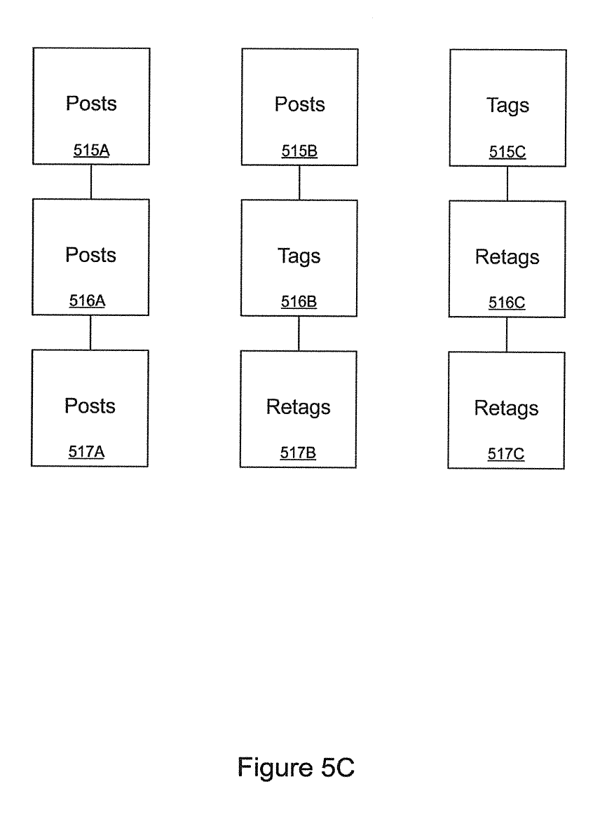

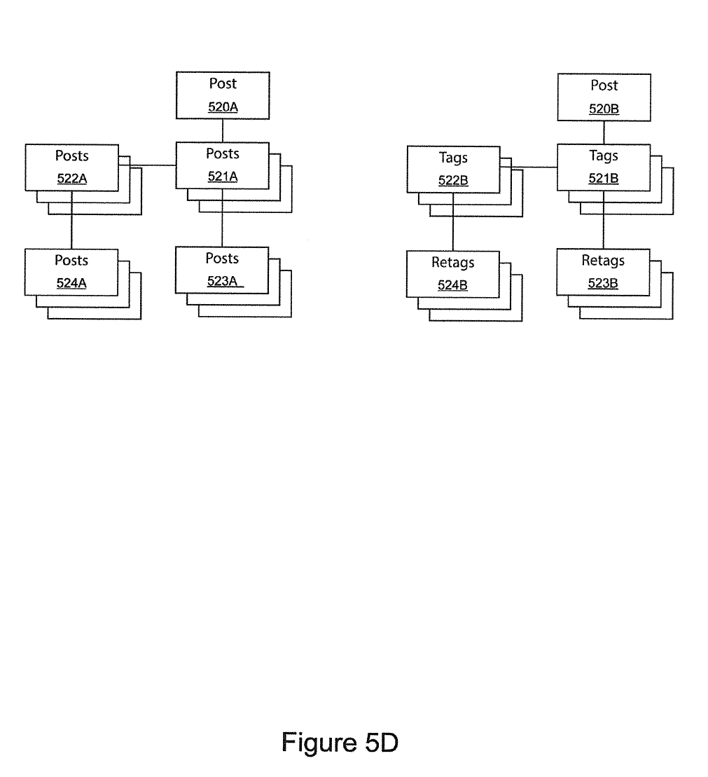

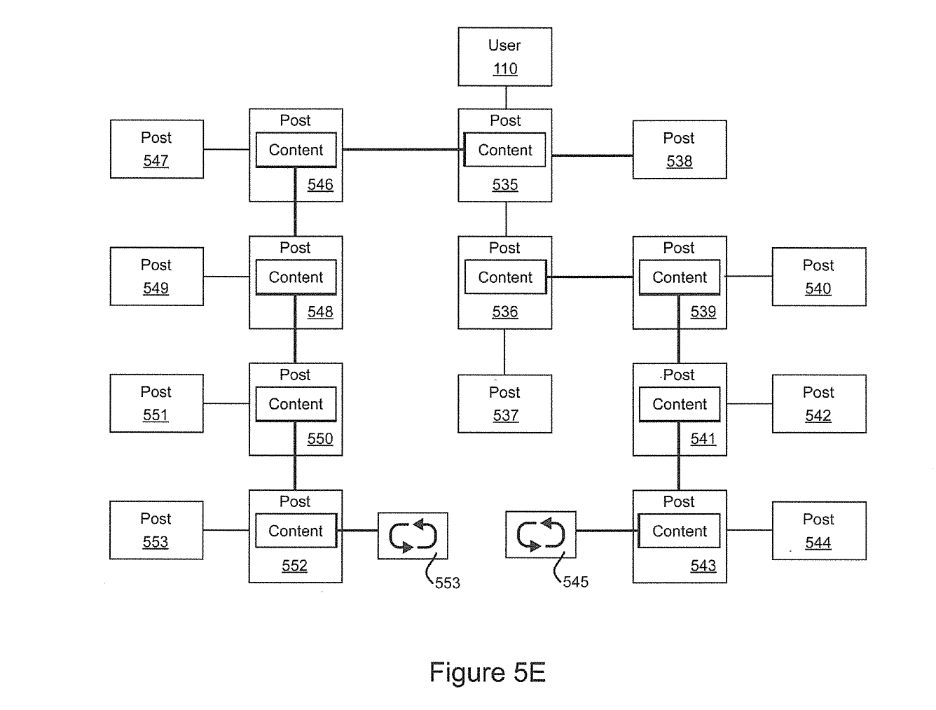

FIG. 5A illustration how one or more posts 505 are created, uploaded, shared with the system 120. Posts 505 can be set to public and/or private while also be shared though the system 120 by users who query, connected user, users using one or more third party services and/or APIs. User 110 who are connected to the user 110 who posted to the system may be updated in a feed or list of recent activity within the system. FIG. 5B illustrates that a post 505 can be made of any, a combination of, and one or more text 506, digital media 507, links 508, documents 509, files 509, and data 510. Where a user can have a series of posts illustrated in FIG. 5C, one post (515A to 516A to 517A and 515B to 516B to 517B) is coupled to the previous one. For example Post 515A would be a focus that the following posts 516A and 517A follow. In one embodiment the system may classify various posts as Posts 515B, Tags 516B and Retags 517B. Posts theoretically can have an unlimited number of Tags and more tags coupled to those tags that are then reshaped and/or added to by one or more retags for every tag within the system. In some embodiments posts (515A, 515B) may refer to tags 515C and tags 516B may refer to retags 516C, furthermore posts 517A may refer to retags 517C. FIG. 5D illustrates that any number of posts that are part/coupled to a post can have added distribution of objects to further categorize and/or define the post or subject. In the disclosed invention posts 520A of posts 521A and tags 520B of post 521B are identified to be the same, while also including retags 523B of tags 521B from posts 520B and posts 523A from post 521A from a post 520A. Further illustrating tags 522A tagging any part of tags 521A or 524A also treated as posts tagging any part of a post. A post can have one or more tags in linking to content provided by users whereby each tag can have one or more retags. One embodiment may also include tags that are linked to a post having one or more tags linking to one or more tags and/or combination of tags. Whereby each tag has one or more retags linking the tags and posts.

FIG. 5E illustrates how a user 110 can create posts with content 535. In some embodiments the same or another user can create a post with content 536 or a post without content 538 from the post with content 535. Post that contain content (535, 536, 539, 541, 543, 546, 548, 550, 552) may include documents, photos, videos, sounds, graphics, augmented representation, links, events, articles, objects, and apps. In some embodiments a user can create posts that contain content originating from any part of a post with content. For example any users can create posts with content or posts without content. Post with content 546 was created from the content of post 535, post with content 550 was created from the content of post 548, post with content 552 was created from the content of post 550, post with content 539 was created from the content of post 536, post with content 541 was created from the content of post 539, and post with content 543 was created from the content of post 541. Within the disclosed invention with some embodiments posts with or without content can be created from the content or parts of content of a post. In some embodiments other data may be include like a region, metadata, location, sequence, frame number, region associated with frame number.

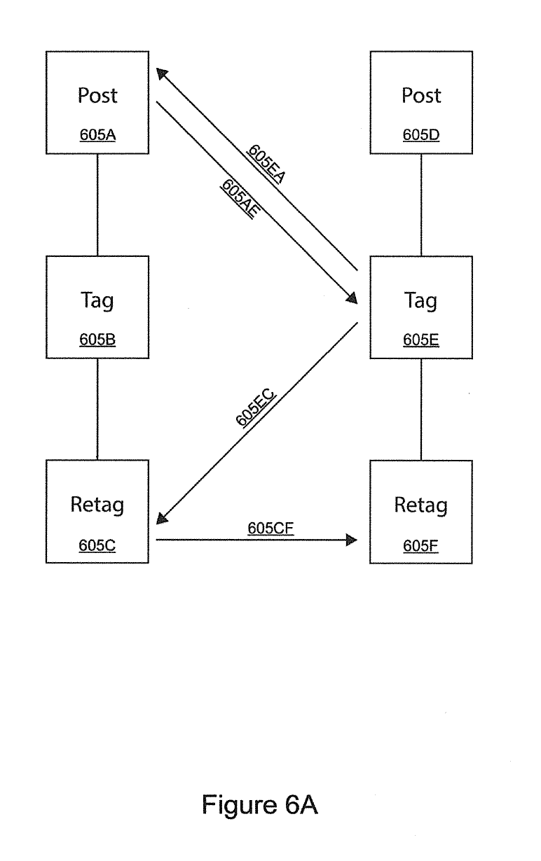

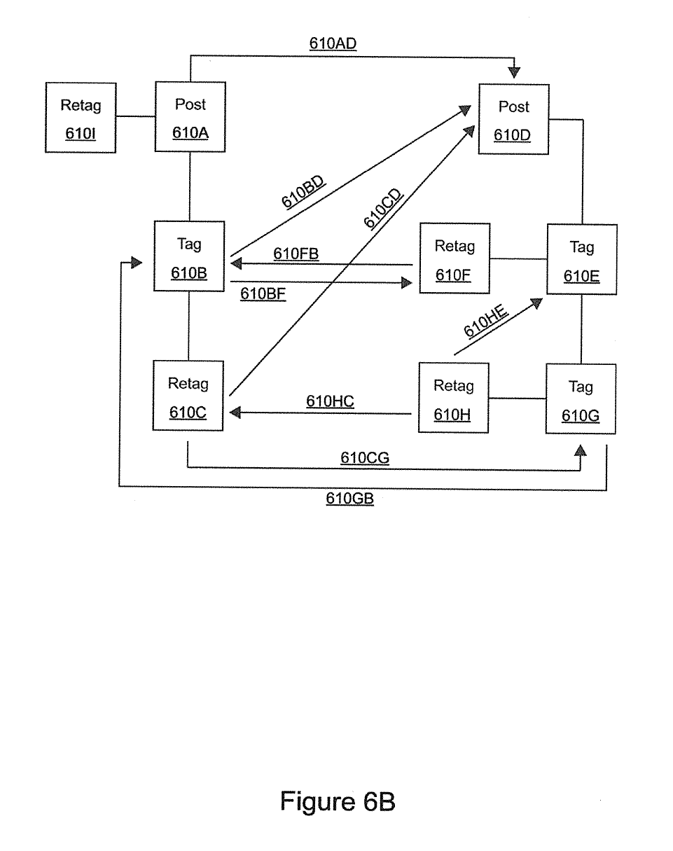

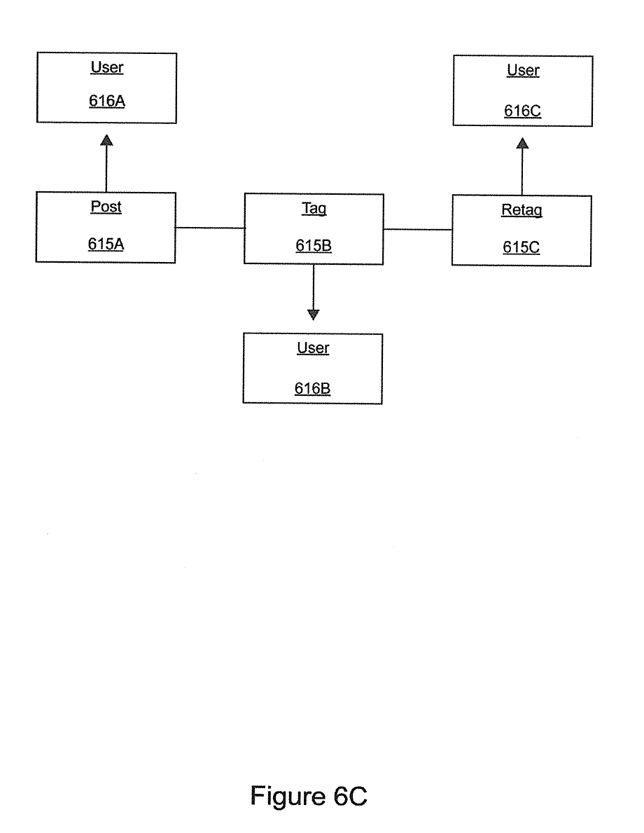

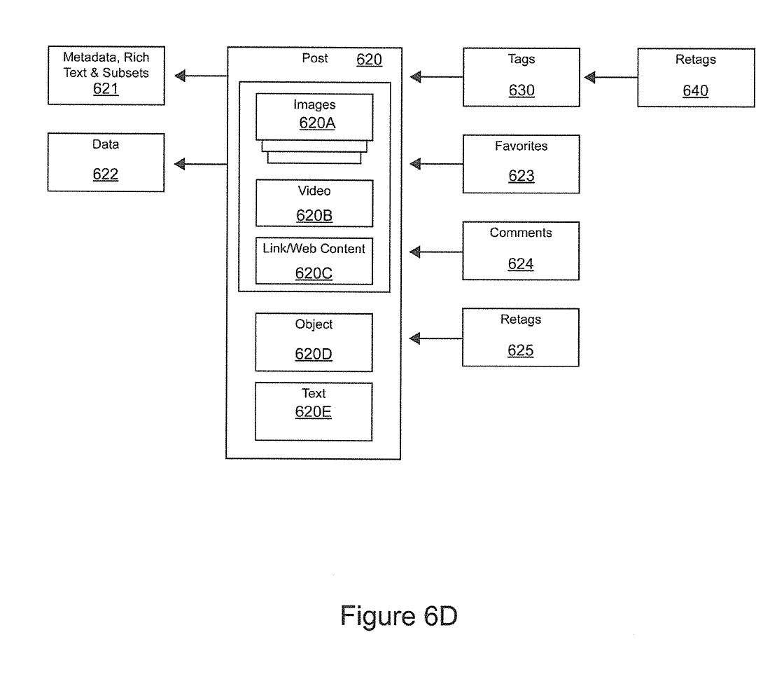

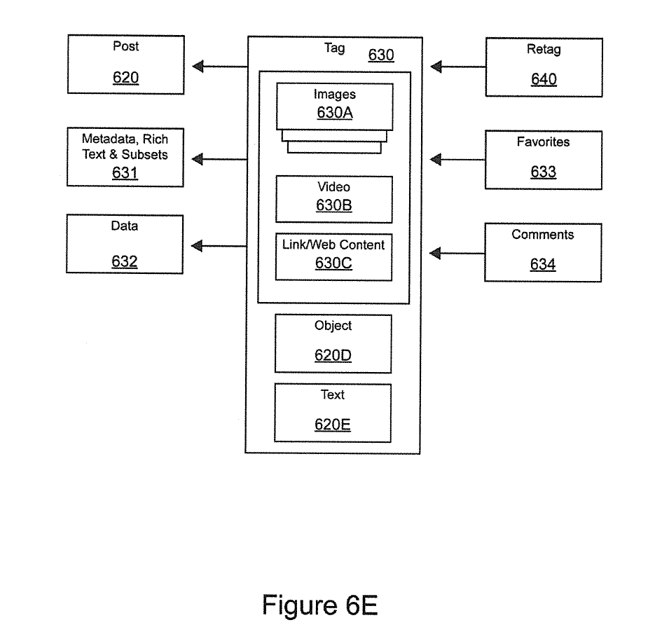

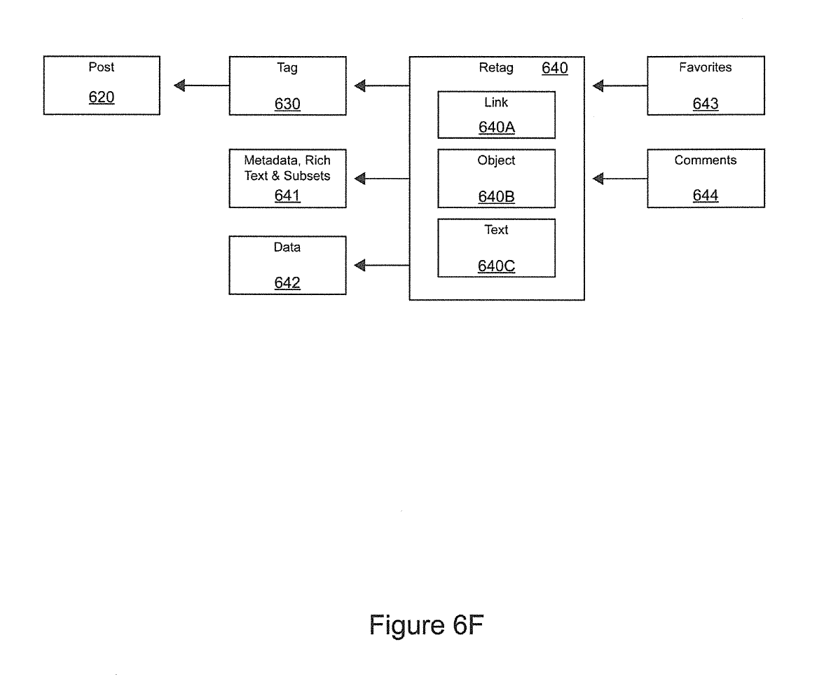

The system in some embodiments can have one or more, and combination of posts, tags, and retags pointing to other posts and tags and retags. Whereby anything within the system as illustrated in FIG. 6A can point to any number of Post, Tags, and retags where data and relationships that are formed by linking can be ranked and scored whereby determining the relevance of every interaction with the system. Further describing FIG. 6A, Post 605A can point Tag 605E whereby linking Post 605A to relationship of Post 605D, Tag 605E, and Retag 605F. Added to embodiments within the system a tag being pointed to and pointing to other Posts 605A and retags 605C links theoretically unlimited number of posts, tags, retags whereby forming relationships and paths to a number of links, digital media, articles, contents, files or documents that can be shown to one or more users when a user uses a system. In embodiments of the system relationships are scored and ranked whereby showing a various levels of significant to users.

FIG. 6B further defines one embodiment that includes relationships between the same or one or more user's posts tags and retags. For example if two users owned two different threads of posts, tags, and retags each and combination of posts, tags, and retags. To specify further post 610A can point/relate 610AD to Post 610D. Any post, tag retag can be pointed to and pointing to any number of other Post, tag and/or retag, for example tag 610B can point to 610BF retag 610F and point to 610BD post 610D. The tag point to can also have one or more other posts, tags, and/or retags pointing to Tag 610B whereby Tag 610G can point to 610GB Tag 610B and retag 610F can point to 610FB tag 610B. FIG. 6C illustrate that any number of posts 615A, tags 615B, and retags 615C can point to any number of users 616A, 616B, and 616C. Any user within or outside the said system pointed to in as a result in any part or combination of any Post, Tags, Retags coupled can be scored and ranked to show any relationship or relevance that can be used now or later for any number of correlations like advertising or results and feeds.

FIG. 6D illustrates a focus where in one embodiment a post 620 may comprise of one or more images 620A, Video 620B, and/or link/web Content 620C while also pointing to one or more Objects 620D and text 620E. Objects are things in the world that may or may not be represented by a user. In some embodiments objects could be a city or state, government, holiday etc. In one embodiment an object may be available through an API for or more clients, developers, third-parties whereby defining objects within the system as PixuredObjects or PixuredObjectuser. In addition to having a post comprise of various text, objects and content a Post 620 can also include Metadata 621, Rich Text 621, subsets 621, and data 622 whereby a post is not limited to also including and/or created by digital media, content, links, hyperlinks, meta data, meta elements (metatags), objects, apps, articles, documents, scores, ranking, API, data, backlinks and/or information. Users interacting with the said system can have the opportunity to rate or favorite 623 and comment 624 whereby adding to the post 620. Users may further define and allocate addition relationships, data and information by tagging 630 and retagging 640 coupled tags 630. Additionally retags 625 that contain and no digital media (or content) can also point to posts 620. Shares in some embodiments can also refer post 620 and any data, digital media, content, information, while also including similar embodiments. Similar to FIG. 6D in the embodiment of FIG. 6E a system interacting with one or more user through a network a focus of a tag 630 may comprise of one or more images 630A, Video 630B, and/or link/web Content 630C while also pointing to one or more Objects 630D and text 630E. In addition to having a tag 630 comprise of various text, objects and content a tags 630 can also include Metadata 631, Rich Text 631, subsets 631, and data 632. Whereby a tag 630 is not limited to also including and/or created by digital media, content, links, hyperlinks, meta data, meta elements (metatags), objects, apps, articles, documents, scores, ranking, API, data, backlinks and/or information. Users interacting with the said system can have the opportunity to rate or favorite 633 and comment 634 whereby adding to the tag 630. Users may further define and allocate additional relationships, data and information by posting 620 and retagging 640 coupled tags 630. Similar to FIG. 6E in one embodiment FIG. 6F a system interacting with one or more user through a network a focus of a Retag 640 may comprise of one or more links 640A while also pointing to and including one or more Objects 640B and text 640C. Retags 640 may also just be a representation, re-share or a copy of the coupled tag 630. In addition to having a retag 640 comprise of various text, objects and content a retag 640 can also include Metadata 641, Rich Text 641, subsets 641, and data 642. Whereby a retag 640 is not limited to also including and/or created by digital media, content, links, hyperlinks, meta data, meta elements (metatags), objects, apps, articles, documents, scores, ranking, API, data, backlinks and/or information. Users interacting with the said system can have the opportunity to rate or favorite 643 and comment 644 whereby adding to the retag 640. Users may further define and allocate additional relationships, data and information by tagging 630 and posts 620 coupled retag 640. Additionally retags 640 that contain and no digital media (or content) can also point to posts 645. Shares in some embodiments can also refer retags 640 and any data, digital media, content, information, while also including similar embodiments.

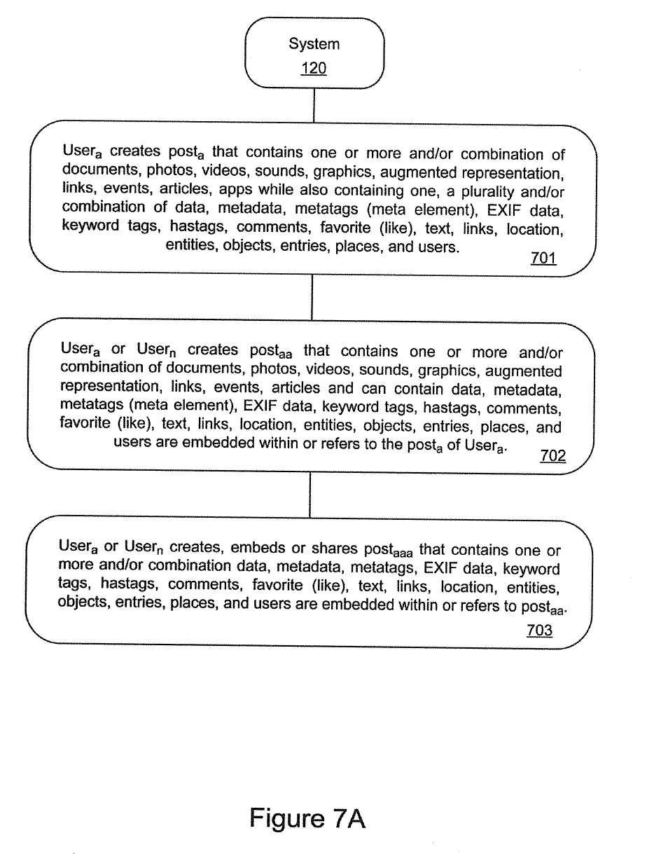

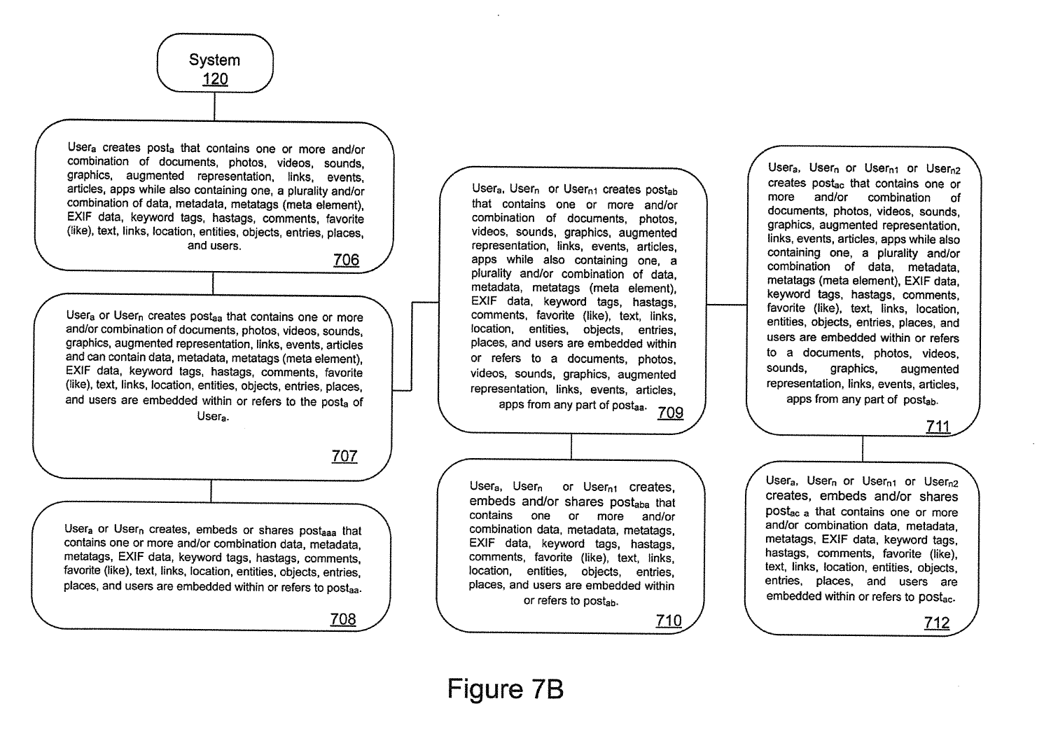

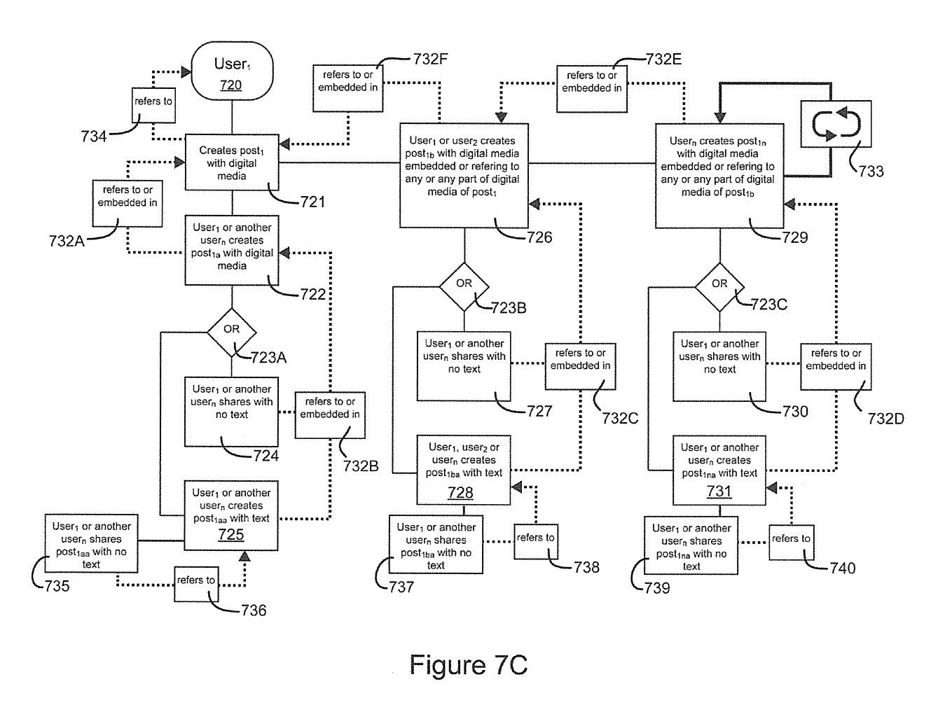

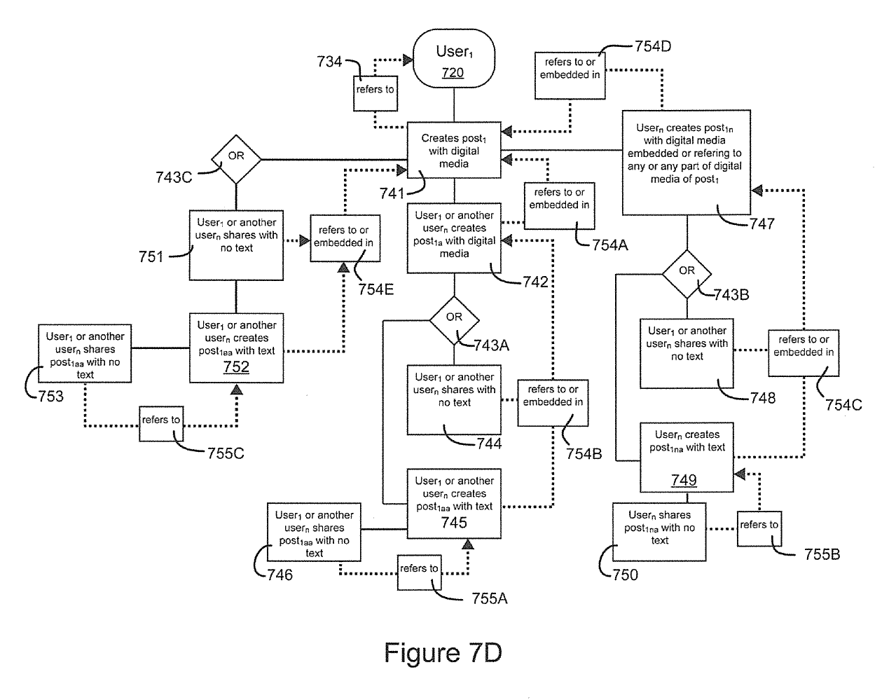

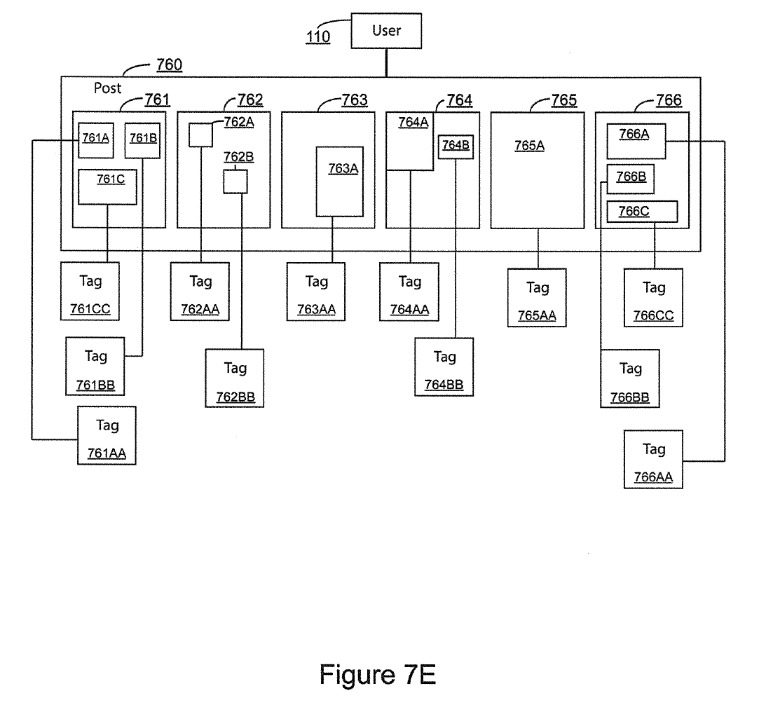

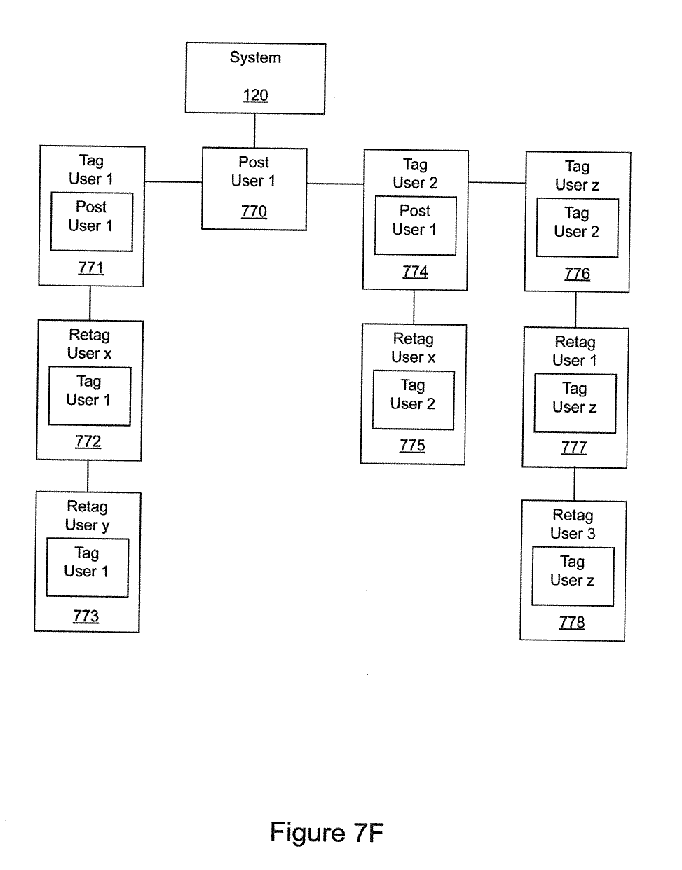

FIG. 7A illustrates in some embodiments where users can create original tags, add tags with content to tags and text to tags. For example, Userₐ creates postₐ that contains one or more and/or combination of documents, photos, videos, sounds, graphics, augmented representation, links, events, articles, objects, and apps while also containing one, a plurality and/or combination of data, metadata, metatags (meta element), EXIF data, keyword tags, hashtags, comments, favorite (like), text, links, location, entities, objects, entries, places, and users at block 701. Followed by a user creating a tag where a Userₐ or User ₙ creates postₐₐ that contains one or more and/or combination of documents, photos, videos, sounds, graphics, augmented representation, links, events, articles objects, and can contain data, metadata, metatags (meta element), EXIF data, keyword tags, hashtags, comments, favorite (like), text, links, location, entities, objects, entries, places, and users are embedded within or refers to the postₐ of Userₐ at block 702. If a user creates a tag with just text from the postₐ created by Userₐ will not allow other users to add content to the post, where in some embodiments, from postₐₐ (with content like digital media), Userₐ or User ₙ creates, embeds or shares postₐₐₐ that contains one or more and/or combination data, metadata, metatags, EXIF data, keyword tags, hashtags, comments, favorite (like), text, links, location, entities, objects, entries, places, and users are embedded within or refers to postₐₐ at block 703.

FIG. 7B illustrates a similar embodiment to FIG. 7A with the added embodiment of a user adding content (and/or digital media and data) to any or any part of digital media. In some embodiments adding content (and/or digital media and data) to any or any part of digital media may also include a region or set of regions within digital media. Corresponding regions can relate to a photo, document, video (for each frame or group of frames), and audio.

In some embodiments Userₐ creates postₐ that contains one or more and/or combination of documents, photos, videos, sounds, graphics, augmented representation, links, events, articles, objects, apps while also containing one, a plurality and/or combination of data, metadata, metatags (meta element), EXIF data, keyword tags, hastags, comments, favorite (like), text, links, location, entities, objects, entries, places, and users at block 706. Additionally Userₐ or User ₙ creates postₐₐ that contains one or more and/or combination of documents, photos, videos, sounds, graphics, augmented representation, links, events, articles and can contain data, metadata, metatags (meta element), EXIF data, keyword tags, hashtags, comments, favorite (like), text, links, location, entities, objects, entries, places, and users are embedded within or refers to the postₐ of Userₐ at block 707. Furthermore Userₐ or User ₙ creates, embeds or shares postₐₐₐ that contains one or more and/or combination data, metadata, metatags, EXIF data, keyword tags, hashtags, comments, favorite (like), text, links, location, entities, objects, entries, places, and users are embedded within or refers to postaₐ at block 708.

From user Userₐ or User ₙ creates postₐₐ that contains one or more and/or combination of documents, photos, videos, sounds, graphics, augmented representation, links, events, articles and can contain data, metadata, metatags (meta element), EXIF data, keyword tags, hashtags, comments, favorite (like), text, links, location, entities, objects, entries, places, and users are embedded within or refers to the postₐ of Userₐ at block 707 in some embodiments Userₐ, User ₙ or Userₙ₁ creates post_{ab} that contains one or more and/or combination of documents, photos, videos, sounds, graphics, augmented representation, links, events, articles, apps while also containing one, a plurality and/or combination of data, metadata, metatags (meta element), EXIF data, keyword tags, hashtags, comments, favorite (like), text, links, location, entities, objects, entries, places, and users are embedded within or refers to a documents, photos, videos, sounds, graphics, augmented representation, links, events, articles, apps from any part of postₐₐ at block 709. Userₐ, Userₙ or Userₙ₁ creates, embeds and/or shares post-able that contains one or more and/or combination data, metadata, metatags, EXIF data, keyword tags, hashtags, comments, favorite (like), text, links, location, entities, objects, entries, places, and users are embedded within or refers to post_{ab} at block 710.

To continue creating posts from digital media and/or parts of digital media, Userₐ, Userₙ or Userₙ₁ or Userₙ₂ creates post_{ac} that contains one or more and/or combination of documents, photos, videos, sounds, graphics, augmented representation, links, events, articles, apps while also containing one, a plurality and/or combination of data, metadata, metatags (meta element), EXIF data, keyword tags, hastags, comments, favorite (like), text, links, location, entities, objects, entries, places, and users are embedded within or refers to a documents, photos, videos, sounds, graphics, augmented representation, links, events, articles, apps from any part of post_{ab} at block 711. Furthermore Userₐ, Userₙ or Userₙ₁ or Userₙ₂ creates, embeds and/or shares post_{ac} a that contains one or more and/or combination data, metadata, metatags, EXIF data, keyword tags, hashtags, comments, favorite (like), text, links, location, entities, objects, entries, places, and users are embedded within or refers to post_{ac} at block 712.

FIG. 7C illustrates a flow chart where in some embodiments a user 110 can create posts aided by the disclosed invention. Illustrated a user₁ 720 creates post₁ with digital media 721 or content, and may include other data metadata and text and/or post₁ is created by an API. From the created post₁ with digital media 721 or content, user₁ or another userₙ creates post₁ₐ with digital media 722 or content. Posts that have been created from another post can be shared with no text or shared with text. Post that have been created with text and digital media or content from another post can share the post created with text. In some embodiments user) or another userₙ shares post₁ₐ with no text (or user, creates post_{1ab} shared with no text) 724 or 723A user) or another user, creates post₁ₐₐ with text 725. Post_{1ab} shared with no text 724 and post₁ₐₐ with text 725 originate from post₁ₐ with digital media. User₁ or another user, shares post₁ₐₐ with no text 735. Shares that refer to a previous post can be place within be placed and/or pushed to one or more user, followers, networks, third-party networks, contacts, and/or personal contacts (through messaging, text messaging, email, cross platform, instant messaging or subscription).

User₁ or user₂ creates post_{1b} with digital media embedded or referring to any or any part of digital media (or content) of post₁ 726. From user) or user₂ creates post_{1b} with digital media embedded or referring to any or any part of digital media (or content) of postₙ 726. Posts that have been created from any part of another post (or any part of another post may include digital media and/or content) can be shared with no text or shared with text. Post that have been created with text and digital media or content from another post can share the post created with text. Additionally a user can create a post with content or digital media from a posts that have been created from any part of another post (or any part of another post may include digital media and/or content). User₁ or another user, shares post_{1b} with no text (or userₙ creates post_{1bb} shared with no text) 727 or 723B user₁ or another user, creates pos_{ba} with text 728. Post_{1ba} shared with no text 727 and post_{1ba} with text 728 originate from post_{1b} with digital media. User₁ or another user, shares post_{1ba} with no text 737. Shares that refer to a previous post can be placed within, be placed and/or pushed to one or more user, followers, networks, third-party networks, contacts, and/or personal contacts (through messaging, text messaging, email, cross platform, instant messaging or subscription).

User, creates postₙ with digital media embedded or referring to any or any part of digital media (or content) of post_{1b} 729. From user, creates post₁ₙ with digital media embedded or referring to any or any part of digital media (or content) of post_{1b} 729. Posts that have been created from any part of another post (or any part of another post may include digital media and/or content) can be shared with no text or shared with text. Post that have been created with text and digital media or content from another post can share the post created with text. Additionally a user can create a post with content or digital media from a posts that have been created from any part of another post (or any part of another post may include digital media and/or content). User₁ or another userₙ shares post_{1b} with no text (or userₙ creates post_{1nb} shared with no text) 730 or 723c user₁ or another userₙ creates post₁ₙₐ with text 731. Post_{1nb} shared with no text 730 and post₁ₙₐ with text 731 originate from post₁ₙ with digital media. User₁ or another userₙ shares post₁ₙₐ with no text 739. Shares that refer to a previous post can be place within be placed and/or pushed to one or more user, followers, networks, third-party networks, contacts, and/or personal contacts (through messaging, text messaging, email, cross platform, instant messaging or subscription).

Posts that have been created from any part of another post (or any part of another post may include digital media and/or content) can be shared with no text or shared with text. Post that have been created with text and digital media or content from another post can share the post created with text. Additionally a user can create a post with content or digital media from a posts that have been created from any part of another post (or any part of another post may include digital media and/or content). This method in some embodiment can continuously or indefinitely occur 733. From these posts created from any part of another post may include digital media and/or content) can be shared with no text or shared with text, in some embodiments can be indefinably and continuously performed as the mentioned in the method and illustrations of FIG. 7C and the disclosed invention.

In some embodiments one or more posts may be referred to or embedded in one or more other posts or part of other posts. For example a post created with two images can have one post referring to or embedded within the first image and three posts referring to or embedded within the second image, while also not limiting any other information or data relating and post created as a result of a user creating a post from an originating post.

In some embodiments defined by the functionality of the system and user interface, a user can create post₁ with digital media 721 where the same (user₁) or another userₙ creates post₁ₐ with digital media 722. Post₁ₐ refers to or embedded 732A in post₁ whereby one or more additional information and data may be stored for either postₙ or post₁ₐ while also containing but not limited to other information like text, metadata (or meta elements), metatags, links, strings, (or post₁ₐ created by meta elements).

From the created postₙ with digital media 721 or content, userₙ or another userₙ creates post₁ₐ with digital media 722 or content. Posts that have been created from another post can be shared with no text or shared with text. Post that have been created with text and digital media or content from another post can share the post created with text. In some embodiments userₙ or another user ₙ shares post₁ₐ with no text (or user creates post_{1ab} shared with no text) 724 or 723A userₙ or another userₙ creates post₁ₐₐ with text 725. Post_{1ab} shared with no text 724 and post₁ₐₐ with text 725 originate from post₁ₐ with digital media. From the share of post₁ₐ or the created post post₁ₐₐ 725, are either embedded or referred to 732B post₁ₐ. Additionally in some embodiments userₙ or another user ₙ shares post₁ₐₐ with no text 735 which is refer to 736 post₁ₐₐ. Shares that refer to a previous post can be placed within be placed and/or pushed to one or more user, followers, networks, third-party networks, contacts, and/or personal contacts (through messaging, text messaging, email, cross platform, instant messaging or subscription).

User₁ or user₂ creates post_{1b} with digital media embedded or referring to any or any part of digital media (or content) of post₁ 726. From the new post post% refers or embedded in (and/or data is embedded in post₁ or post_{1b}) to the post₁ with digital media 726 and/or content. From user₁ or user₂ creating post_{1b} with digital media embedded or referring to any or any part of digital media (or content) of post₁ 726, user₁ or another user ₙ shares post_{1b} with no text (or user ₙ creates post_{1bb} shared with no text) 727 or 723B user₁ or another userₙ creates post_{1ba} with text 728 whereby both post_{1ba} and shared post with no text refer to or are embedded within 732C the created post_{1b}. Post_{1ba} shared with no text 727 and post_{1ba} with text 728 originate from post_{1b} with digital media. User₁ or another user ₙ shares post_{1ba} with no text 737. Shares that refer to a previous post can be placed within be placed and/or pushed to one or more user, followers, networks, third-party networks, contacts, and/or personal contacts (through messaging, text messaging, email, cross platform, instant messaging or subscription). A post created by a post of any part of content where in some embodiments the originating post could be part of another post can refer and or be imbedded.

Userₙ creates post₁ₙ with digital media embedded or referring to any or any part of digital media (or content) of post_{1b} 729. From the new post post_{1b} refers or embedded in (and/or data is embedded in post_{1b} or post₁) 732E to the post₁ with digital media 729 and/or content. From userₙ creating post₁ₙ with digital media embedded or referring to any or any part of digital media (or content) of post_{1b} 729, user₁ or another userₙ shares post_{1b} with no text (or userₙ creates post_{1bb} shared with no text) 730 or 723C user) or another user creates post_{1nb} with text 731 whereby both post₁ₙₐ and shared post with no text refer to or are embedded within 732D the created post₁. Post_{1nb} shared with no text 730 and post₁ₙₐ with text 731 originate from post₁ₙ with digital media. User₁ or another userₙ shares post₁ₙₐ with no text 739. Shares that refer 740 to a previous post can be placed within be placed and/or pushed to one or more user, followers, networks, third-party networks, contacts, and/or personal contacts (through messaging, text messaging, email, cross platform, instant messaging or subscription).

FIG. 7D illustrates a flow chart where in some embodiments a user 110 can create posts, creates posts referring to or embedded in any or any part of a digital media or content within a post, posts created from other posts (with or without content) and sharing any post aided by the disclosed invention. Similar to FIG. 7C in some embodiments user₁ 720 creates post₁ with digital media 741 where the same user₁ or one or more userₙ can create a post from the whole post₁ 747, any digital media (or content) and/or any part of digital media (or content) contained in post₁ 742, post with text 752 and/or 743C shares post₁ 751 to one or more networks, followers of the creating user who post and/or share. Where in some embodiment the same user user₁ or one or more than one userₙ can create a post from the whole post₁ 742, any digital media (or content) and/or any part of digital media (or content) contained in post₁ 747, post with text 744 and/or 743A shares post₁ₐ 745 to one or more networks, followers of the creating user who post and/or share. If a post is created with text that same post with text can be shared 746 to one or more networks, followers of the creating user who post and/or share. For example user₁ or another userₙ shares post₁ₐₐ with no text 746.

Additionally some embodiment include the same user same user₁ or one or more userₛ creates post₁ₙ as a result from any digital media (or content) and/or any part of digital media (or content) contained in post₁ 747, and a post created with text 749 from post₁ₙ and/or 743B shares post₁ₙ 748 to one or more networks, followers of the creating user who post and/or share. If a post is created with text that same post with text can be shared 746 to one or more networks, followers of the creating user who post and/or share. For example user₁ or another userₙ shares post₁ₙₐ with no text 750.

In addition some embodiment included the same user₁ or one or more userₙ creates a post with text 752 from post₁ and/or 743C shares post₁ 751 to one or more networks, followers of the creating user who post and/or share. If a post is created with text for example post₁ₐₐ with text can be shared 753 to one or more networks, followers of the user who created the share 753. For example user₁ or another userₙ shares post₁ₐₐ with no text 753.

In some cases and in some embodiments, a post and/or share can refer to and/or may embed within one or more users other posts, digital media, content, links, hyperlinks, meta data, meta elements, objects, apps, articles, documents, scores, ranking, API, data, backlinks and/or information. For example a post can refer to the posting user₁ 734. Any user that creates a post₁ₐ from a post include the same user who created the original post may have post₁ₐ and/or any digital media, content, links, hyperlinks, meta data, meta elements, objects, apps, articles, documents, scores, ranking, API, data, backlinks and/or information refer to or embedded in 754A either post₁ₐ or post₁. Furthermore embodiment may also include post with text 745, shares of post with text 746 and shares of posts 744 refer to and/or embedded within 754B one or more other posts. For example, User₁ or another userₙ shares post₁ₐ 744 or 743A user) or another userₙ creates post₁ₐₐ with text 745 where post₁ₐₐ 745 or 754B share of post₁ₐ 744 can refer to or embedded in post₁ₐ, the share of post₁ₐ and/or post₁ₐₐ with in some cases anything relating to post, any digital media, content, links, hyperlinks, meta data, meta elements, objects, apps, articles, documents, scores, ranking, API, data, backlinks and/or information. Additionally user₁ or another userₙ shares post₁ₐₐ 746. User that view the shared post₁ₐₐ of user) or another userₙ can be referred 755A to post₁ₐₐ created userₙ or another user, whereby also including in some cases anything relating to post, any digital media, content, links, hyperlinks, meta data, meta elements, objects, apps, articles, documents, scores, ranking, API, data, backlinks and/or information.

Additionally some examples may include a post that can refer to the posting of user₁ 734. Any user that creates a post₁ₙ from any part post₁ and/or any part of any digital media or content include the same user who created the original post₁ may have post₁ₙ and/or any digital media, content, links, hyperlinks, meta data, meta elements, objects, apps, articles, documents, scores, ranking, API, data, backlinks and/or information refer to or embedded in 754D either post₁ₙ or post₁. Furthermore an embodiment may also include post with text 749, shares of post with text 750 and shares of posts 748 refer to and/or embedded within 754C one or more other posts. For example, user₁ₙₐ or another user, shares post₁ₙ 748 or 743B user₁ or another user, creates post₁ₙₐ with text 749 where post₁ₙₐ 749 or 754C share of post₁ₙ 747 can refer to or embedded in post₁ₙ, the share of post₁ₙ and/or post₁ₙₐ with in some cases anything relating to post, any digital media, content, links, hyperlinks, meta data, meta elements, objects, apps, articles, documents, scores, ranking, API, data, backlinks and/or information. Additionally user₁ or another user, shares post₁ₙₐ 750. User that view the shared post₁ₙₐ of user₁ or another user, can be referred 755B to post₁ₙₐ created user₁ or another user, whereby also including in some cases anything relating to post, any digital media, content, links, hyperlinks, meta data, meta elements, objects, apps, articles, documents, scores, ranking, API, data, backlinks and/or information.

Furthermore some examples from any user that creating a post₁ₐₐ or 743C sharing 751 from any part of post₁ and/or any part of any digital media or content include the same user who created the original post₁ may have post₁ₙ and/or any digital media, content, links, hyperlinks, meta data, meta elements, objects, apps, articles, documents, scores, ranking, API, data, backlinks and/or information refer to or embedded in 754E either post₁ₐₐ 752, share of post₁ 751 or post₁. Furthermore an embodiment may also include post with text 752, shares of post with text 753 and shares of posts 751 refer to and/or embedded within 754E one or more other posts. For example, user₁ or another user, shares post₁ 751 or 743C user₁ or another user, creates post₁ₙₐ with text 749 where post₁ₙₐ 749 or 754E share of post₁ 741 can refer to or embedded in post₁, the share of post_{1 n} and/or post₁ₐₐ with in some cases anything relating to post, any digital media, content, links, hyperlinks, meta data, meta elements, objects, apps, articles, documents, scores, ranking, API, data, backlinks and/or information. Additionally user) or another user ₙ shares post₁ₐₐ 753. User that view the shared post₁ₐₐ of user₁ or another user ₙ can be referred 755C to post₁ₙₐ created user₁ or another user ₙ whereby also including in some cases anything relating to post, any digital media, content, links, hyperlinks, meta data, meta elements, objects, apps, articles, documents, scores, ranking, API, data, backlinks and/or information.

FIG. 7E Illustrates one embodiment where a user 110 posts 760 at least one photo, document, object, illustration, video, sound, or anything (761, 762, 763, 764, 765, 766) dictated by the system. According to various embodiments the same or one or more other users can tag and/or add distribution of objects to anything posted by the user 110. One embodiment a user posts a slideshow of images or document (761, 762, 763, 764, 765, 766). These images or documents each may have one or more tags or allocation by the same or by one or more other users. For example image 761 comprises of three tags (761A, 761B, 761C) whereby tag 761A corresponds to tag 761AA, tag 761B corresponds to tag 761BB, and tag 761C corresponds to tag 761CC. Another image (762, 763) within the same posts may have two tags (allocation 762A corresponds to tag 762AA and allocation 762B corresponds to tag 762BB) or just one tag (allocation 763A corresponds to tag 763AA). The number of allocation for a tag are theoretically unlimited, however the system may rank and present information to user based on variables determined by the system. For example variables like and/or combination of but not limiting to location, proximity, favorites retags, tags, the user who tag, user queries, number of visits. Each of these tags can relate to one or more other tags, posts, object, retags, users, etc. additionally the illustration is not meant to limit the scope of the invention whereby regions defined within and/or any part of any digital media apps or content within a post.

FIG. 7F illustrates a system 120 where one embodiment shows a post coupled by one or more tags by one or more users. For example user₁ posts 770 to the system 120 where right away or sometime after user₁ tags 771 the post from user₁ 770. User₂ also tags 774 the post from user₁ 775. User, represents one or more users, and/or same, and relating users that tags 766 and allocation of user₂ tag 774. User z could also be user₁, user₂ or any user within the system. From the said tags (771, 774, 776) user ₓ retags 772 the tag made by user₁ 771 and user_{y} retags (re-shares or reposts) 773 the tag created by user₁ 773. Similar examples is that user ₓ retags 775 user₂ tags and from the said tags (771, 774, 776) user₁ retags 777 the tag made by user, 776 and user_{y} retags (re-shares or reposts) 778 the tag created by user, 776. To further describe the system a user₁ who posted the original post 770 to the system can also tag and retag any other users tag or retag and by doing so creates relationships and correlations that are then scored and ranked by the system 120.

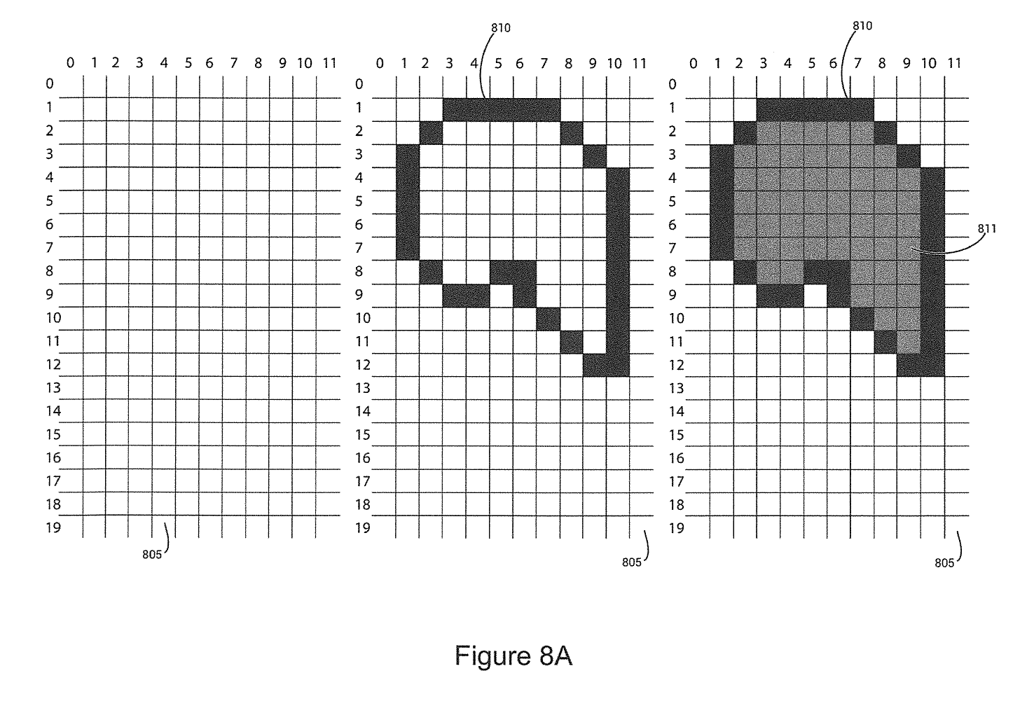

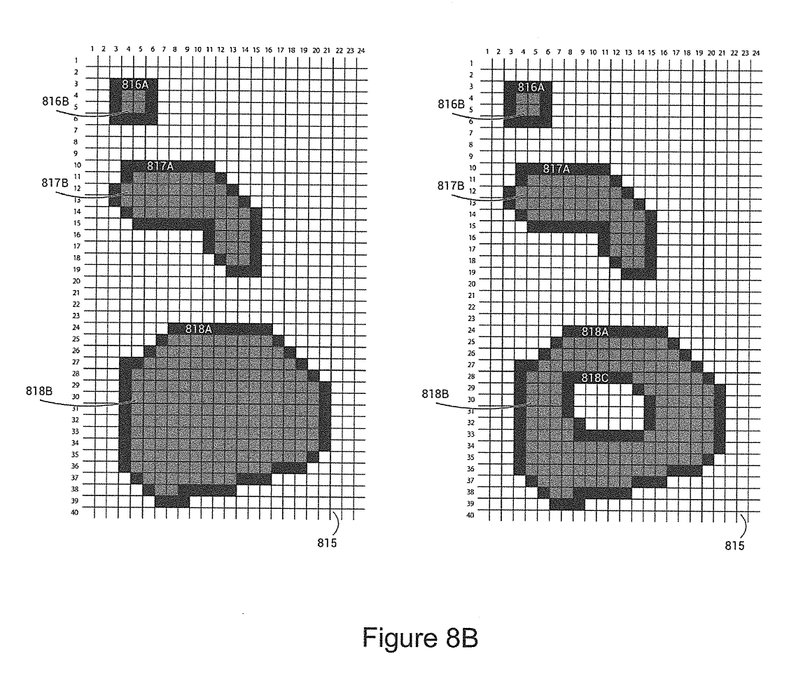

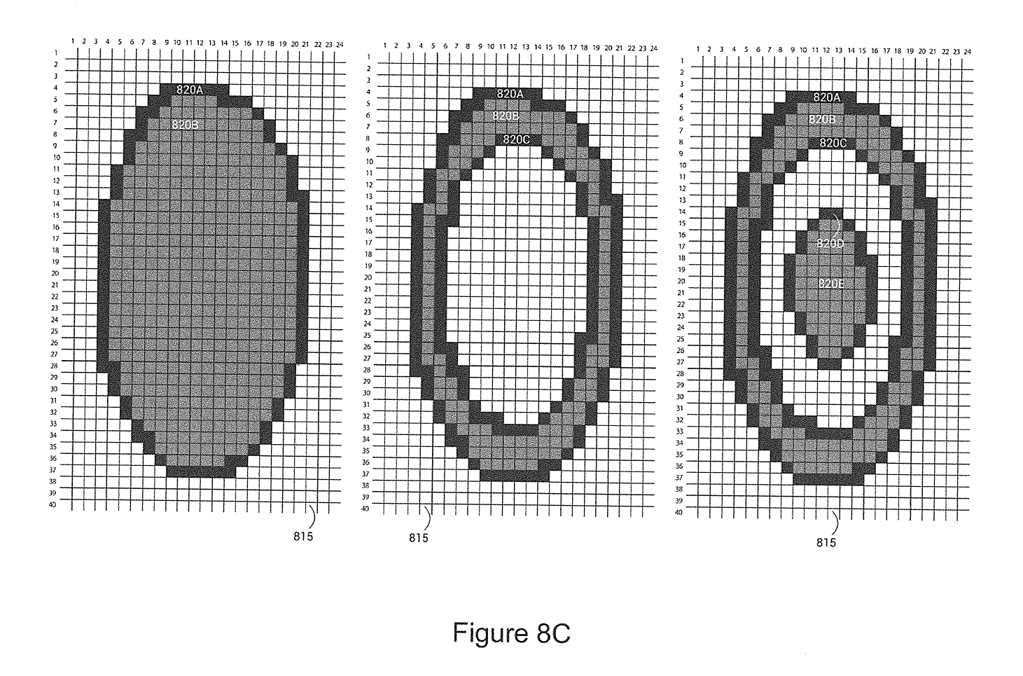

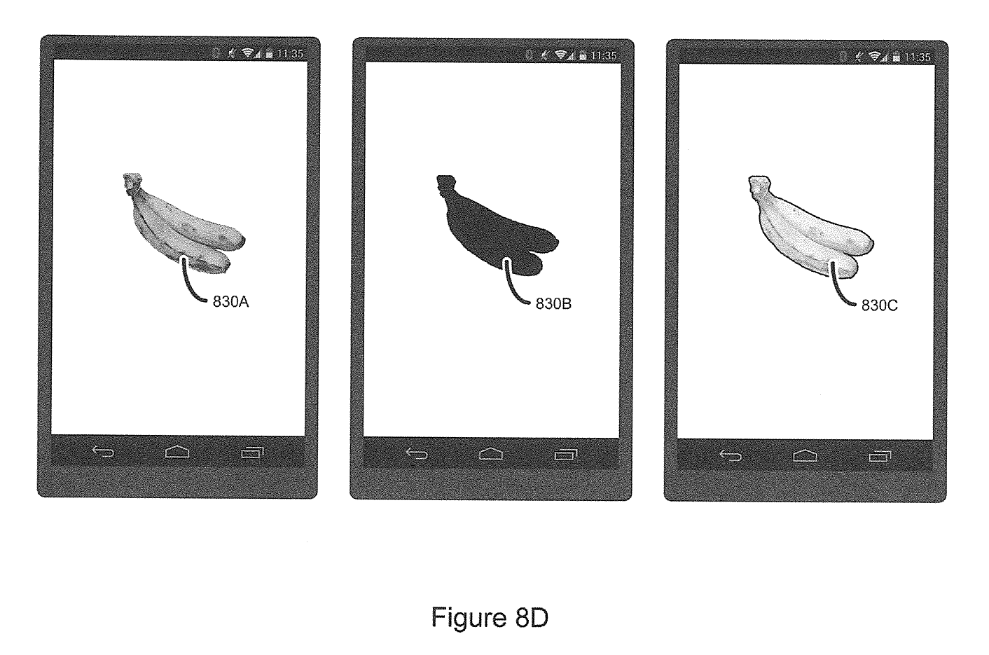

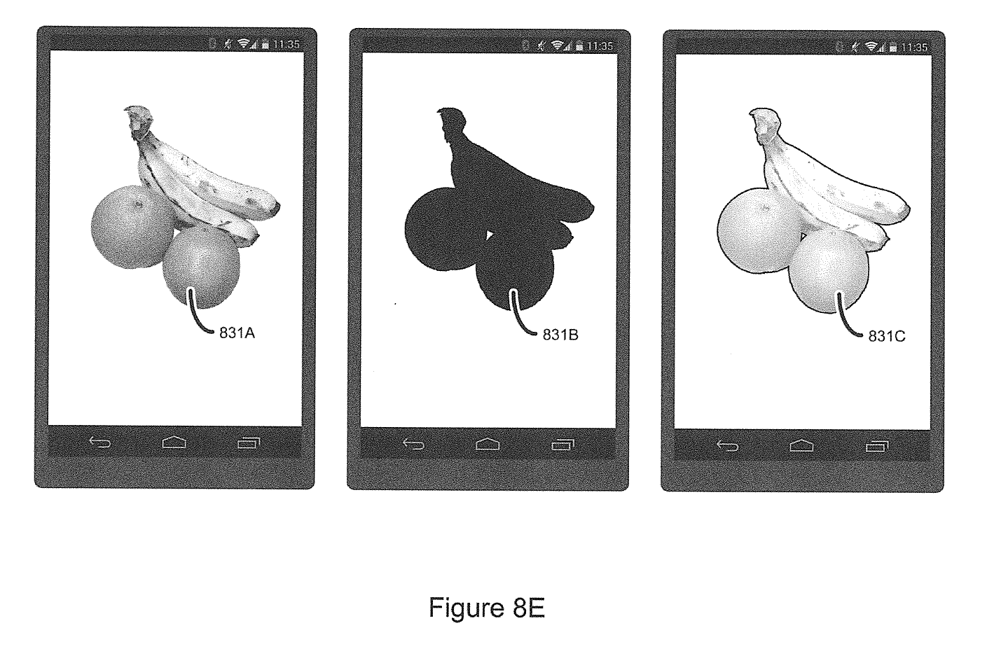

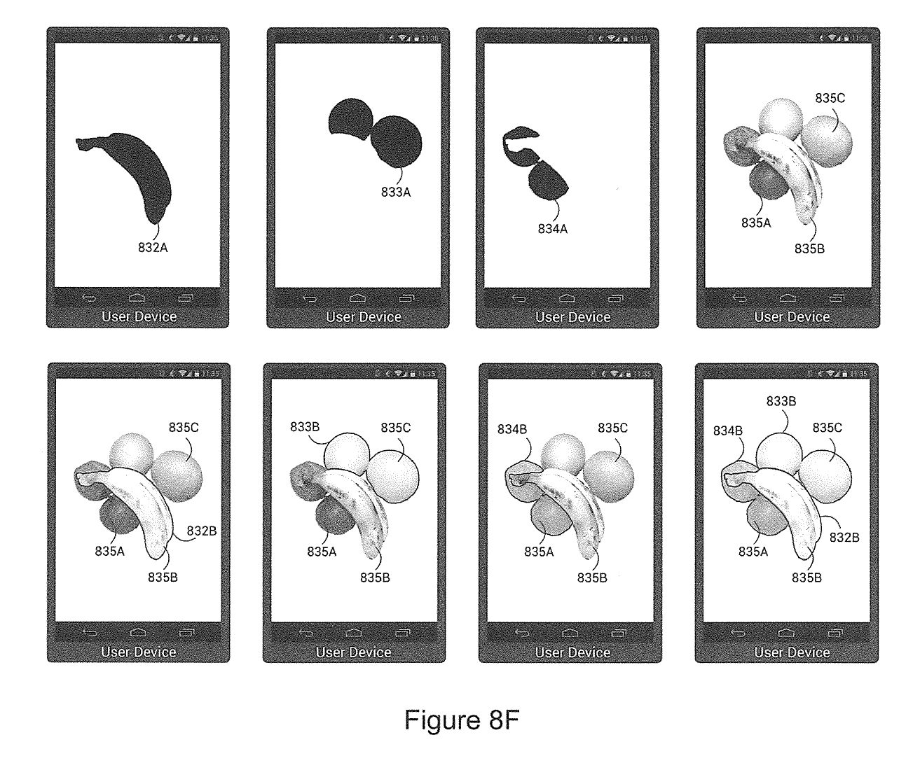

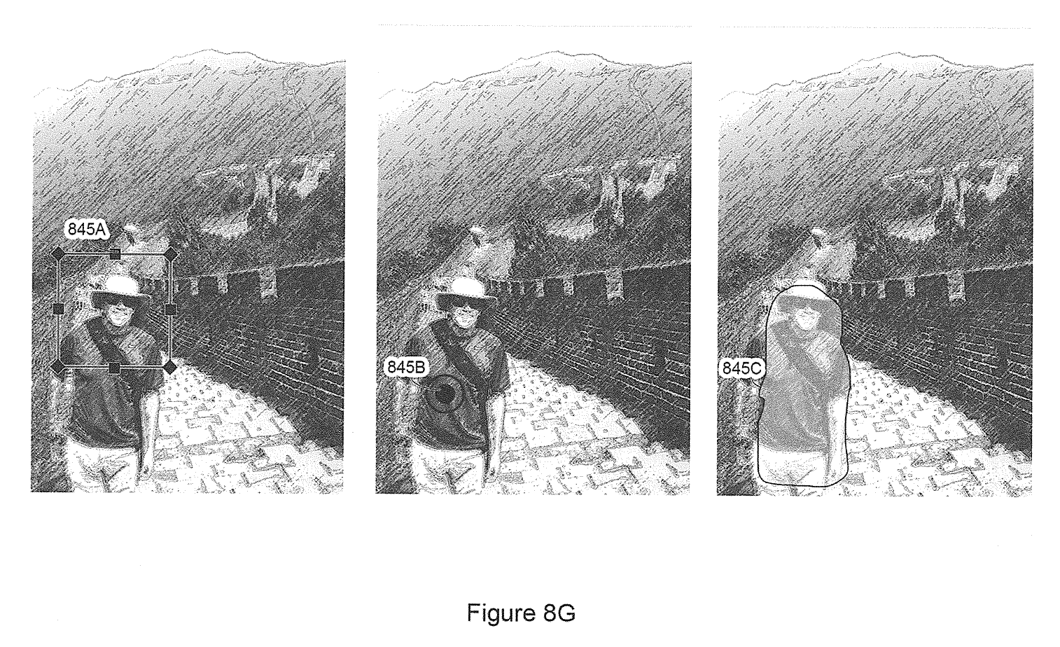

FIG. 8A-FIG. 8G in some embodiments illustrates visually how users and servers process information.

FIG. 8A illustrates pixel grids that act as reference points where in some embodiments defining an image. A user using a user device could create a shape, point or polygon 810 defined by a grid of pixels 805 and may define an area within a region. The region could include a method for manually recognizing an association within digital media that may or may not be shown to a user. The corresponding association could be one or more people, places, landmarks, buildings, businesses, restaurants, objects, figures, advertisements, etc. /

FIG. 8B shows more than one region in an image where recognizing an association within digital media. The regular polygon or rectangle 816A is defined by 4 points ((3,3),(3,6),(6,3),(6,6)) creating the boundary for area 816B. 817A and 818A are defined by multiple points for example 817A has a starting point where in some embodiments starts in the upper left corner for example (4,10) and continues to the next pixels ((4,11), (3,12), (3,13), (4,14), (5,15), (6,15), (7,15), (8,15), (9,15), (10,15), (11,15), (11,16), (11,17), (12,18), (13,19), (14,19), (15,19), (15,18), (15,17), (15,16), (15,15), (15,14), (14,13),(13,12), (12,11), (11,10), (10,10), (9,10), (8,10), (7,10), (6,10), (5,10)). In some embodiments a user or system may define a hole 818C within the bounds of the outer boundary of 818A and with the defined region 818B.

FIG. 8C illustrates in one embodiment where a user defines a polygon 820A with region 820B. Furthermore a user defines a polygon hole 820C from the polygon 820A defining the region of 820B. A user can further define a polygon 820D and region 820E from the polygon 820A with hole 820C.

In some embodiments a rectangular tool draws a square or rectangular selection borders, and the Elliptical tool draws round or elliptical selection borders. Other embodiments may include tools like the Lasso tool which draws freehand selection borders whereby enabling users to make very precise selections. Another example of a tool would be the Polygonal Lasso tool which draws straight-edged segments of a selection border user can create as many segments to draw a selection border. The

Magnetic Lasso tool automatically snaps to the edges of objects in digital media making it easy to draw precise selection over borders. A user can quickly select objects that may include complex edges set against high-contrast backgrounds whereby enabling a user to select regions with precisions and speed. A very powerful tool would include the Magic Wand tool selects pixels within a similar color range with one click where a user can specify the color range and tolerance and a user would use the Magic Wand tool when you have an area of similar colors. A quick selection tool is used based on color and texture similarity when you click or click-drag the area a user would want to select whereby enabling a user with simple and easy to use methods to mark and automatically and intuitively creates a border. A brush tool or Selection Brush tool makes selections where a user can paint over the area to select or paint over areas you don't want to select. The appearance in the user interface may in some embodiments resemble semi opaque overlay in Mask mode. A user may use one or more than one combination of tools, for example a user may roughly select with a marquee tool, or the quick Selection tool, or other selection tool, where by allowing a user to fine-tune and/or accelerate selecting. Other tools may include the magic extractor making accurate selections based on the appearance of foreground and background areas that a user or system could specify. The tool enables users to place colored marks in regions or areas to select, whereby using the magic extractor enables a user with easy methods to select people or objects from their respective backgrounds. For example, a user can select a fruit, car or bicycle from a photo. All of these tools can be used with a mobile devices and PCs, aided by touch screens, voice controls, and devices like a mouse or styles.

FIG. 8D illustrates how a user can define polygon to specify regions referencing digital media. From a user device an object 830A, construct an overlay of a region in some embodiment black to define the region within a system of corresponding region 830C.

FIG. 8E shows one region defined that may include 2 objects for example a banana and two oranges 831A. In some embodiments a user can define a region by a single color, like black 831A where a user can use gestures with a user's finger or instrument like a pen to draw a region. The outcome of a user defining the region will result in shape where one or more user can add tags to or see the indicting user context. FIG. 8F illustrates and array of examples that show a method visually to define multiple regions with multiple objects. For example a banana 835B, two oranges 835C and two apples 835A may in some embodiments be defined by black regions for banana 832A, two oranges 833A and two apples 834A to define the region for banana 832B, two oranges 833B and two apples 834B within various types of digital media. These regions could be simple polygons or complex shapes to defining a database schema like

#relative location in the parent image

top = IntField( )
bottom = IntField( )
left = IntField( )
right = IntField( )

Other schemas may include defining multiple points in the UI and then recording those points in the database.

Var polygonCoords = new tag.intField(

new tag.intField(n1,n2),
new tag.intField(n3,n4),
new tag.intField(n4,n6),
new tag.intField(n7,n8)

);

In some embodiments information may be needed for scale factors or other data like device screen size or ratio while in the same or other embodiment a starting point or distance from a starting point may be included in the schema. Other embodiments may include the selection point, then a string of points, defined by the system then the user can manipulate the region redefining the automatically selected regions.

FIG. 8G illustrates various user interface example of defining a region within digital media. Depending on the type of tag, will also define the user's ability and process to tag. In some embodiments the bounding region is an association that is manually and/or automatic recognized within digital media or post. Additionally the bounding region could be understood as just a point that could include the vicinity area surrounding. In some cases automatic recognition processing takes place of the bounding region with could be given value and weight for indoor, outdoor, gender, gender, race, glasses, Facial, Features, head, hair, headwear, clothing factors, eye color, occurrences, date, time location, metadata, person, place, businesses, landmarks, food, object, build, advertisements, complexion, height weather, plurality, logos, brands. In some embodiments servers could give value and weight for being outdoor, male, sunglasses, smiling, wearing a hat, t-shirt, bag-sling-camera bag, etc. Within FIG. 8G illustrating four examples of a user interacting with various types of Uls. The region defined by 845A is a simple polygon where user define the region as a square or a rectangle, in some embodiments the system understand four (4) points within the defined user device. Other data may be collected like starting point or screen size whereby taking the ratio and comparing it for user devices. The point defined at 845B is a single point or marker where one point or many points are collated. For example many point may be sent to the system whereby defining the region proximity where the outer (non-visible region to the user) is a circular or ellipse shape with the center point of where the user or system selected. A user may also draw 845C by using touch gestures, stylus or other devices or methods to define a shape whereby father defining the shape from the drawing could be made from individual points or polylines. To further define an area a user may use polylines whereby the polylines have endpoints and midpoints to define a shape. In some embodiments, the midpoint is in the middle of a straight polyline whereby a user could select and move (drag) the midpoint to a new position hereby creating an endpoint from the midpoint. From the created endpoint two (2) new midpoint are formed at either end of the new endpoint. The new midpoints if moved can create two (2) more midpoints. To further define the example, a database when receiving data from the user device may receive just an array of points with every other point being the midpoint.

In any example points may be taken to calculate the distance from the edge of the digital media or screen size whereby further defining to require depending on situation radius, starting point, direction, distance, defined shape class or other information required to associate a region defined by a user or a system within a post or digital media and apps.

In some embodiments the user will be given optional suggestions to the identity of the association while also providing the ability to search, add an identity while also selecting additional associations. Manually recognizing an association within digital media. The corresponding association could be one or more people, places, landmarks, buildings, businesses, restaurants, objects, figures, advertisements, etc. Features of various identifiers to a corresponding association. In some embodiments the user will be given optional suggestions to the identity of the association while also providing the ability to search, add an identity while also selecting additional associations. When selecting one or more points, the user may associate regions that correspond with one or more associations. This process could take place automatically. An example of association that is manually and/or automatic recognized within digital media. In some embodiments the bounding region could be understood as just a point that could include a vicinity area surrounding. In some cases automatic recognition processing takes place of the bounding region with could be given value and weight for indoor, outdoor, gender, gender, race, glasses, facial, features, head, hair, headwear, clothing factors, eye color, occurrences, date, time location, metadata, person, place, businesses, landmarks, food, object, build, advertisements, complexion, height weather, plurality, logos. In some embodiments servers could give value and weight for being outdoor, wall, geo tag, geocode in degrees, 40.67693° N 117.23193° E, Great Wall of China, history, 7^{th} century BC, etc.

In some embodiments the user will be given optional suggestions to the identity of the association while also providing the ability to search, add an identity while also selecting additional associations. When selecting one or more points, the user may associate regions that correspond with one or more associations. This process could take place automatically and indicators may or may not be visible. Points or indicators may vary in size shape color representation while also being interchangeable with buttons and buttons with features. One or more points can be interchangeable with buttons and buttons with features, including identifiers and features that enable users to find out more, call, message, share, getting information, directions, saving for later, adding to favorites, advertisements, settings etc. Method for automatic recognizing one or more associations within digital media that could take place at any time. The corresponding association could be one or more people, places, landmarks, buildings, businesses, restaurants, objects, figures, advertisements, etc., the bounding region shows association that is manually and/or automatic recognized within digital media. In some embodiments the bounding region could be understood as just a point that could include a vicinity area surrounding. Additional method for automatic recognizing one or more associations within digital media that could take place at any time. The bounding region shows association automatic recognized and explained within digital media 901. For example one way one or more server systems analyze bounded regions within digital media. The digital media, associations, and/or bounding regions are converted into digital data that will be made available for the user. Including one or more buttons or buttons with features. The corresponding association could be one or more people, places, landmarks, buildings, businesses, restaurants, objects, figures, advertisements, etc., In some embodiments the bounding region could be understood as just a point that could include a vicinity area surrounding. One or more points can be interchangeable with buttons and buttons with features, including identifiers and features that enable users to find out more, call, message, share, getting information, directions, saving for later, adding to favorites, advertisements, settings etc., while also showing a button with features of various identifiers to a corresponding association. In some embodiments the user will be given optional suggestions to the identity of the association, while also providing the ability to search, remove identities, setting tabs, and add an identity while also selecting additional associations. Implementing removal of identity would remove all digital data leaving the digital media unaltered; while the user implements remove identity feature which could, may or may not remove the data throughout the server system and databases. The user may organize additional information and configurations.

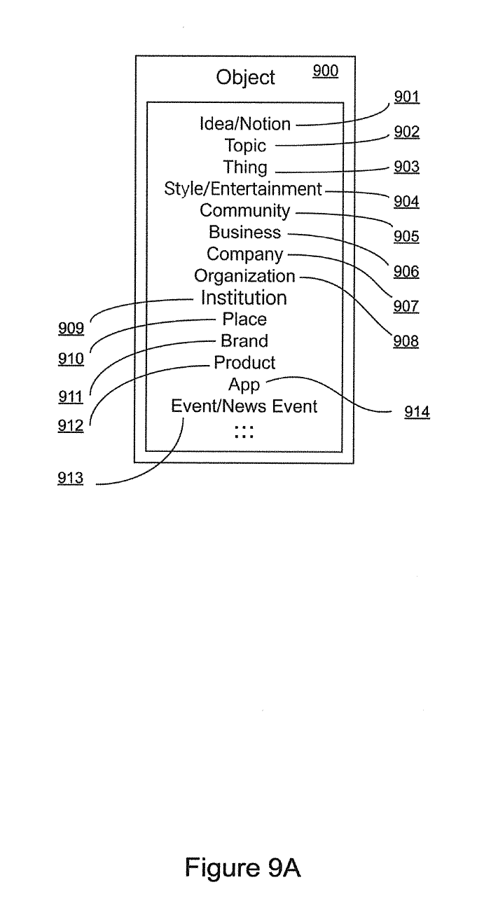

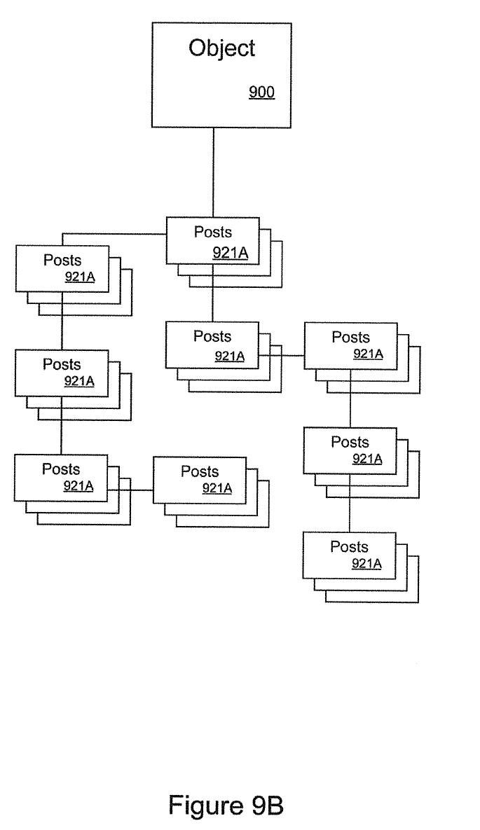

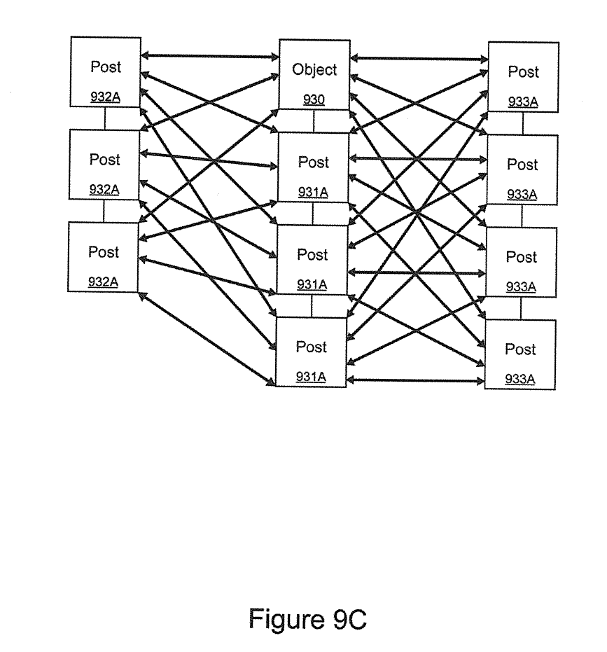

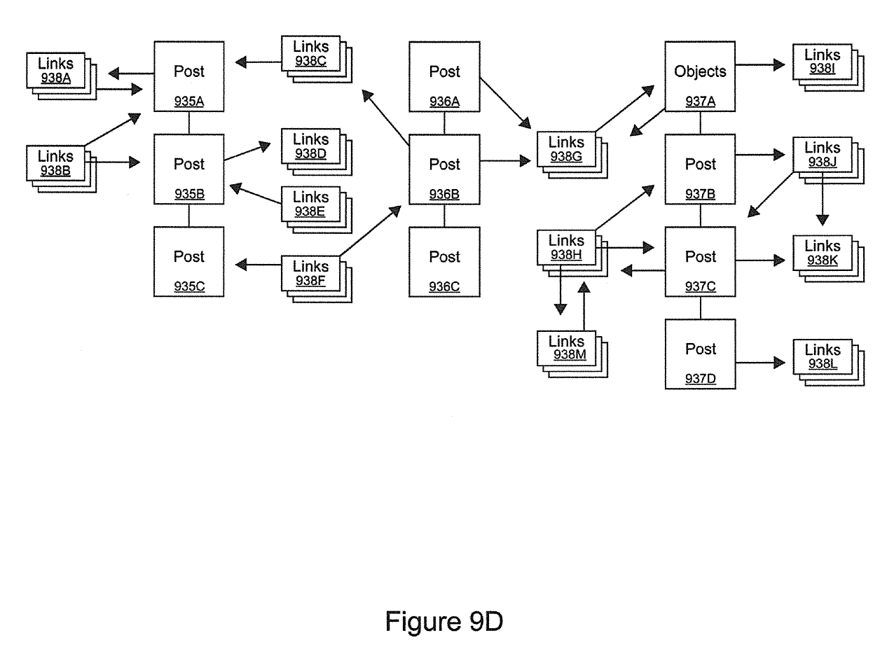

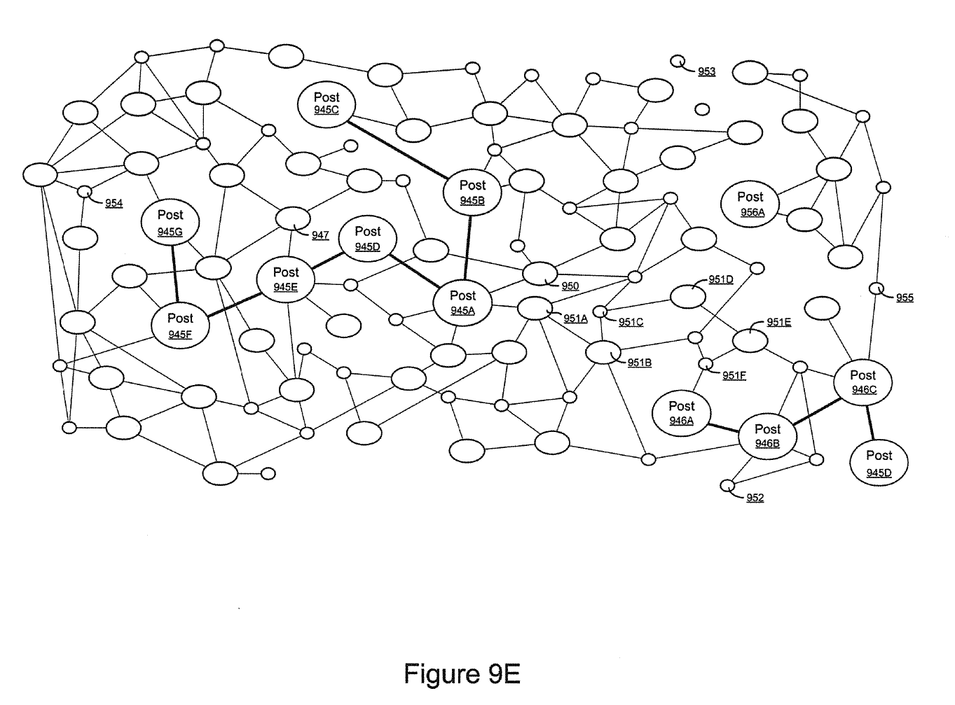

FIG. 9A illustrates objects that are part of the system, these objects 900 are created by one or more users and generated automatically by the system. One embodiment also includes that an object that is automatically created by the system be converted into an object that is managed by one or more users. Additional the reverse can also take place, where an object created by a user and then deleted may be automatically generated by a system. An example of this would be a city (San Francisco) where the government or representing agency would take control in managing some of the information of the city, but if the same example is used for the for the city of San Francisco events, posts, tags, retags and other objects could be shown, represented, and/or linked to the parts and/or the object of San Francisco. Another example of an automatically generated object is one created by one or more users as a whole updating information about something. This could be a restaurant, place, activity, etc, whereby using the example of a restaurant one or more users could create the object for a restaurant where at a later date a restaurant owner could take control over the same object created. Objects 900 within the system could be an idea/Notion 901, topic 902, Thing 903, style/Entertainment 904, Community 905, Business 906, Company 907, Organization 908, Institution 909, Place 910, Brand 911, Product 912, Event/News Event 913 and apps 914.

FIG. 9B is a diagram that shows an object 900 that is coupled within a system to another object 921A whereby objects 900 acts as a parent class for the child class post 921A. In return any post, tag, tags of tags, and retags can refer to and/or embedded in object 900. In one embodiment any posts 921A may have one or more posts 921A coupled to that same post , similarly tags and tags of retags whereby every tag has one or more retags and tags of tags also have any number of retags. A post can be coupled to one or more other posts and/or any part or portion of a post (for example digital media or content) may have one or more post couple to the originating post. Post like a web can relate to each other.

FIG. 9C illustrates a system that analyzes various tags, tags of tags, retags posts and objects whereby creating relationships and relevance relating the serving of data and information to a number of users who use the system and result in using the system through an API, Third-Party, developer, and/or client. These relationships between posts, tags, tags of tags, objects and retags in one embodiment can point to and be pointed at by posts, tags, tags of tags, objects and retags. For example Post can point to tag while Post points to post. Additionally a coupled tag can have a retag whereby tag and retags are not couples but form a relationship. In a chain of posts and posts that can refer to or embedded in another posts can point to other posts within a system. For example coupled posts 932A, objects 930 coupled to posts 931A, and other posts coupled with a number of post coupled 933A. It is important to note that even if posts are not coupled or linked together the system may relate the plurality of non-coupled or linked posts and show any relationship to one or more users, search results, and feed lists. Posts may also refer to one or more links, users and/or objects.

FIG. 9D illustrates how any number of objects, tags, posts, can have relationships to and from one or more and combination of other posts, tags objects and retags that are and are not coupled (decoupled). Similar to relating post, tags, objects and retags with one another, links within each posts, tag, retags, and objects and from websites. The system can either find or support links that relate to one or more post, tags, retags, and objects. For example links can point to any number of Posts, tags and retags and any number of posts, objects, tags and retags can point to links. In some embodiments a user may have posts, illustrations, documents, or images on a website or other applications, whereby the posts, illustrations, documents and/or images are supported by the system. The API (Application Programing Interface) allows one or more user, third-party content providers, third-party service providers, clients, advertisers, and developers to access information, apps, content and data from the system. In other embodiments the system may communicate with other systems, other APIs and one or more user, third-party content providers, third-party service providers, clients, advertisers, and developers can send information, apps, content and data to the system. Various User interfaces can function and communicate with the same system offer different applications for a plethora of reasons and functions. In some embodiments, coupled posts (935A, 935B, 935C) can refer to links and/or have links embedded within and one or more links can have one or more coupled post embedded. For example Post 935A can reflect a relationship with link 938A, additionally links can refer to or show a relationship to other links, while also not limited to linking post that have one or more relationships with links. Post and links can point to links that do not refer to any other post or other link. For example, Post 937C points to links 938K and Links 938J point to Links 938K, Link 938K does not point to any link or posts. In other embodiments, Links can only point to one or more other Links. For example Links 938H and Links 938M can point to each other.

FIG. 9E illustrates one or more posts within a system where posts, data, users, objects, digital media, content, tags, and links may be represented with relationships. In some embodiments posts are a simple method for a user to contribute to a system, where in addition to and in most cases the system creates relationships with everything within the system, with third-party providers, developers, content, the world wide web, data and other information. Through a web of data, content, information, digital media, comments, favorites, location objects links posts can relate to one another even if they are not directly coupled by users with the disclosed invention. For example post 945A can have one or more posts coupled like Post 945B and Post 945D. In some embodiments posts that contain content allow users to add or contribute to that same coupled post. Where posts that contain text are limited in the value were adding digital media to coupled posts with just text may in some embodiments be restricted through the User interface or various other techniques. In a very simple example non-coupled posts can link to one or more other posts and coupled post by relating relationships found within and though providers, third-party platforms and the world wide web. In some cases through the internet or intranet. For example Post 945A and Post 946A are distance and not coupled, however using various forms of algorithms, methods, while also determining relationships, ranks, scores and metrics, a path or relationship is found connecting Post 945A and Post 946A. Through various forms of data, information, from the world wide web, links, users, activity, involvement, tags, objects, third party providers, developers, third party platforms, subscribers, locations, businesses digital media and content, the path 951A, 951B, 951C, 951D, 951E, 951F can link and/or connect Post 945A and Post 946A. Data, information, from the world wide web, links, users, activity, involvement, tags, objects, third party providers, developers, third party platforms, subscribers, locations, businesses digital media and content (954, 947, 950, 951A, 951B, 9510, 951D, 951E, 951F, 952, 953, 955) can be identified where the disclosed system will try to relate information to, for anything in the past, present (real-time) and future. The system will continuous try to relate information that has associations and no associations 953. Other embodiments represent a single relationship point 955 that links Post 956A and Post 9460.

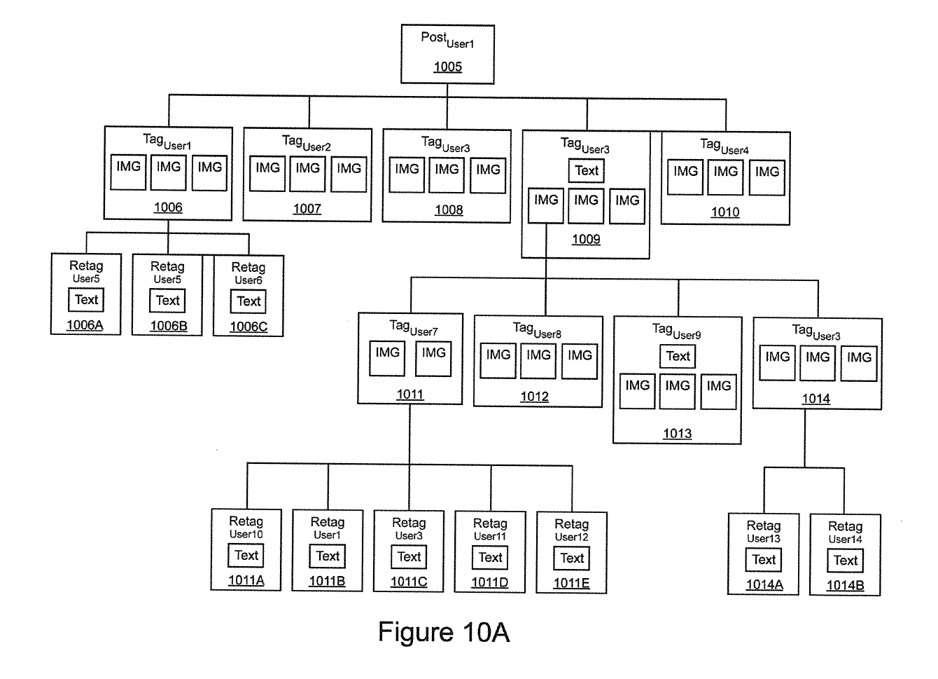

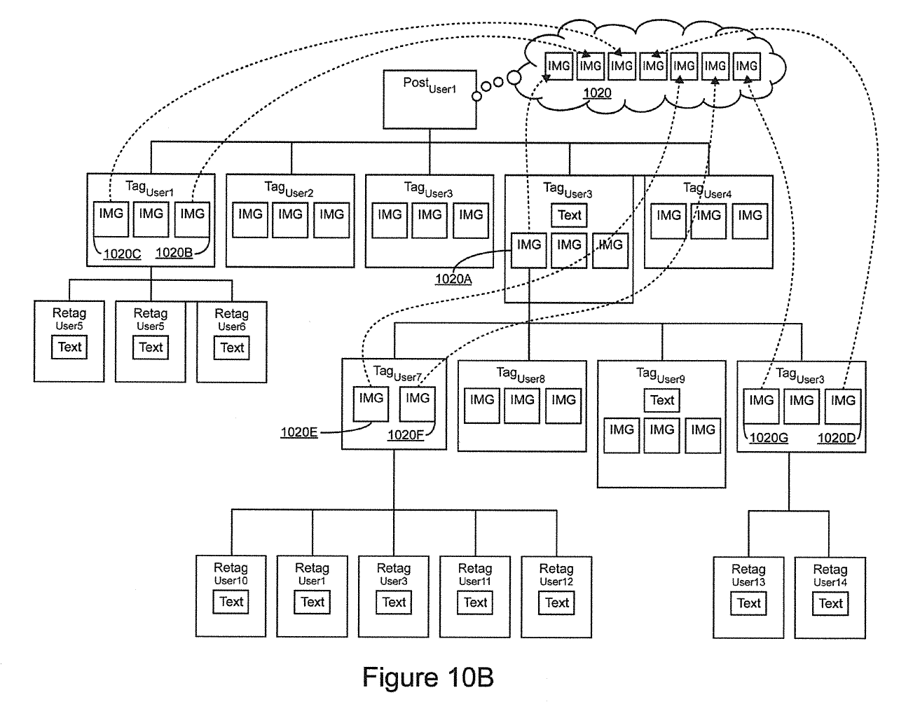

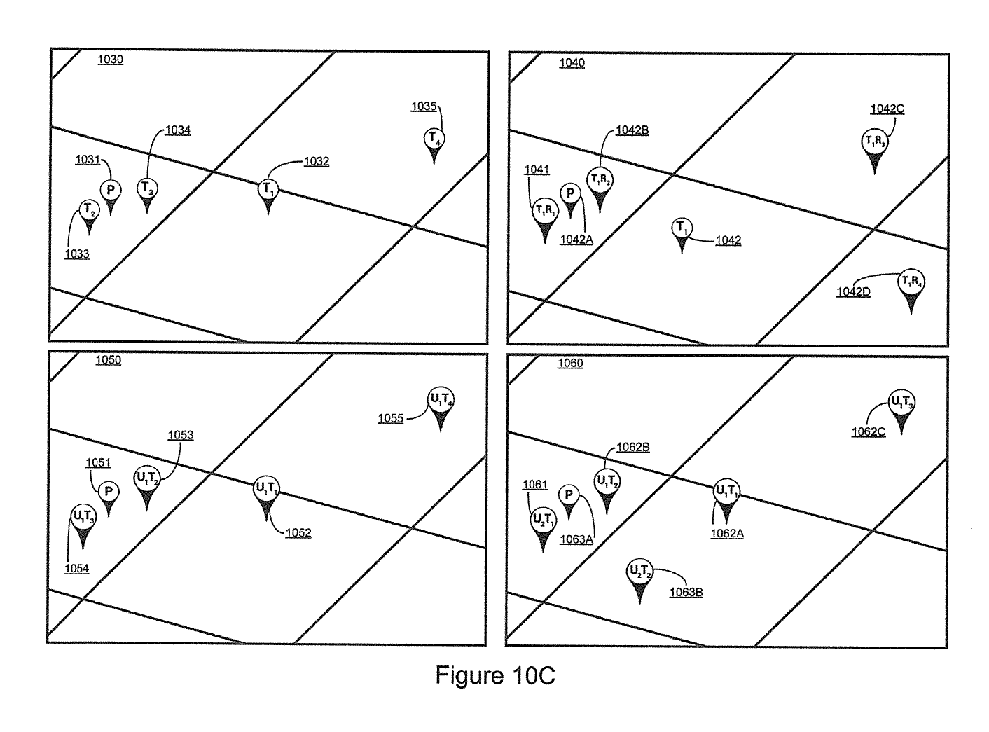

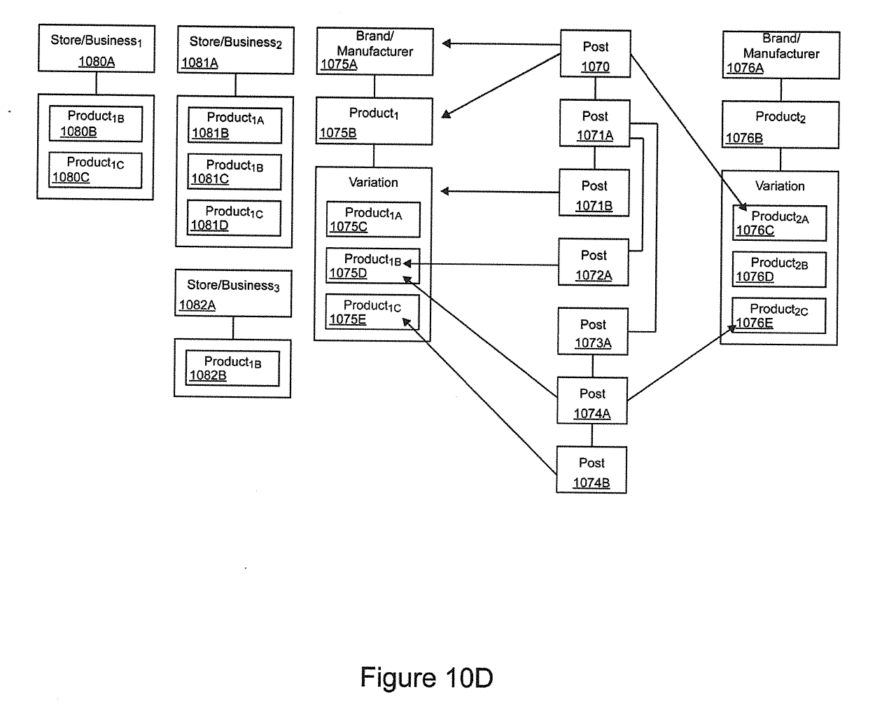

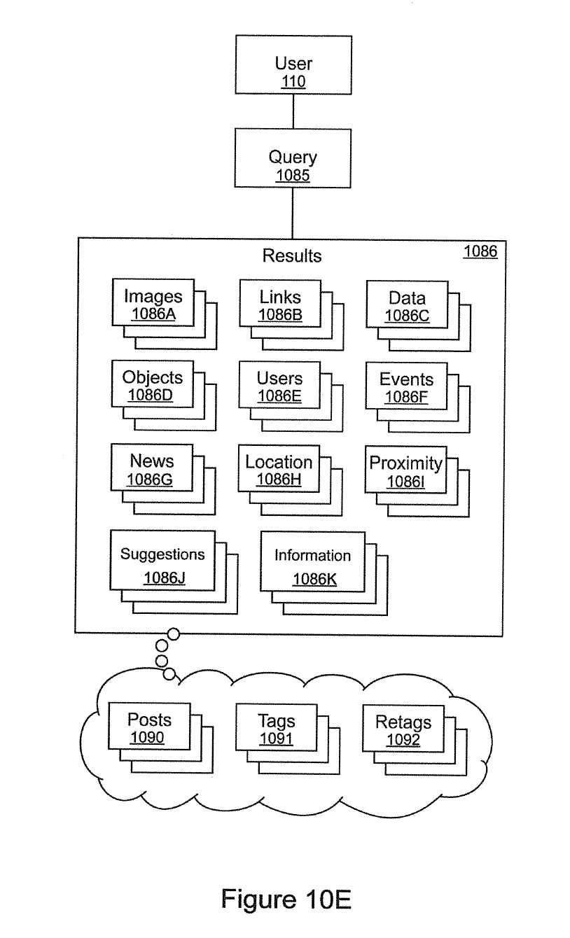

FIG. 10A illustrates a post with a series of tags, tags of tags, and retags from a plethora of users. Relationships between user's interactions aids the system in determining relevance and ranking within a system any interaction within the system. In one embodiment, FIG. 10A illustrates a post from user₁ 1005 whereby the post is tagged by one or more of the same user and other users. User₁ tags 1006 the post 1005 by adding in one embodiment with images. Other users like user₂ (1007), user₃ (1008 & 1009), user₄ (1010), tag user₁'s post 1005 by adding text and images. Any of the said tags can have any number tags and retags coupled to any tag and to the original post. The same user can also tag the same post multiple times, for example user₃ tagged (1008 & 1009) the post made by user₁ (1005). In one embodiment the tag made by user₃ (1009 of the post from user₁ (1005) can have on or more tags (1011, 1012, 1013, 1014) by any number of users (1011, 1012, 1013) and/or the same user (1014). Additionally, tags of tags may have any number of tags, tags of tags, and retags. For example FIG. 10A also illustrates a tag of a tag 1011 having one or more retags (1011A, 1011B, 1011C, 1011D, 1011E) and another tag of a tag 1014 having one or more retags (1014A, 1014B).

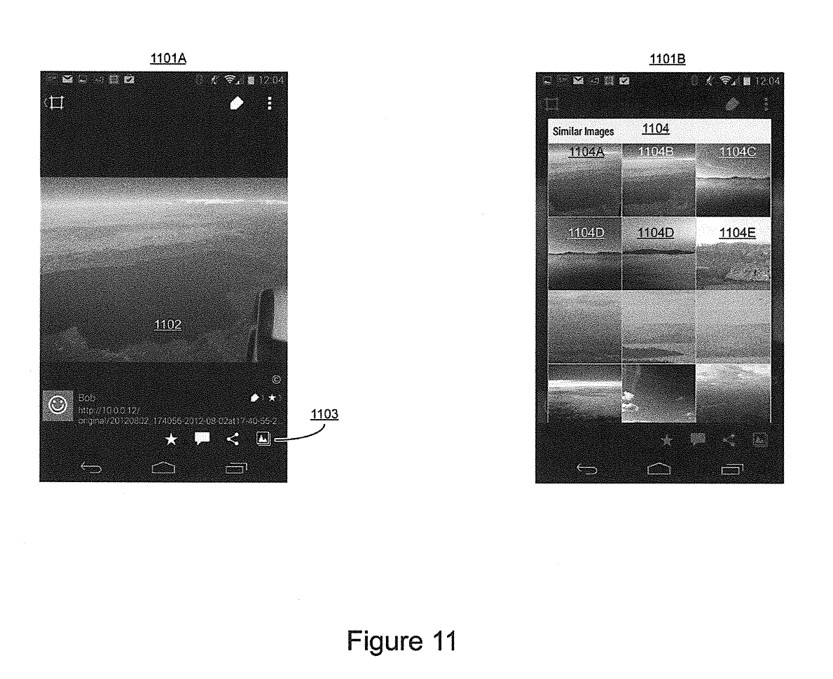

FIG. 10B illustrates possible (relatively simple) relationships formed by tags and retags or formed by coupled Posts. In one embodiment, the system can score and rank any interaction where images tagged by the same user uploaded a post to the system is ranked higher than other photos tags. Additionally tags with retags show more of a significance than tags without retags. Also tags that one or more additional tags, tags of tags, and retag may show a plethora of relevance and scores to be ranked within the system. Another example for finding simple relating interactions within the system like posts, object, tags, and retags and/or parts or combination of parts would include in one embodiment images or an image of a tag that is scored and ranked and presented to a user. For example a user may want to find one or more additional posts, tags, retags, contents, users or anything else managed by the system. In FIG. 10B the illustration shows one or more tags and tags of tags with retags of a post where a user can find relating images associated with the post whereby the system presents these images with the aid of a user interface and found with anything connected to but not limited to the system. One or more images like (1020A, 1020B, 1020C, 1020D, 1020E, 1020F, 1020G) are presented to a user whereby an example of showing related images is shown in the screen shot from a user device illustrated in FIG. 11.

FIG. 10C shows one or more embodiments relating to proximity or location. A location 1030 can be found anywhere in the world, where in one example a post with coupled one or more tags illustrated where the tag was made. In some embodiments, the tag or post has content that relates to a location or an embodiment like an image where the images was taken near close to or nearby other posts and tags. The system can also analyze content within posts, tags, users, objects retags whereby scoring and ranking each and comparing with other posts, tags, objects, retags and other content/links. Location 140 illustrates post, tags and retags, where in some embodiments shows that tags and retags include one or more dimensions for ranking and scoring whereby tags that are closer to the couple or other posts may than other tags may be ranked lower or higher based on other objects, post, tags and retags. Example of various dimensions would include number of tags, tags of tags, retags, content, allocation, links, other objects, proximity, time of day etc. Location 1050 shows a post 1051 where in one embodiments user₁ has multiple tags coupled to a post of a user or same user. The post and tags show higher significant to users feeds and search resulting from the tags that are within various proximity to the coupled post. Other dimensions are also incorporated in the affinity of the tag and post and everything relating to. Location 1060 illustrates how a post can have one or more user's tag where each user can tag the post multiple times. Proximity of the tag and post may be given a value for other users to be served within the system. One or more interaction by a user with a system may be displayed in a feed for one or more users searching and/or following that user. The system can also build data profiles for every user with or without an account whereby scoring and ranking every interaction with the system.

FIG. 10D illustrates Posts, tags, retags, and tags of tags relating to one or more objects. In one embodiment a brand or manufacture may have one or more products where each product has one or more variation. An example of a brand would be clothing brand inc, where the product₁ could be style₁ (shoes) and product₂ could be style₂ (football shoes). The variation for product₁ could be style₁ (shoes) color, style, gender etc. additionally stores, businesses (physical or ecommerce) can sell any product and/or various of the Brands/manufactures products. Inventory and SKU may reference one or more products. The system may have one or more Post tags retags tags of tags and objects relating or pointing to a brand manufacture, product and/or variation. In one embodiment a user could be tagging a review a story or more images about a variation of a product from a manufacturer. Additionally, FIG. 10D illustrates an embodiment that includes posts the point to brand/manufacture 1075A where the same brand/manufacture has a product₁ that the post 1070 also points to. Additionally post 1070 also post to product_{2A} 1076C of the brand/manufacture 1076A. in the same embodiment retags can point to variations as a whole 10718 and tags and retags can point to one or more products for example like Tag 1074A pointing to product_{1B} 1075D and product_{2c} 1076E. Also tags may be used to help with inventory in stores or confirm inventory of one or more products where users or even employees of the store can report and confirm with one or more user looking for a certain product. Much like tags, posts within a system, simply acts differently depending on a user's input and response. For example, images, links, videos, text, shared, documents, other content and data that a system can recognize while also not limited by or through an API, apps, EXIF data, metadata, meta elements, meta tags, and/or objects. Additionally post can be created from any part of another post, for example from digital media (videos, images, audio), links, files, and documents. Posts can also refer to products, brands, manufactures, and variations. One or more posts can be coupled together (1070, 1071A, 1071B), additionally Posts 1071 are coupled to posts 1072A and Post 1073A. Post 1073A are coupled to Post 1074A and Post 1074B is coupled to Post 1074A.

FIG. 10E illustrates a user querying the system for results. The user may be presented with one or more Images, Links Data, Objects, Users, Events, News, Locations, Proximity, suggestions and information whereby including and any of results can comprise of Posts, Tags, and Retags. Additionally embodiments of the system performing queries from a user whereby the results may be displayed in various user interfaces differently to include images, links data, objects, users, events, news, locations, proximity, suggestions, and information that may take the form of posts, tags and retags.

FIG. 11 illustrates a screen shot of an image (just one type of digital media) and a user interface like page viewer, action bar and other information like user profile image, username, location, link, crawled information favorites, shares, comments and relating button. The related buttons brings up association related to digital media. The system can relate data and information between digital media and posts through various methods. For example the system can match pixels and colors, bring up the highest ranked digital media or posts, by one or more links or urls, metadata, objects, posts, tags, retags, followers, followers users or by other methods like explained in FIG. 10A and FIG. 10B between one or more user and relationships. In some embodiments, methods may include using proximity like in FIG. 10C, or objects, or products like in FIG. 10D. Additionally examples may be taken from a variety disclosed in this invention.

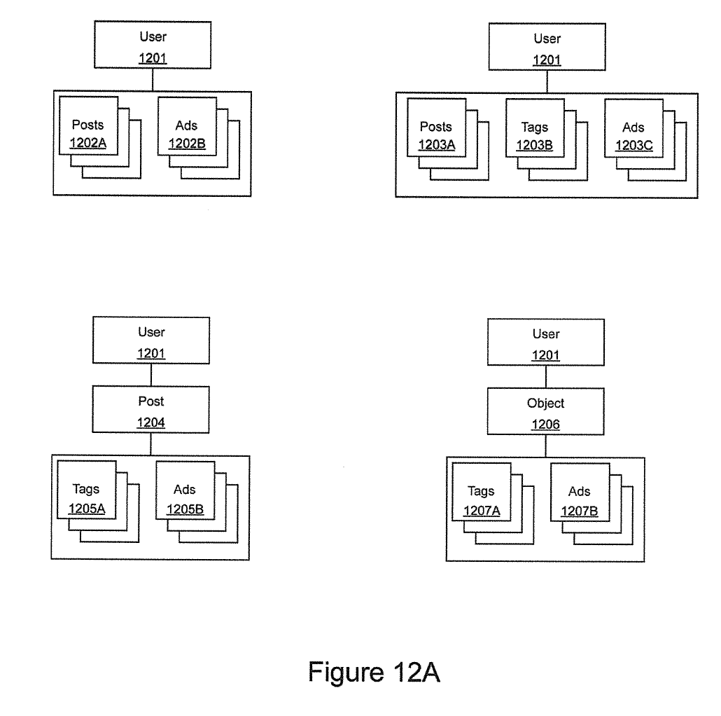

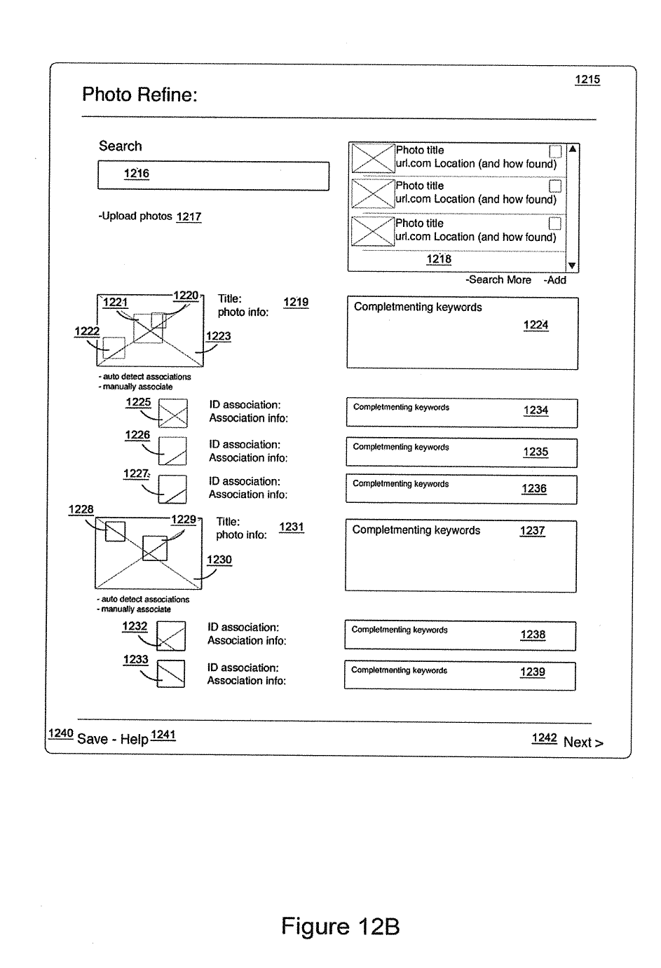

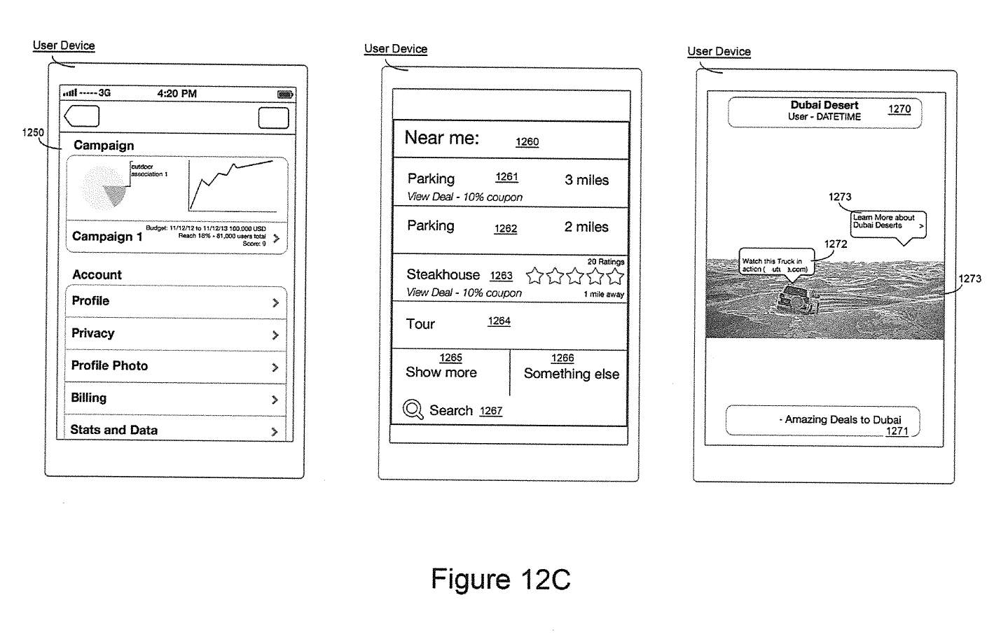

FIG. 12A illustrates advertisements coinciding with posts, objects, tags, apps, and other user actions. For example, user 1201 couples to Posts 1202A and 1202B. In other embodiments a user 1201 are coupled to 1204 and posts coupled to tags 1205A and Ads 1205B. User 1201 are coupled to Posts 1203A, Tags 1203B and Ads 1203C. Other embodiments, users 1201 are coupled to objects 1206 wherein objects 1206 are coupled to one or more tags 1207A and ads 1207B.

FIG. 12B illustrates methods for creating posts within digital media that may act as advertisements. Refining the digital media or posts 1215 can also save 1240 progress, help 1241 and go forward with progress 1242. For example a user can search 1216 for digital media and content to tag where one or more advertisements may or may not be shown to a user. Advertisements within digital media and content can have advertisements with one or more digital media, content, text, payment, and strategy. A user can upload one or more photos 1217. Searched photos can be found through the web 1218. One or more regions (1220, 1221, 1222, 1228, 1229) of digital media (1223, 1230) within a posts. In some embodiments corresponding regions within digital media may have one or more associations identified (1219, 1225, 1226, 1227, 1231, 1232, 1233) and complementing keywords (1224, 1234, 1235, 1236, 1237, 1238, 1239).

FIG. 12C illustrates from a user device embodiments used by the system to track analytics, nearby items with deals, of a promotion introduced by a post and or advertising campaign. In some embodiments, Analytics may include basic options to view advertising data through tables, graphs, and reports. Aided and managed or individual managed, both at the campaign level or simply level. Table Data organizes the data of through metrics like Impressions, clicks, money spent, name, status, CPC, etc. Graphs give you a visual representation of the table data, where a user can compare campaigns. Reports illustrate useful data to evaluate a user's advertisement by evaluating performing and gives insight strategically used to further optimize advertising campaigns effectiveness. Reports may include Advertising Performance Report illustrate detailed information in various formats for individual advertisement including metrics such as impressions, clicks, money spent, CPC etc. Demographics report provides information on the type of users interacting with the system, interacting with the advertisement or viewing a user's advertisement. Impression report illustrates a count of actions along with the impression time they are attributed to. Impressions can also link length of time between and when a user views or clicks on an advertisement and conversion. Interaction report illustrates information regarding user engagement, such as the number of photo views, followers, posts, views, favorites, and video plays. Feed report illustrates the average position and or placement of a user advertisements and/or promoted stories in news feed, including any statistics about impressions, clicks, CTR, etc.and various other analytics.

Further defining a system local data can be presented to a user for the best results and some of the best deals. For example proximity or near me 1260 illustrates a venue to park 1262, steak house 1263, tours 1264, parking deal 1261, show more 1265 and something else 1266 as well as search 1267 options a user can interact with any of these provide by the system, developers, advertisers, third party providers and or third party platforms. Other information and data could be presented to a user like rating, deals, live coupon with and without time restriction, in store coupon, other tags, images, other posts etc.

Post and or digital media may be presented to a user or viewed by a user through a user device. Other information or regions identified or asked question but user or advertisers, or through an API may also include user who created post, or digital media title date, links to questions (that have answers), other posts with or without and or combination of or without digital media, content and/or text, and other deals (i.e. like travel 1271, flights, food, activities etc.). In some cases an active window or menu with options leading to enabling users to perform certain function and/or tasks. The user may have the ability to implement features relating to calling, messaging, Social, Social web, direction, search, of one or more people, places, businesses, objects, landmarks. In some embodiment features presented to the user are more convenient to the user than other features that are based off user configuration and setting, as well as user tendencies. The directions active window could have the name of the association with other information while allowing the user to select a map service location (Bing maps, Google maps, apple maps, Nokia maps), while additional service could be presented, like profile, settings or have the ability to search. After setting a preferred method of directions, the use could be presented with driving, walking, bus routes, time, distances, running times etc. In some embodiments using information on where a user is going could also allow for other forms of advertising like using digital billboards to show an advertisement related to one or more users passing by said billboard.

The said advertising platform may act as a combination or used separately that would include interface, advertising sales, advertising serving platform, marketplace platform. In some embodiments, the said advertising platform may use demographic profiling, location/proximity profiling, micro targeting, themed advertising, including advertising tracking (and response) whereby information is collected on actions, locate, glance, clicks, or codes. The advertising platform may include may include various specific methods for a computer operating system or by one or more application programs whereby an advertiser or programmer writing applications programs could make requests of the advertising platform (operating systems) or one or more other application. Cookies (session, persistent, tracking, etc.) may aid the said advertising platform to serve the best advertisements for users/requestors and advertisers. Other types of advertisers may include (but not limiting to) print advertising (newspapers, magazines, brochures, fliers), Digital printer advertising (Digital newspaper, digital magazines, digital brochure, digital fliers) outdoor advertising (digital billboards, billboards, kiosks, trade shows, digital trade shows, events), broadcast advertising (TV, Radio, Internet), convert advertising, superstitial advertising, mobile advertising, interstitial advertising, and map advertising. Also included are various formats of text, display pop-up, flash, video, email, onsite-sponsorship. Some basic targeting methods include contextual targeting, behavioral targeting, geo-targeting, proximity targeting, and local advertisings. Similar examples include where an advertiser (including consumer, businesses anyone who has an intent to create an advertisements.) In some embodiments the advertiser is presented with one or more windows that may guide the advertiser to customize and deliver advertisements.

In some embodiments window where an advertiser may make from a selection of buttons. In some embodiments the advertiser will be asked, “I need to create an advertisement” or “I have an advertisement ready to use” between these two question the said invention will be able to determine a plurality of data from the advertiser. Some data would include that the “I need to create an advertisement” the said invention may need to take additional steps to complete guide an advertiser through the completion of creating an advertising campaign. Whereas “I have an advertisement ready to use” is probably not the first time the advertiser has used the said invention and/or has experience creating the advertisements. Regardless of experience there may not be an exclusion of services from the novice to the experienced advertiser. Additional services and or features may be made available to one advertiser and not available to other. For example differences of features may be the result of a fee based system, high value client, and or long term repeat customers other services may include a freemium model with a tiered fee system. The window may also include a title describing the window, more options that could include a more technical approach to creating advertisements, and/or a button that would advance the advertiser to the subsequent window. Additionally services may be included to developers or interacting with the system without a user interface from a client, provider, developer etc.

Similar examples illustrate where an advertiser may make from a selection of buttons. In some embodiments the advertiser will be asked the criteria that narrows the scope on the type of advertisements needed by the advertisers, for example determining whether the item to be advertised is one or more product, brand, local business or place, website, company, organization and/or cause, multimedia (music video, photos etc) and event (other options may be include). Advertisers may also search for possible additional criteria that may narrow the scope of the advertisement. The window may also include a title describing the window, more options that could include a more technical approach to creating advertisements, and/or a button that would advance (next or skip) the advertiser to the subsequent window. In some embodiments the advertiser will be asked about general information that may include Campaign name and description of the campaign The window may also include a title describing the window, more options that could include a more technical approach to creating advertisements, help, and/or a button that would advance (next or skip) the advertiser to the subsequent window.

In some embodiments the advertiser may be asked to associate images and association within images that may aid in reaching target users farther and faster. The said invention allows for advertisers to find and or upload one or more photos that may broaden reach but refine advertising campaign, while also allowing for people to search faster. For example the image 1145 can be auto associated and or manually associated with one or more associations (while also including compliment date that may include a keywords links, hastags, urls etc). Whereby each association can be further defined with keywords, links, uris, tags, storefront, etc. The window may also include a title describing the window, more options that could include a more technical approach to creating advertisements, help, immediate response for help, and/or a button that would advance (next or skip) the advertiser to the subsequent window. A practical understanding (example) would be like. In some embodiments the advertiser may be asked to enter information that will define the scope of the advertising campaign (advertising in context). Whereby the presented window includes various categories and subcategories that establish a more refined and deeper understanding, for example digital media map, interests, habits, active participation, ownership, individual, keywords. Most windows will contain an area selected category. Although most defining information is option, filling in any additional information may or may not greatly impact advertising campaign and or said invention. In some embodiments including a way to associate advertising to photos taken or relating to various regions around the world. The presented digital media map would be interactive and could zoom in/out, pan to various selectable region as well as identifier areas of interest along with defining a uniform and/or like uniformed area around the identifier). For example identifier is place in between The United States of America and Canada (advertising many mountain and ski towns and mountains) showing a radius of 200 miles. Another example may include an advertiser defined region where a defining area that is not uniform using the identifier (sharing a boarder of Canada and the United States of America near the American Midwest) where the defined area is 355 miles. Other defining criteria for regions of where photos are from may include whole regions/countries, also including other data that a photo would be used to define a photo taken in a certain region. Not excluding and adaptable for photos taken from outer space from this galaxy and others. The window may also include a title describing the window, more options that could include a more technical approach to creating advertisements, help, immediate response for help, and/or a button that would advance (next or skip) the advertiser to the subsequent window.

In some embodiments the advertiser may be asked to enter information about active participation, whereby the advertising would include context of how the advertising campaign is defined. If a user actually does something or activity (a sport like skiing) then we can actively target to them. The intention is to find out the amount that one or more user (target audience) actively participate in what they like, want to do, and/or are passionate about. This includes hobbies, interests, and other ways users have a repetitive participation in. Additionally an advertiser may be asked target people who own certain product and/or items. Ownership tells provides an extreme amount of data for advertising campaigns and can identify and establish a link for understanding users and how to target to them. For example owning a Mercedes s550 shows an amount of wealth that advertisers could use to advertise other categories like fashion, electronics, etc. Other embodiments the advertiser could be presented with a summery chart where one or more advertising campaigns are set up. Also presented might be charts, pie graphs, bar graphs that show everything. The said charts and or graphs could display information showing how effective the advertisement is by showing potential reach (with resects to budget) and current performance. Some examples include showing on a user device the ability to gain insight and define criteria for advertising campaigns.

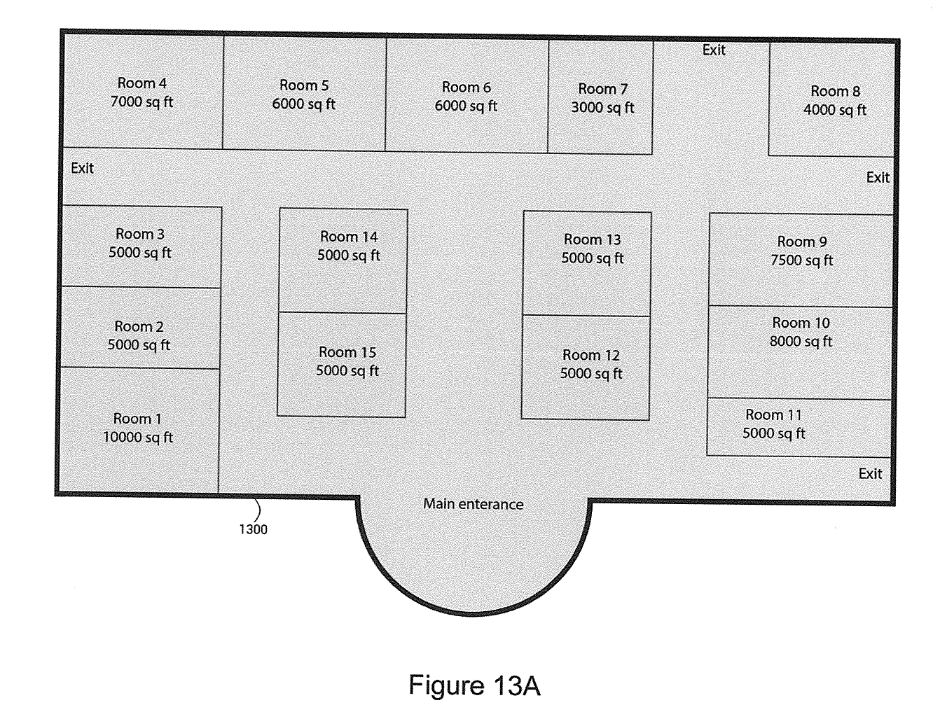

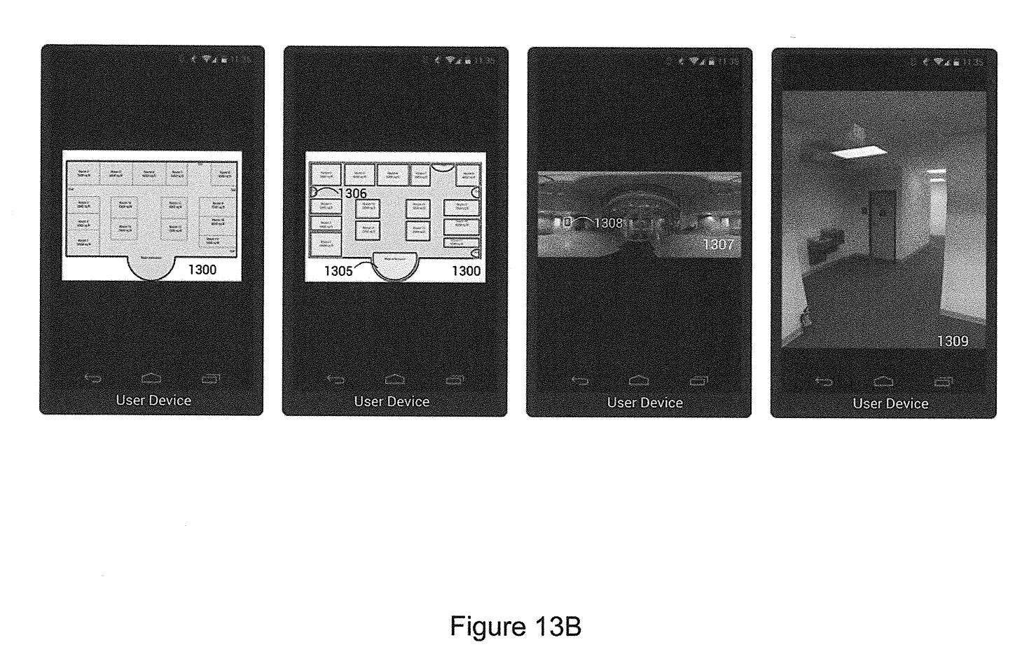

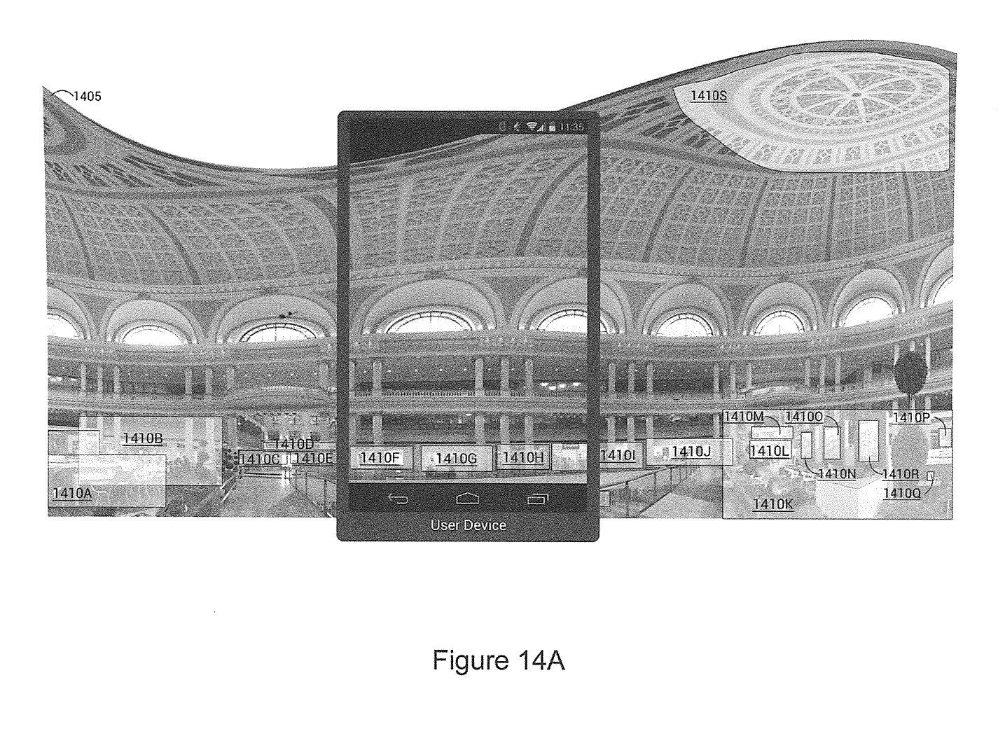

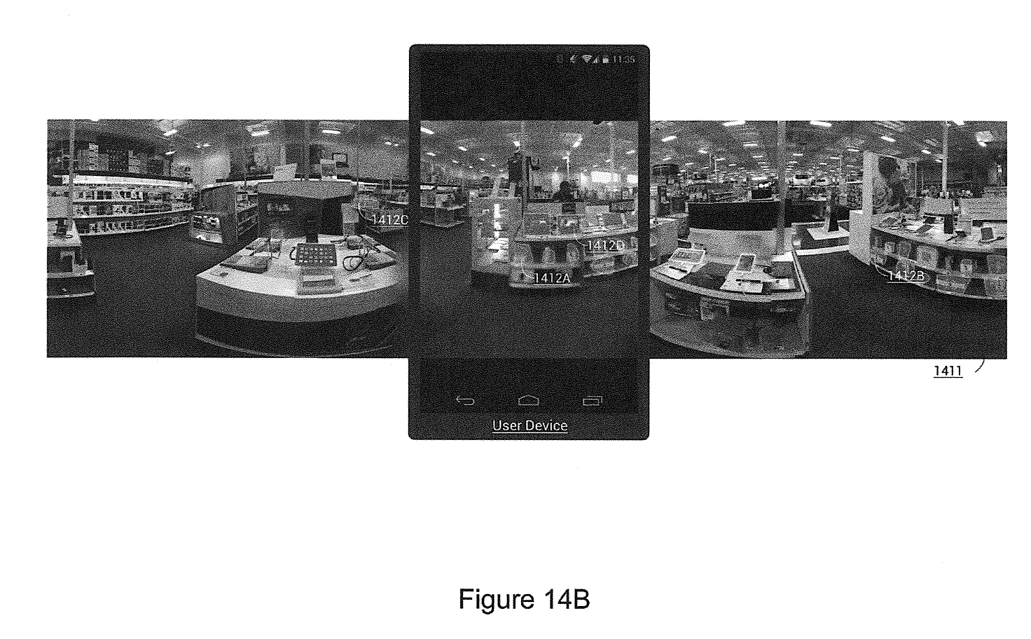

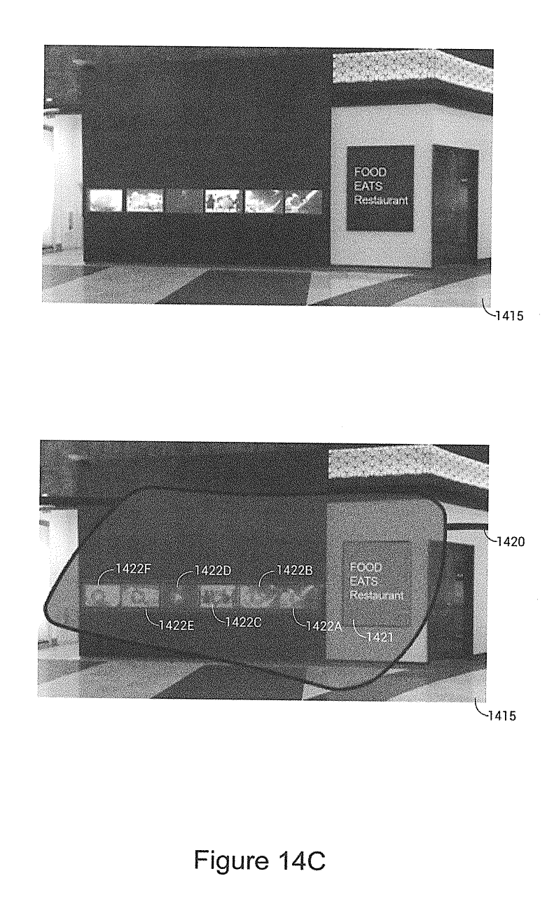

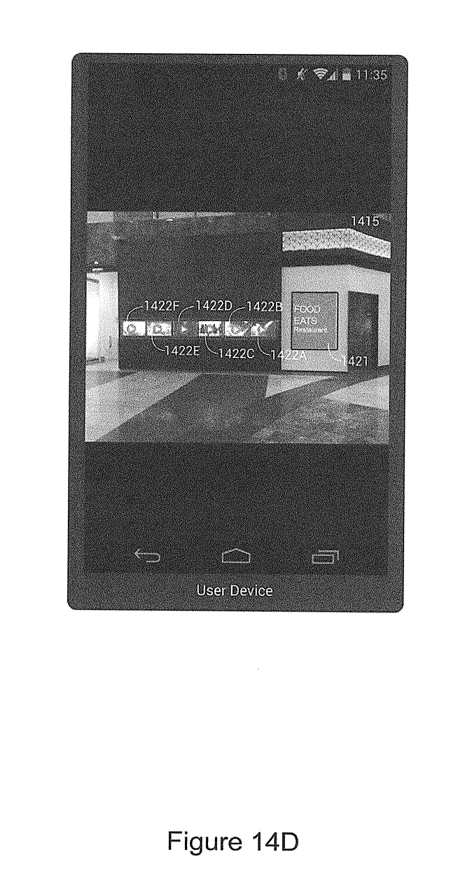

FIG. 13A-FIG. 13B illustrates real-life examples where the said invention is used by users. FIG. 13A illustrates an example of an office building floor plans. A leaser or commercial real-estate would use a floor plan 1300 such as the illustrated in FIG. 13A to show potential clients the layout of the office building. In some embodiment an image could show one or more floors and offices. Aided by our system, FIG. 13B illustrates various ways a user (commercial real-estate and or agent could post tags to showcase the office building for lease). For example each room could have a post with referencing regions as well as other parts of the building such as the entrance to the building 1305 or exits 1306. From a user device viewable from the selected post 1305 of the main entrance where a user can view any digital media 1307 part of the post 1305. The image 1307 viewed from the user device can also be a panoramic or even viewpoint like a sphere where a user is freely able to explore the entire scene all around (example in FIG. 14). Embedded within the image is another post 1308 referencing a region within the image 1307, whereby showing the nameplates that a business name would be displayed. From post 1306 describes image 1309 uploaded whereby the image or images could also include text and other information and data that could further be provide to the system and user. FIG. 13 illustrates an easy to user intuitive way for a business to showcase a product.

FIG. 14A illustrates viewpoint like a sphere where a user is freely able to explore the entire scene all around. A user could view from a device series or array of images that make 360 degree or less viewpoint where a user can look all around up and down whereby the full scope of the image depends on the user who uploaded it. For example a flattened version of a sphere image 1405 could have tags (1410A, 1410B, 1410C, 1410D, 1410E, 1410F, 1410G, 1410H, 1410I, 1410J, 1410K, 1410L, 1410M, 1410N, 1410O, 1410P, 1410Q, 1410R) or post embedded and/or referencing to. By clicking on any of these tags bring up one or more addition information or data that is embedded within tag. Along with any suggestions tags or relating data.

FIG. 14B illustrates a panoramic image 1411 viewable from a user device on mobile or computer. The panoramic image 1411 could have tags (1412A, 1412B, 1412C, 1412D) or post embedded and/or referencing to. By clicking on any of these tags bring up one or more additional information or data that is embedded within tag. Along with any suggestions tags or relating data.

FIG. 14C illustrates a viewpoint 1420 from one eye of a user at a popular location like a mall. Added by a device (user device) 1420 that can augment reality or show a real time video representation of the same or similar viewpoint would show tags or post a user in real life has tagged at a certain location. These tags 1421 showing the name of a restaurant, (1422A, 1422B, 1422C, 1422D, 1422D, 1422E, 1422F) showing the live video feed could be a photo taken and then presented to a user or could be tagged by a user in the virtual or augmented reality. These tags could be 1421, 1422A, 1422B, 14220, 1422D, 1422D, 1422E, 1422F, could be also viewed by other view points and distances and some tags 1422A, 1422B, 1422C, 1422D, 1422D, 1422E, 1422F may be shown differently among various users. For example depending on a user's relationship graph the system can send the best information and most relevant information to one or more users.

FIG. 14D illustrates a viewpoint from displayed on a user device that are commonly used today whereby in some embodiments the image 1415 by a user has one or more tags 1421, 1422A, 1422B, 1422C, 1422D, 1422D, 1422E, 1422F. This image could be the same image shown to the user in FIG. 148.

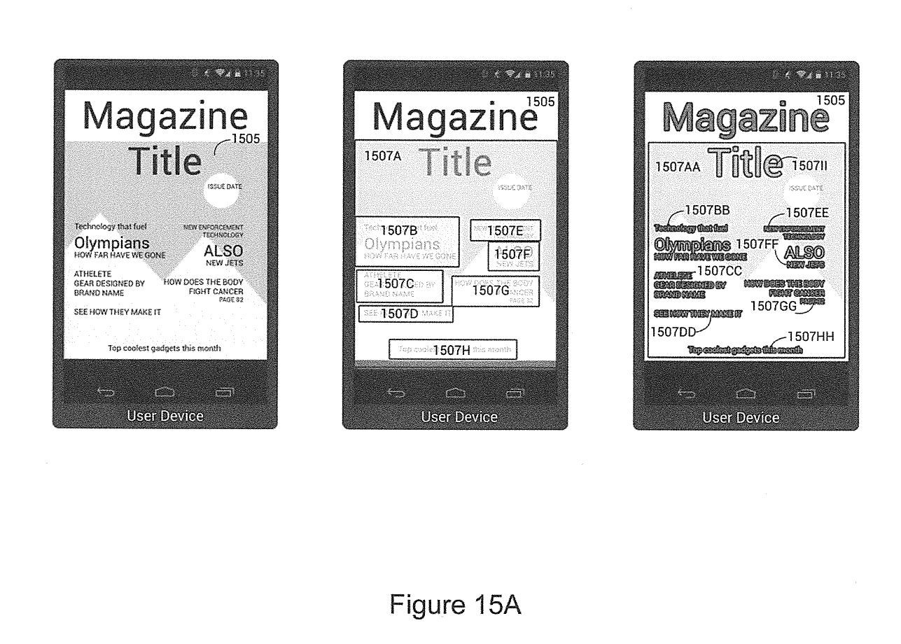

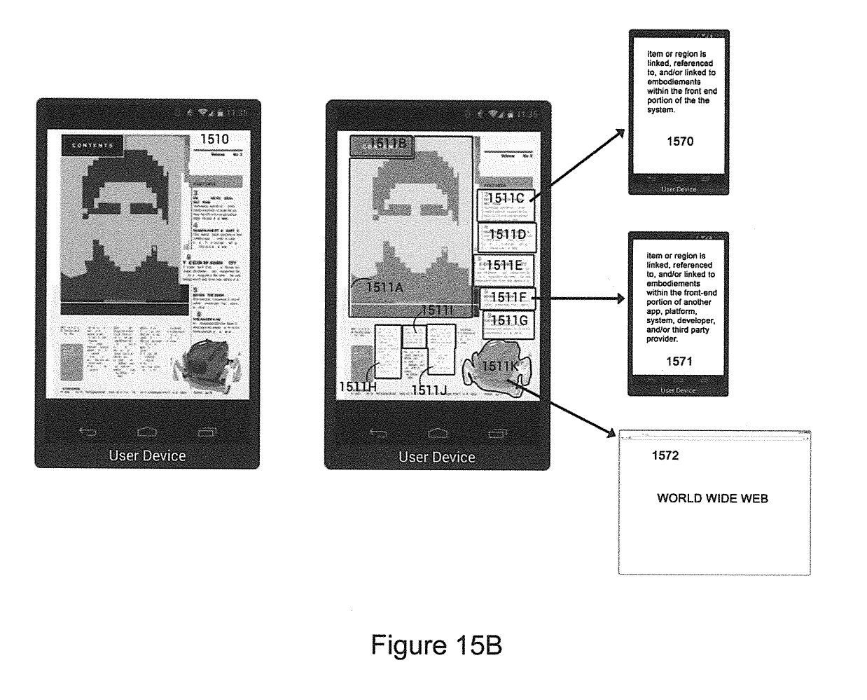

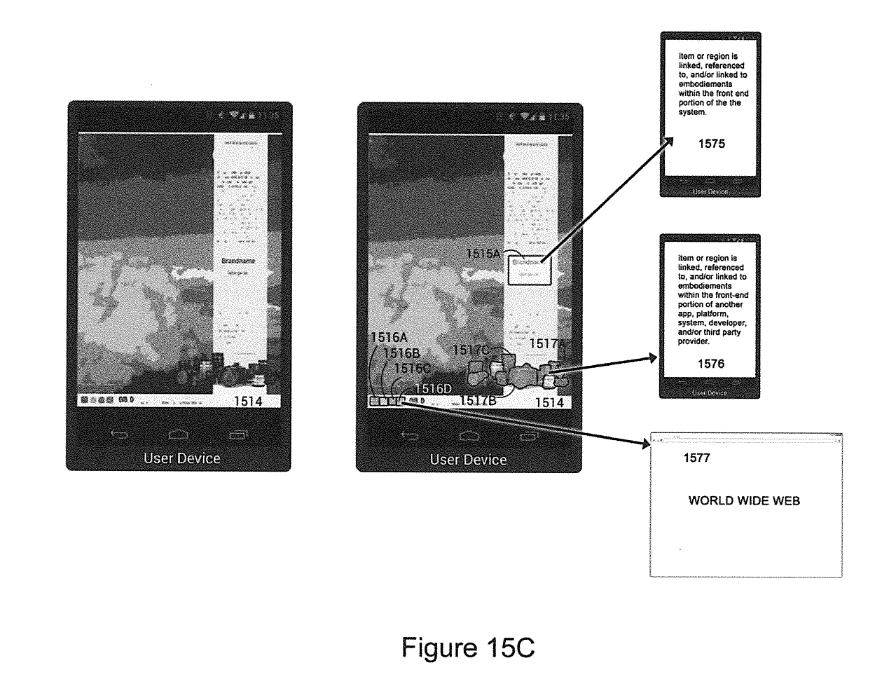

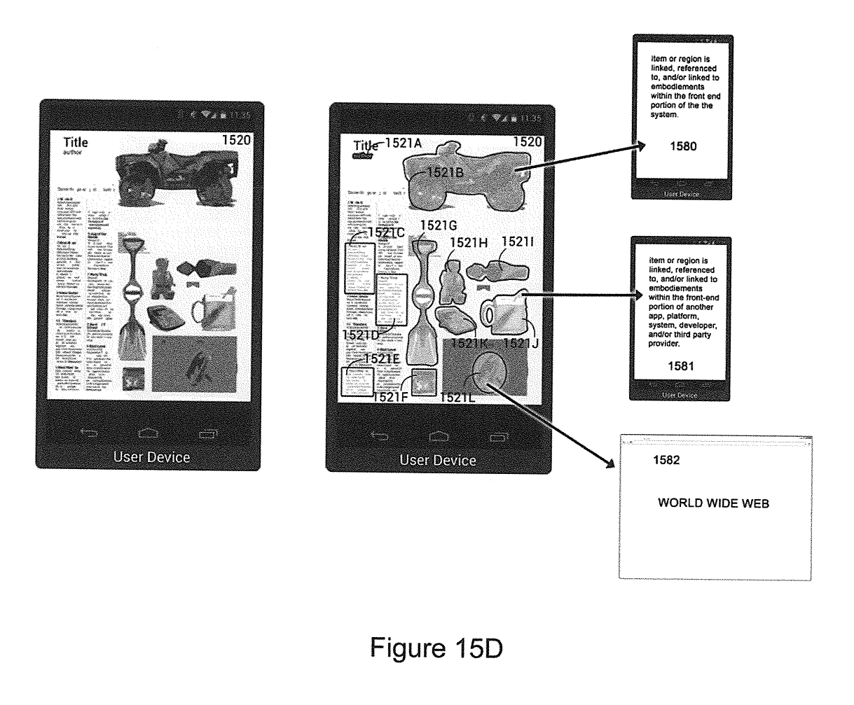

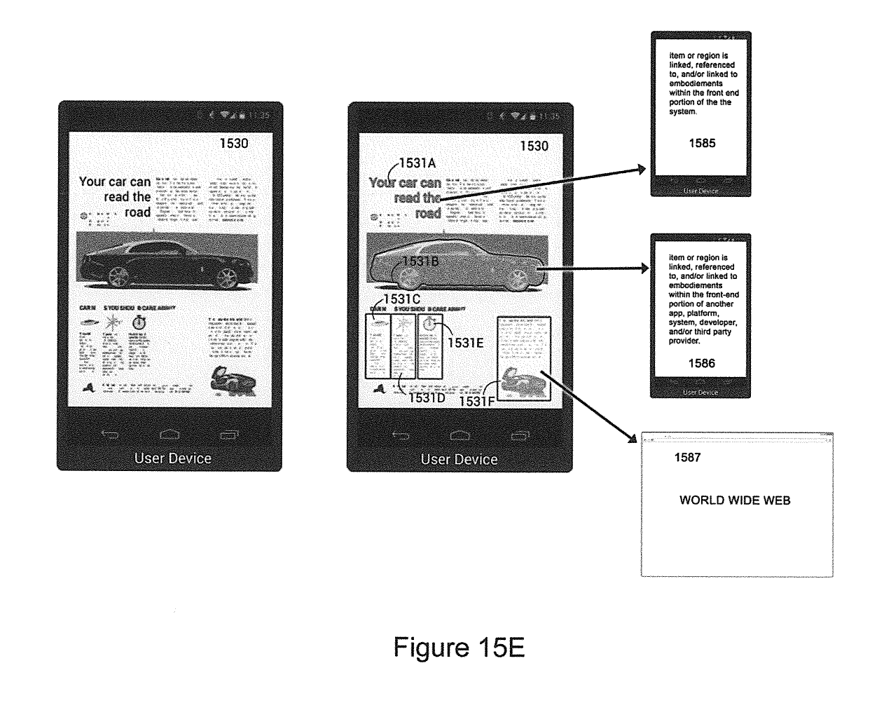

FIG. 15A illustrates from a user device an interactive way for user to view publications or content like magazines, newspapers, brochures and similar. Like most content viewable from a user device has each page, pair of pages, a grid of pages or list of pages. In FIG. 15A show a page view of one page 1505 one page (a cover to a magazine). In some embodiments the tags are not visible so that it does not interfere with the user's experience. Upon activating the visibility of the tags or posts (1507A, 1507B, 1507C, 1507D, 1507E, 1507F, 1507G, 1507H) are shown with polygon or similar shapes. Additionally in other embodiments tags or posts (1507AA, 150788, 1507CC, 1507DD, 1507EE, 1507FF, 1507GG, 1507HH, 150711) that are a one or more outlines or mixture and/or combination of outlines or overlays tags and shaped or polygon tags. For example 1507B is a rectangle with four points and 1507BB is the same tag just outlined by a user or detected automatically by OCR or feature detection where the points are identified and stored as the location referencing the id of the content (along with other vital information and data) which may show page of content referencing other tags and weights and scores. FIG. 15B-FIG. 15E illustrates examples of various pages of a magazine where the publisher of the magazine may or may allow all users to add tags, disabling users to add tags, limit which users can add tags or add tag location for people to retag those areas. FIG. 15B shows an image 1510 or page from publication where multiple tags can be presented to a user 1511A of an image that may bring up the full additional images or a full size version of any image.

Tag 1511B could represent contents or a list view of table of contents that a user can navigate. Tags 1511C, 1511D, 1511E, 1511F, 1511G, 1511H, 1511I, 1511J, 1511K that could in some embodiments reference an article or page later in the content. In fact these pages could build on themselves where a user can upload the whole content and build the tags or have parts of the content posts and build the rest of the content. In additional embodiments items or region that is linked, referenced to, and or linked to embodiments within the frontend portion (also backend) of the system can associate from a region defined 1511C originating from 1510 (1570). Other examples include items or regions that is linked, referenced to, and/or linked to embodiments within the front-end (or backend or any portion within the system) portion of another app, platform system, developer, and/or third party provider from a region defined 1511 F originating from 1510 (1571). Additionally, other embodiment may include from a region defined 1511K originating from 1510 a reference opening up to a browser or other web related and may ultimately linking to a IP address or web address that connects to the world wide web 1572 where the system may also still be linked and collecting data relating to information, content, digital media, backlinks, links, and social web of connections. From the association of the different regions 1511C and 1511 originating from the region defined by text. This association could be highlighted defined within the system as clickable or selectable.

FIG. 15C illustrates an image an advertisement 1514 whereby there could be tags 1517A, 1517B, 1517C, 1517D that link to products or tags 1516A, 1516B, 1516C, 1516D social shares to other popular third-party search or social networks. Other tags may include business name which contains a link or other data like products. In additional embodiments items or region(s) that is linked, referenced to, and or linked to embodiments within the frontend portion (also backend) of the system can associate from a region defined 1515A originating from 1514 (1575). Other examples embodiments items or region that is linked, referenced to, and or linked to embodiments within the frontend portion (also backend) of the system can associate include items or regions that is linked, referenced to, and/or linked to embodiments within the front-end (or backend or any portion within the system) portion of another app, platform system, developer, and/or third party provider from a region defined 1517A originating from 1514 (1576). Additionally, other embodiment may include from a region defined 1511K originating from 1514 a reference opening up to a browser or other web related and may ultimately linking to a IP address or web address that connects to the world wide web 1577 where the system may also still be linked and collecting data relating to information, content, digital media, backlinks, links, and social web of connections. Additionally any associations may connect with and represent a product, store, store front, ecommerce site, advertisement, magazine, developer, third-party association, third-party partners, third-party system, subscription or any tiered service(s) offered by the system. Other embodiments may include additional applications from the system.

FIG. 15D illustrates a page from a Publication showing the top coolest gadgets this month from the cover (FIG. 15A) where the publisher has created content, but with the said invention and tags within the page a user can interactively search more into their interests instead of going to a search engine and having a hard time finding quick information. From the tags 1521A is a tag of the author, this tag post could show the authors other publications, tags, user profile and similar authors, while also not limiting to information and suggestions as well as promotions. The tags 1521B, 1521C, 1521D, 1521E, 1521F, 1521G, 1521H, 1521I, 1521J, 1521K, 1521L are tags created whereby clicking on any of these tags could bring up a number of various met-tags, tags, data, metadata, links, images, ability to buy product, user that posted tag, original publisher, more tags, similar information, suggestions, and other useful information or not limiting information and data. Much like descriptions in this disclosure. In additional embodiments items or region that is linked, referenced to, and or linked to embodiments within the frontend portion (also backend) of the system can associate from a region defined 1521A originating from 1520 (1580). Other examples include items or regions that is linked, referenced to, and/or linked to embodiments within the front-end (or backend or any portion within the system) portion of another app, platform system, developer, and/or third party provider from a region defined 1521J originating from 1520 (1581). Additionally, other embodiment may include from a region defined 1521L originating from 1520 a reference opening up to a browser or other web related and may ultimately linking to a IP address or web address that connects to the world wide web 1582 where the system may also still be linked and collecting data relating to information, content, digital media, backlinks, links, and social web of connections. Additionally any associations may connect with and represent a product, store, store front, ecommerce site, advertisement, magazine, developer, third-party association, third-party partners, third-party system, subscription or any tiered service(s) offered by the system. Other embodiments may include additional applications from the system.

FIG. 15E illustrates examples of page 1530 from a publisher that may contain one or more tags from one or more users whereby one of the users may be the original poster or publisher. For example tag 1531A can have more information about the article, tag 1531B represents a car where a user may be prompted with an application or other data relating to that car, and tags like 1531C, 1531D, 1531E, 1531F the show information respectively to what tagged. In additional embodiments items or region that is linked, referenced to, and or linked to embodiments within the frontend portion (also backend) of the system can associate from a region defined 1531A originating from 1530 (1585). Other examples include items or regions that is linked, referenced to, and/or linked to embodiments within the front-end (or backend or any portion within the system) portion of another app, platform system, developer, and/or third party provider from a region defined 1531B originating from 1530 (1586). Additionally, other embodiment may include from a region defined 1531F originating from 1530 a reference opening up to a browser or other web related, may ultimately link to a IP address or web address that connects to the world wide web 1587 where the system may also still be linked and collecting data relating to information, content, digital media, backlinks, links, and social web of connections. Additionally any associations may connect with and represent a product, store, store front, ecommerce site, advertisement, magazine, developer, third-party association, third-party partners, third-party system, subscription or any tiered service(s) offered by the system. Other embodiments may include additional applications from the system. The embodiments in FIG. 15E include an example of an magazine or publication page 1530 that identifies a clickable region 1531B that associates with an automobile. When a user clicks or selects with methods included in the said disclosure could bring up various situations on a case by case basis. One example may include a list of possible choices of platforms, other third-party apps, items within the system and other embodiments defined by the system. Defined by the system the user could be also presented with in app purchases, advertisement, promotions, or even another applications managed by the same system that the user has already downloaded to optimize functionalities and capabilities of the app. To also include any association viewed from a third-party platform using an API using embodiments from the system. Additionally other embodiments may include viewing from a webpage or other user devices.

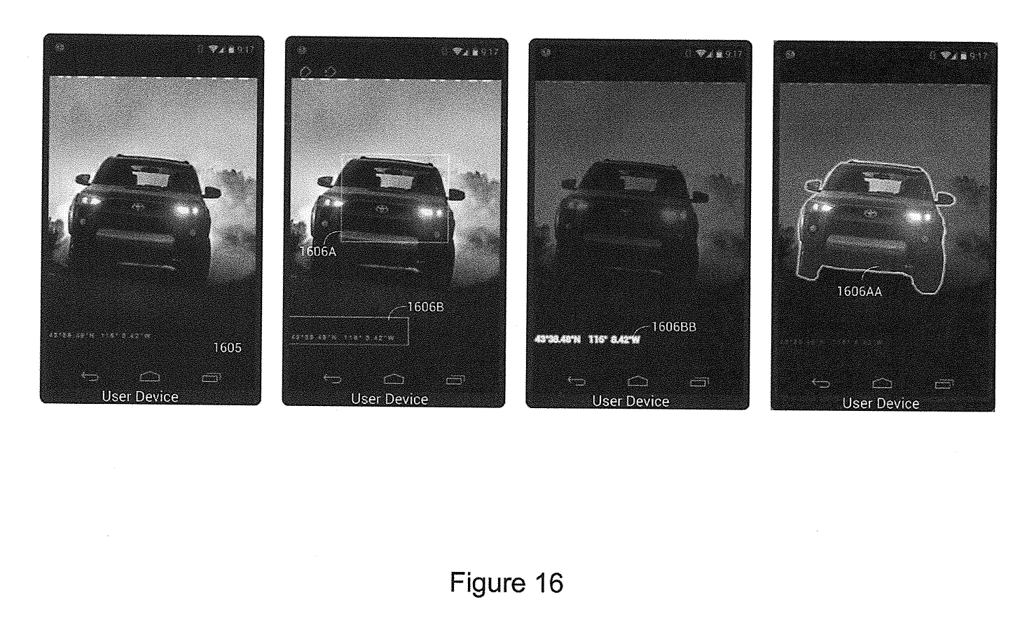

FIG. 16 shows a user device with several versions of the same image 1605 but the user interface may advance and be more user friendly. For example, the region defined by 1606A and 1606AA are different when inferring about the user interface but there is no difference on how the tags is representing relating information and date, the user is still selecting a tag where in FIG. 16 are tags(or posts) within images. In other words embedding posts that may contain data and information where some changes are made in the logic and what is actually stored in the database but what the tag (post) represents does not. For example in the database tag region 1606A has four (4) points to define the polygon rectangle, whereas tag 1606AA has many points illustrated in FIG. 8. Both of these may contain other value like screen ratio or starting point. Tags 1606B and 1606BB the same representation of a tag or something identified by the system to show coordinates.

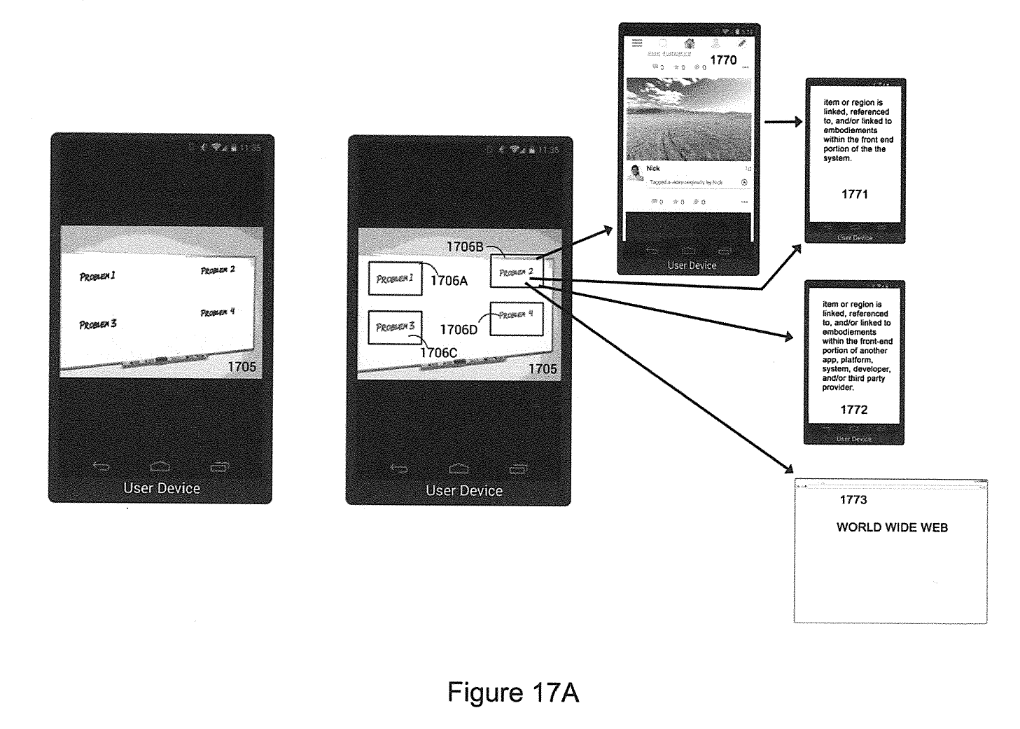

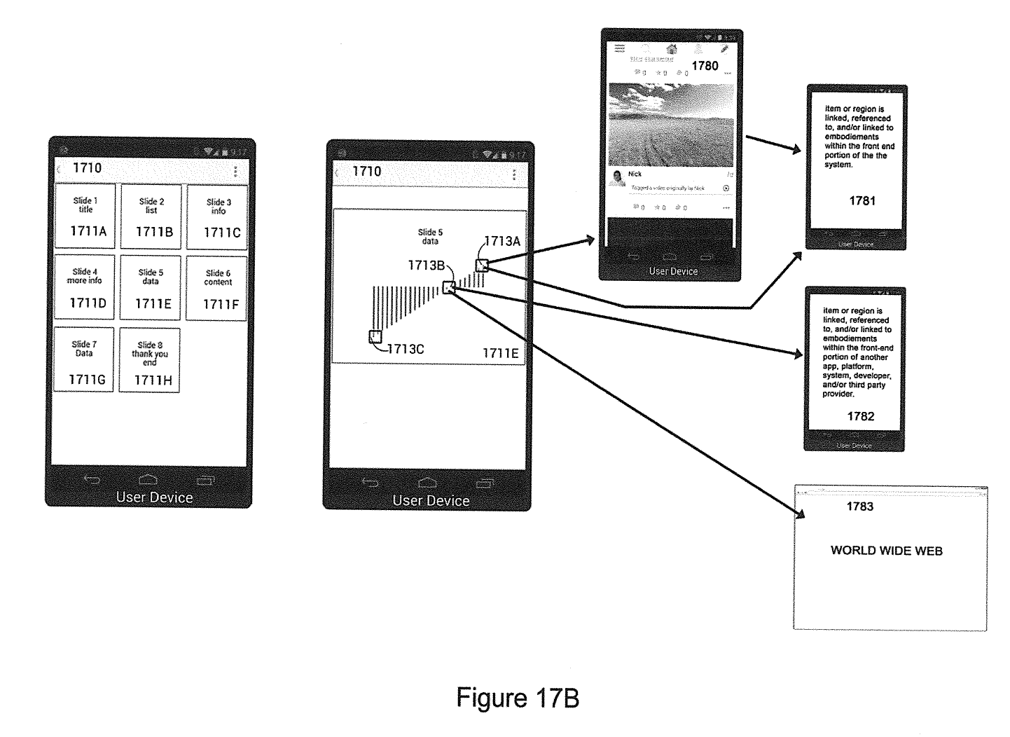

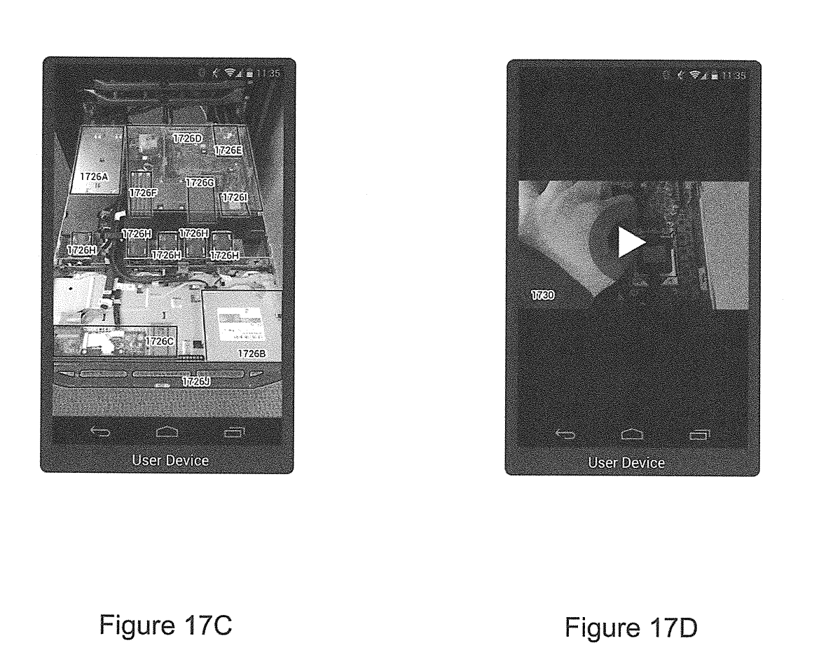

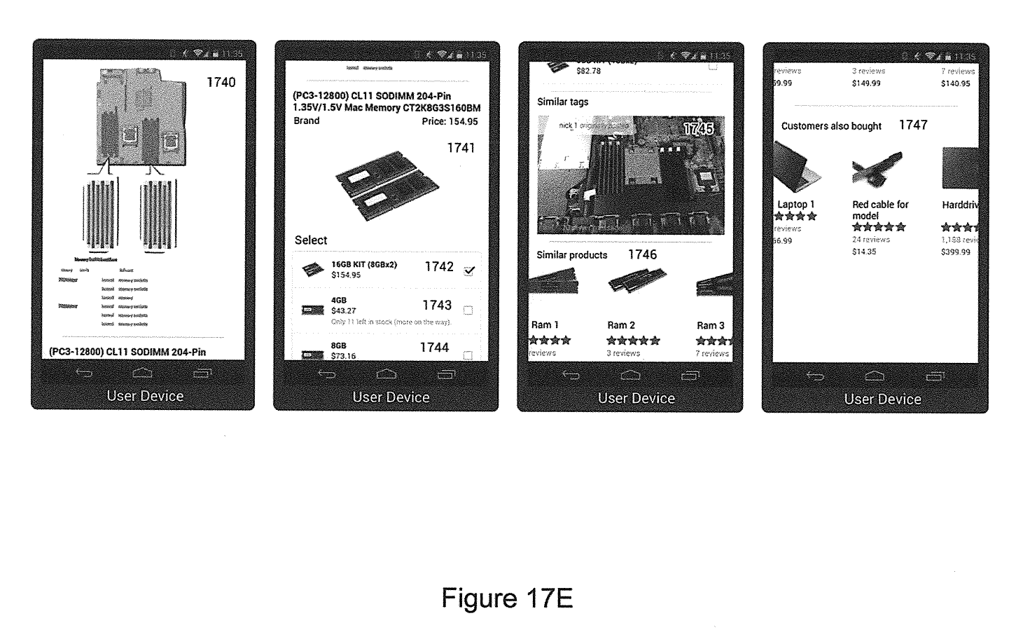

FIG. 17A illustrates a school setting 1705 where students can view problems from a user device (which includes mobile and PCs) from inside the class room or remotely. Digital media 1705 could be a video or image or a screenshot of a video or computer screen. Where each problem has a solution 1706A, 1706B, 1706C, 1706D where each student can view the solution or hints for each problem or students can ask questions or upload solutions to the problems. In additional embodiments items or region that is linked, referenced to, and or linked to embodiments within the frontend portion (also backend) of the system can associate from a region defined 17068 originating from 1705 to (1770 and/or 1771). Included in the illustration is a user selecting the region of 1706B whereby the user is given a list of tags (post) 1770 associated with the said region, where the user can select from a list to a items or region that is linked, referenced to, and or linked to embodiments within the frontend portion (also backend) of the system can associate 1771. Additionally from the said list of tags (post) 1770 the user can click on an item (by methods described in this disclosure) linked, referenced to, and or linked to embodiments within the frontend portion (also backend) of the system 1771, linked, referenced to, and/or linked to embodiments within the front-end (or backend or any portion within the system) portion of another app, platform system, developer, and/or third party provider 1772, a browser or other web related and may ultimately linking to a IP address or web address that connects to the world wide web 1773. Other examples include items or regions that is linked, referenced to, and/or linked to embodiments within the front-end (or backend or any portion within the system) portion of another app, platform system, developer, and/or third party provider from a region defined 1706B originating from 1705 (1772). Additionally, other embodiment may include from a region defined 1706B originating from 1705 a reference opening up to a browser or other web related and may ultimately linking to a IP address or web address that connects to the world wide web 1773 where the system may also still be linked and collecting data relating to information, content, digital media, backlinks, links, and social web of connections. Additionally any associations may connect with and represent a product, store, store front, ecommerce site, advertisement, magazine, developer, third-party association, third-party partners, third-party system, subscription or any tiered service(s) offered by the system. Other embodiments may include additional applications from the system. Also not shown is a user presented with choices (depending on the information given to the user and what is actually stored, referenced to, linked to the system. Some choices may include choosing between choices that are linked to associations, regions, embedded, or items associated within the system.

FIG. 17B illustrates a situation of a slide show or presentation, more specifically aided by the user interface 1710 shows a grid of slides 1711A, 1711B, 1711C, 1711D, 1711E, 1711F, 1711G, 1711H which could be viewed from the presentation. When a user enlarged slide 5 1711E containing data like a chart. Various types of tags may be displayed, for example embedded tags 1713A, 1713B, 1713C could represent additional information that people could look at or could be part of the presentation, these tags 1713A, 1713B, 1713C could also represent other slides, links to information, or not limited to references or sources. Furthermore these tags could be view by the user presenting as question that other users may have relating to slide 5 1711E with data. Included in the illustration is a user selecting the region of 1713A whereby the user is given a list of tags (post) 1780 associated with the said region, where the user can select from a list to a items or region that is linked, referenced to, and or linked to embodiments within the frontend portion (also backend) of the system can associate 1781. Additionally from the said list of tags (post) 1780 the user can click on an item (by methods described in this disclosure) linked, referenced to, and or linked to embodiments within the frontend portion (also backend) of the system 1781, linked, referenced to, and/or linked to embodiments within the front-end (or backend or any portion within the system) portion of another app, platform system, developer, and/or third party provider 1782, a browser or other web related and may ultimately linking to a IP address or web address that connects to the world wide web 1783. Other examples include items or regions that is linked, referenced to, and/or linked to embodiments within the front-end (or backend or any portion within the system) portion of another app, platform system, developer, and/or third party provider from a region defined 1713B originating from 1711E (1782). Additionally, other embodiment may include from a region defined 1713B originating from 1711E a reference opening up to a browser or other web related and may ultimately linking to a IP address or web address that connects to the world wide web 1783 where the system may also still be linked and collecting data relating to information, content, digital media, backlinks, links, and social web of connections. Additionally any associations may connect with and represent a product, store, store front, ecommerce site, advertisement, magazine, developer, third-party association, third-party partners, third-party system, subscription or any tiered service(s) offered by the system. Other embodiments may include additional applications from the system. Also not shown is a user presented with choices (depending on the information given to the user and what is actually stored, referenced to, linked to the system. Some choices may include choosing between choices that are linked to associations, regions, embedded, or items associated within the system. Further defining the embodiments in FIG. 17B web or in person presentation that may include restrictions or additional information available.

FIG. 17C-FIG. 17E could illustrate various examples aided by the system disclosed. FIG. 17C could represent a manual, product specs, classified products, how to or repair guide. Additional each tag 1726A, 1726B, 1726C, 1726D, 1726E, 1726F, 1726G, 1726H, 1726I are components of the computer or server. For example tag 1726H are fans, Front bezel Covers the system's front-loading hard drives and locks for security, Hard drives Up to eight 2.5-inch drives—Hot-plug hard drive options: 2.5″ SATA, nearline SAS, SAS (15K, 10K), SAS SSD, SATA SSD, 3.5″ SATA, nearline SAS, SAS (15K), Cabled hard drive options: 3.5″ SATA, nearline SAS, SAS (15K)-Self-encrypting drives available, Tag 1726F/1726G relates to memory Up to 384GB (12 DIMM slots): 16GBDDR3 up to 1600MT/s, Tag 17261 relates to the Processors, tag 1726A relates power supplies Platinum efficiency 550W and 350W (for one processor only) power supplies Silver efficiency cabled 550W power supply, auto-ranging power supplies and tag 1726E relates to the dual-port 1Gb LOM. FIG. 17D show a how video to replace or add a processor to the computer/server from tag 17261 in FIG. 17C. FIG. 17E illustrates a tag that contains information like specs, information or schematics of the ram 1740 as well as links to possible purchase 1741, versions, variations, 1742, 1743, 1744 or ecommerce sites 1741, as well as suggestions, similar products 1746, other customer purchases 1747 and similar tags 1745 from tags 1726G and 1726G in FIG. 17C. A user will be able to save or place an item in a cart or wish list as a result from viewing a tag. Tags could be group together and/or organized in various ways that depending on the system, application, and/or users.

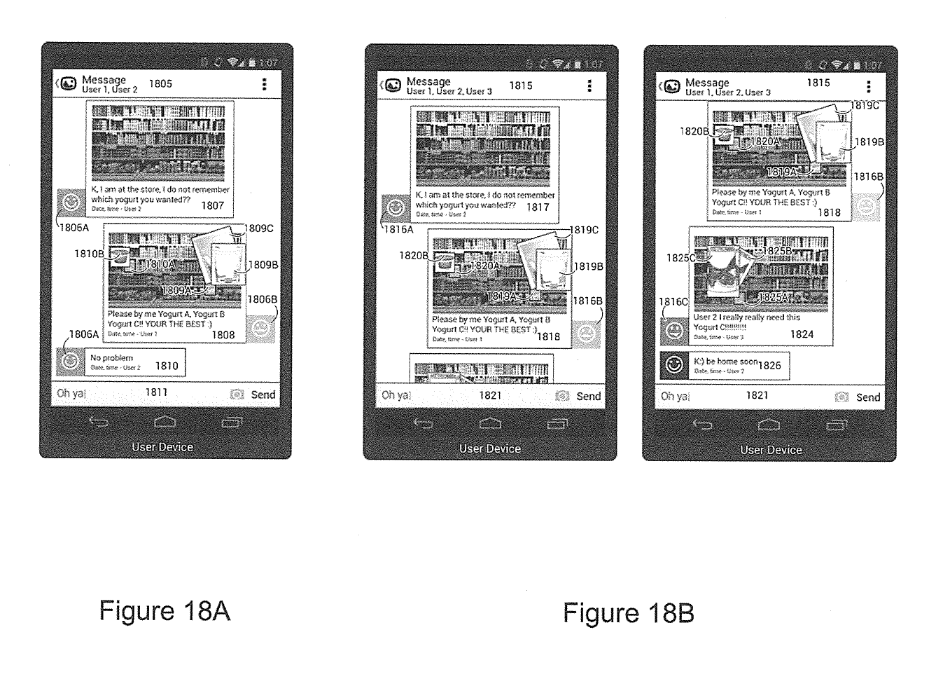

FIG. 18A illustrates an example of the system being used between users for messaging. From a user device whereby displaying the message feed 1805 FIG. 18A illustrates two users, 1806A (user₂) and 1806B (user₁) whereby in some embodiments each user has a name and profile image. Between two users, user₂ 1806A upload a photo and text contained in message 1807. From that message 1807 user₁ response with message 1808 which may contain tags in the same message that are added together or Iater(and may in some embodiments limit the tagging multiple things in one message 1808 by but not limiting to if user₂ has responded or by a allocated time). For example tag 1810A contains image, text or tag 1810B and tag 1809A contains more than one or a combination of digital media 1809B, 1809C (images, video, audio) and text. User₂ 1806A responds with a final confirmation message 1810. Where user₁ 1806B can communicate with bar 1811 with text, sending and attachments button

FIG. 18B illustrates an example of the system being used between users for messaging. From a user device whereby displaying the message feed 1805 FIG. 18A illustrates three users, 1816A (user₂), 18168 (user₁), and 1816C (user₃) whereby in some embodiments each user has a name and profile image. Between two users user₂ 1816A upload a photo and text contained in message 1817. From that message 1817 user1 1816B response with message 1818 which may contain tags in the same message that are added together or later (and may in some embodiments limit the tagging multiple things in one message 1818 by but not limiting to if user₂ 1816A has responded or by a allocated time). For example tag 1820A contains image, text or tag 18208 and tag 1819A contains more than one or a combination of digital media 1819B, 1819C (images, video, audio) and text. User₃ 1816C also responds with a message 1824 containing one tag 1825A with one or more or a combination of digital media 1825B, 1825C (images, video, audio) and text. User₂ 1816A responds with a final confirmation message 1826. Where user₁ 1816B can communicate with bar 1821 with text, sending and attachments button.

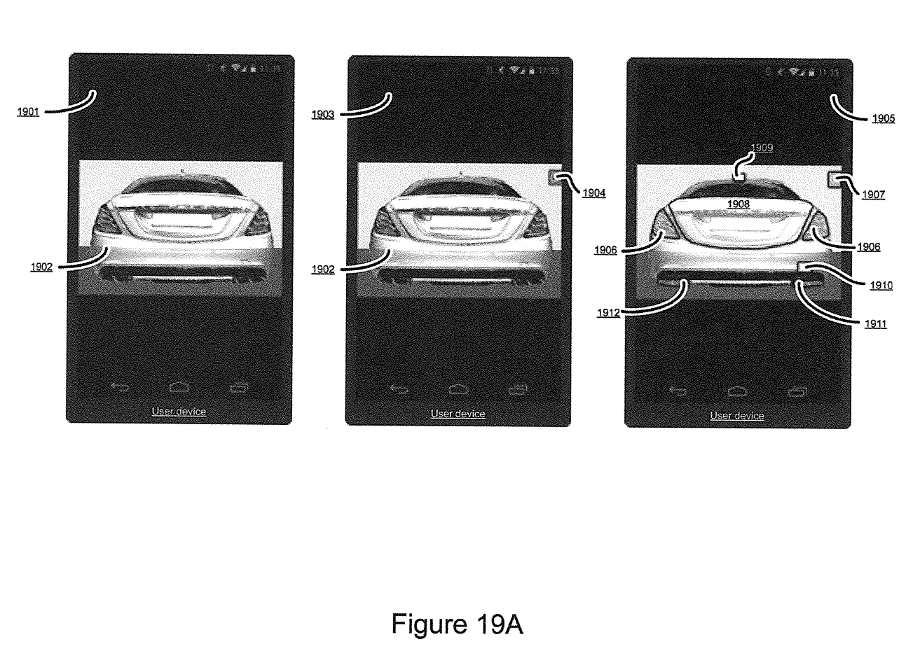

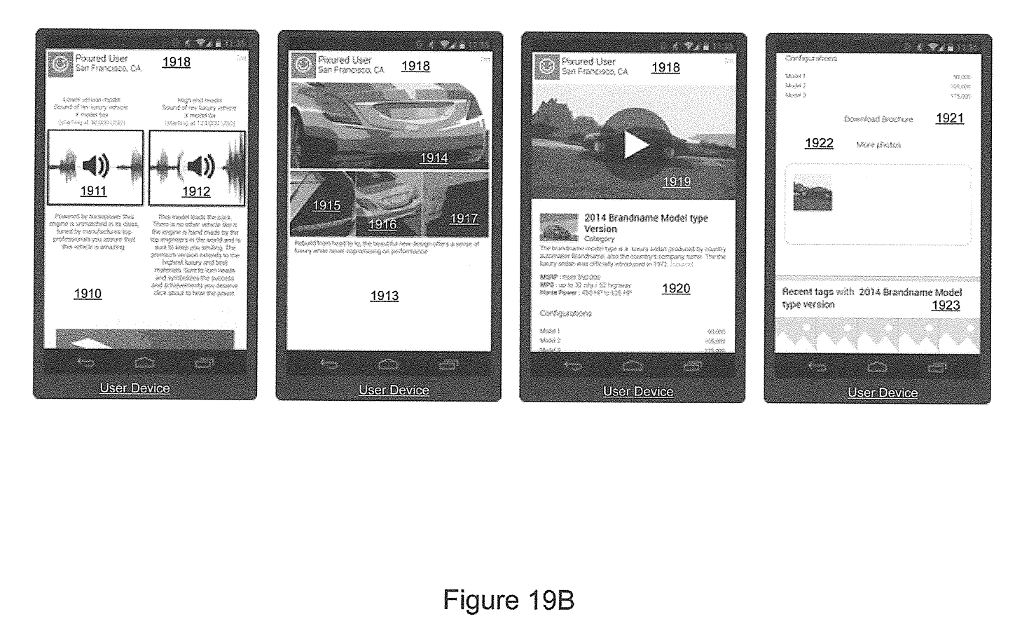

FIG. 19A illustrates an example of the system and user interface from a user device, where one or more images can be shown to a user that contain information not immediately shown to the user. In some embodiments a user may be presented with one or more digital media viewable from a user device. Viewable from a user device, displayed 1901 and image of a back of a car 1902 with no other post or regions visible to the user. The shown digital media of a car could be a digital brochure or catalogue or a listing from a car dealer. In other embodiments viewable from a user device, displayed 1903 and image of a back of a car 1902 with no other post or regions visible to the user but an information button 1904 that could be added later or before by a user. Other embodiments show may also show user information, search information, date uploaded, rating, location, title, text, comments, favorites and text. Another example viewable from a user device, displayed 1905 and image of a back of a car with other post, tags or regions visible (1906, 1907,1908, 1909, 1910, 1911, 1912) to the user but an information button 1907 that could be added later or before by a user. Other embodiments show may also show user information, search information, date uploaded, rating, location, title, text, comments, favorites and text. Further defining the embodiments regions that contain posts, tags, objects, data information and/or links may represent the digital media, posts or content, for example region 1906 associates with the tail lights of the vehicle, region 1908 associates with the trunk of the vehicle, region 1909 associates with the tail lights of the vehicle, region 1910 associates with a defined feature of the vehicle, regions 1911 and 1912 associates with the exhaust and/or performance of the vehicle.

FIG. 19B further illustrates FIG. 19A where by selecting regions a popup dialogue windows appears or another user interface activity. Further illustrated a user's posting user information 1918 may be included at the top of the user device, where one or more regions like regions 1911 and 1912 associates with the exhaust and/or performance of the vehicle may have one or more additional posts like various models. For example, the exhaust audio clip of 2 versions of the vehicle, the lower performance 1911 model and the more expensive 1912 model. Other examples may include additional digital media like images 1914, 1915, 1916, 1917 and further descriptions 1913 and or options. The layout for each region may be similar to current printed brochures or catalogue provided by the manufacture. Additional embodiments may also include video of the vehicle 1919 and general information of the vehicle 1920 like MSRP, Miles per Gallon, horse power, links, ability to download or share the brochure 1921 or listing, more photos 1922, more tags 1923 identified within the system that may or may not show an association of the originating post. Regions identified in some embodiments will show information provided by users and various information and data that the system find, relates and associates with the post. For example if a person is looking at a model of a car the system can recognize additional information as well as relating information, advertising, similar associations, and various posts. Presented information may also me relating to one or more third-party providers, third-party platforms, developers, local listings, ecommerce, API, or any system aiding or connected to the system of the disclosed invention.

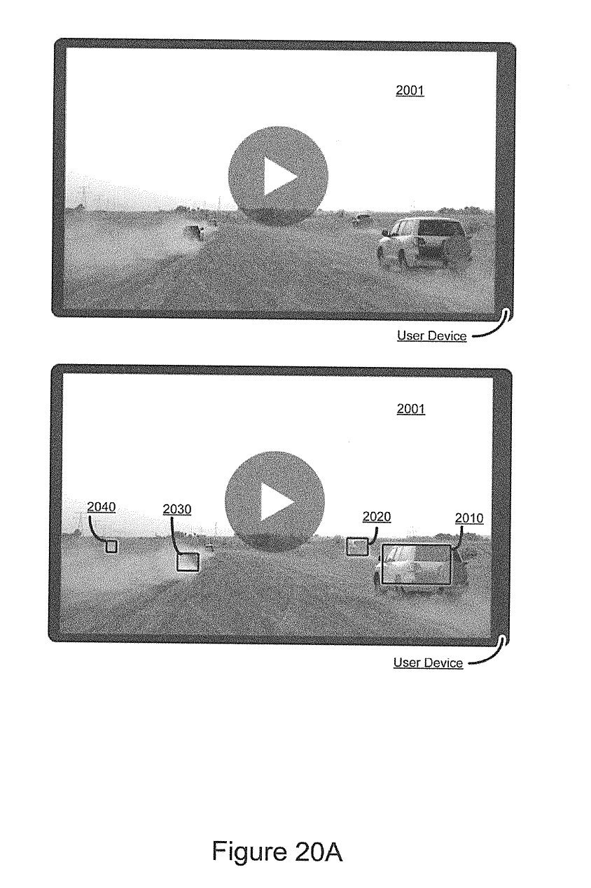

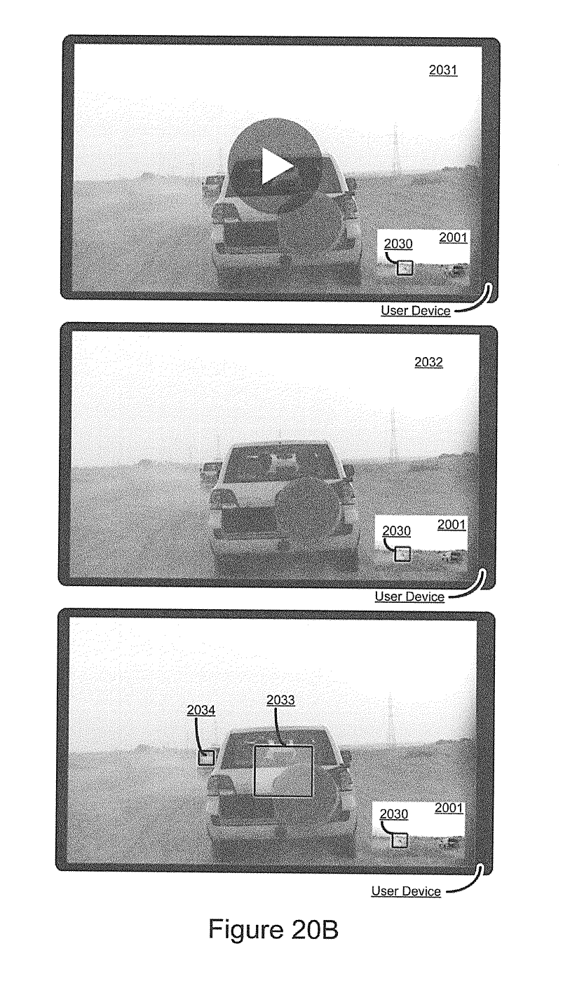

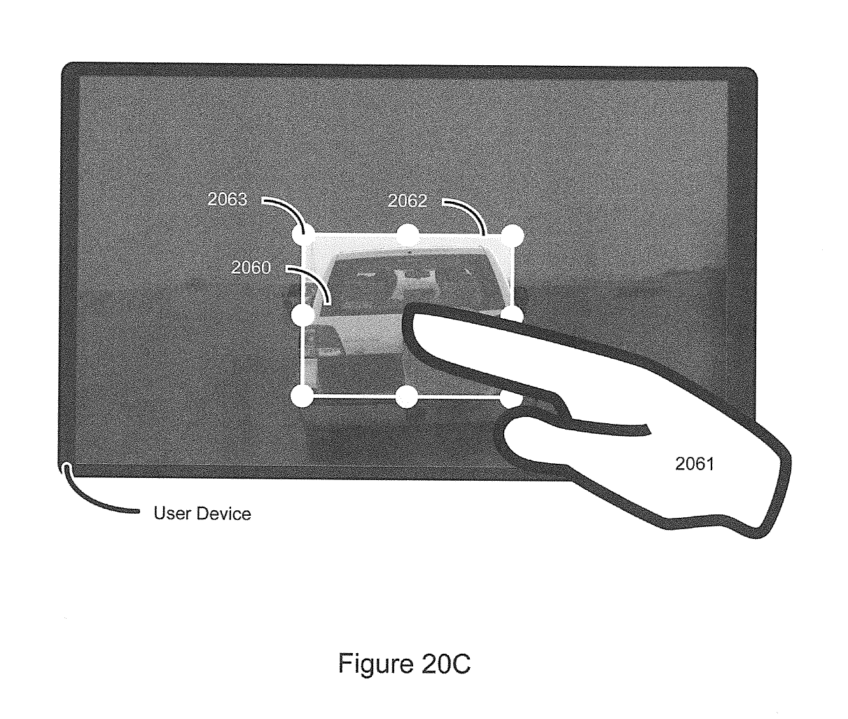

FIG. 20A illustrates how a user in embodiments may view one or more posts within digital media like video, motion pictures, and clips. For example from a user device video 2001 shows an embodiment of a desert safari, posted within the system or embedded from a third-party provider. Embodiments allow for regions that contain one or more posts and data. For example from the user device video clip 2001 with one or more regions tags, associated and/or identified 2010, 2020, 2030, 2040. The system can perform defining/identifying regions automatically or by user, (by users as show in FIG. 20C) which by defining the location within the video and another variable like frame rate or frame number to define the region for various parts of the video or clip.

FIG. 20B illustrates how a user in embodiments may view a posts within digital media like video, motion pictures, and clips from another video. For example from a user device video 2001 shows an embodiment of a desert safari, posted within the system or embedded from a third-party provider. In some embodiments by selecting region 2030, the original video 2001 is reduced in size and brought to the lower right corner and the new video 2031 from region 2030. Defined regions can be shown or displayed as any shape, color etc. Examples of shapes would include polygons, circles, squares rectangles, a mixture or combination of and or 3d objects. Additional examples of colors would include red, blue, yellow, purple, etc and any combination of colors for each shape or same color. Additionally a user can play and/or reverse play where each corresponding tags are shown. Embodiments may also allow for other forms of digital media to be embedded into video like photos 2032 and links that may include embedding other videos. Embodiments allow for regions that contain one or more posts and data. For example from the user device video clip 2031 may have one or more regions, tags, associated and/or identified 2033 and 2034. The system can perform defining/identifying regions automatically or by users.

FIG. 20C illustrates how a user in some embodiments can define a region within a video, for example a user using a simple gesture like placing a finger 2061 on the user device that is touch sensitive, can identify and follow an object as the video plays, from this user created input the system can recognize the point and or points and frames of video (start and end) including any positions defined on the user device. Defining the region is not limited to gesture and may also work the same way with a mouse, clicker, eye tracking, and/or stylus. Using multiple fingers may increase and decrease size of the region and/or zoom. Other user implemented features may also include if a user takes their finger off the screen the play of the video stops or just the defined region or both or a dialogue window may ask if the user is done or something else. The region within the region identified by the user is illustrated 2060 bound by 2062 and may also be defined by points 2063.

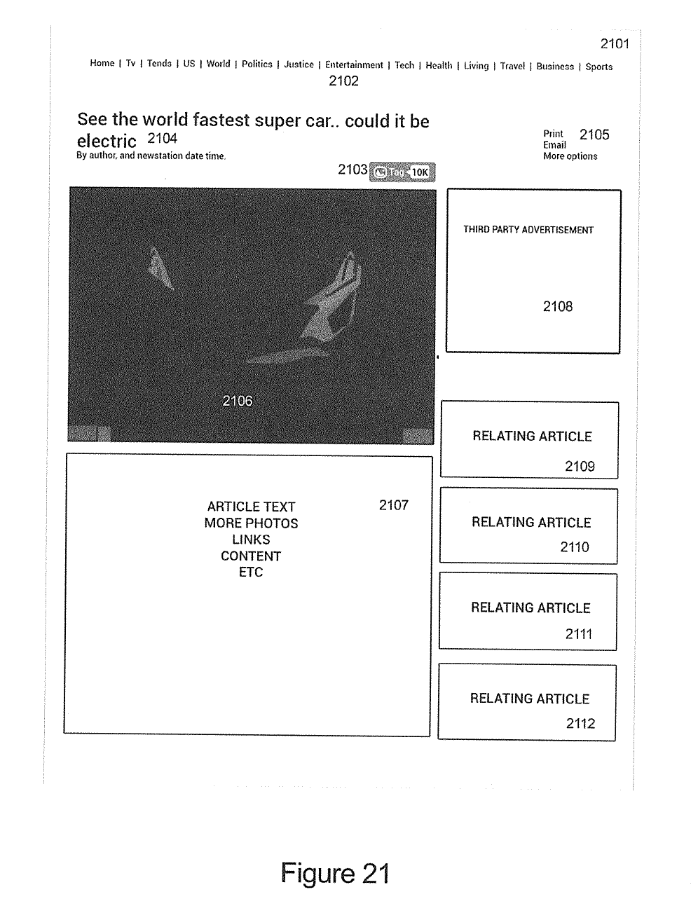

FIG. 21 illustrates how a web site can user meta tags or meta elements in HTML or similar to provide structure about a web page and for one or users to embedded content from the web in posts surrounding a link. The system may also provide methods for user to tag the whole link or parts, further defining the example any post of the web url would be defined as adding to text, documents, digital media, etc. For Example, a new article on automobiles was on a web page a user can post their photos at the event or of the vehicles or added attributes. Additionally user will be able to restrict posting abilities. In some embodiments, aided by an API or other platforms, a user can tag the selected article with the button tag 2103 where information like the title 2104 and other embodiments of the article will show 2107, including in some examples relating articles. In some embodiments tags may be contributed (created or uploaded) to the disclosed invention and/or system by an API. Examples of creating tags from an API would include using metatags the would define values within the system, where values could include title, image (or images or set of images {i.e. image0 , image1, image2, image3} and are usually urls), src (sometimes not required depends on what the user wants to add to the system, for example a product would have a url for the image, or an app may have a url to download), video (or link), web domain, username, contact, creator, main profile, title, description, image description (image0: description, image1: description), image source (i.e.: image0: scr, image1: scr, image2: scr), image creator (i.e. image0: creator, image1: creator, image2: creator), digital media width (i.e.: image: width, video: width), digital media height (i.e. image: height, video: height). Other examples may include metatags having ID for their corresponding location, for example an application in various marketplaces like ITunes, googleplay, or by type of device (phone, tablet). Other examples may include a region or country (app:country, country or country:trg). Additionally embodiments, for creating tags through an API using metatags could also include fields (for input) for price, locations, data(data0, data1, data2, data3), labels (label0, label1, label2, label3), stream url (url to a raw file format of video or audio—stream), stream type, stream image, or embedding url. Other API with third party platforms may include other ways to create tags and other enabling abilities within the scope of this invention.

The disclosed invention, while providing a detailed description of the inventions when referencing buttons, buttons with features, implementers, actions, features, implement/features, categories, and sub categories could fall under the same understanding and could be cross compatible with the ways to present with windows, buttons, buttons within buttons, buttons within windows that may be selected to simplify and streamline how information is presented to user(s). Variations of button and/or features could be referred to as multimedia buttons, page slides or widgets where all or most variations are to be executed by an end user. Additionally features and expanding of features from categories to sub-categories could be related on how information is related and presented to the user. In most of the said invention, digital media could come from one or more search results, users, social networks, or databases. Additionally a user or someone who uses or interacts with the said invention could be identified or referred to as a requestor.

Features with buttons may sometimes show with different symbols that may resemble a phone, envelope, heart, star, magnifying glass, tag, user, food, fork, knife, building, city, home, etc. are not intended to limit the scope of the invention. Where symbols and meaning can be changed, or not exist where the equivalent function will still remain. A user may search for keywords along with the digital media, where the photo and keywords are complements to one another and provides additional context to users search query. While also providing additional information and explanation of certain features and action does not limit the ability of various implement/features, features and expanding of features, buttons, etc.⁻from performing or for methods further explained for one button does not limit the function or ability of another button. Buttons and features with buttons vary depending on situations and/or associations. Figures are meant to show examples of various embodiments, while also flow chart illustrations, screenshots, block diagrams, diagrams while also include coupled, links, and paths may include additional or fewer actions and procedures.

What is claimed is:

1. A computer implemented method of managing posts for interacting with web based digital media items, comprising:
providing a user application for creating posts that refer to web based digital media items and/or to previously created posts;
providing a database system for storing user created posts; and
creating and managing programmed links between user created posts and web based digital media items, wherein users interacting with the user application can access posts that refer to and/or are embedded within another post.

2. The computer implemented method of claim 1, wherein the database system stores a plurality of data items each having associated digital data relating to one or more of user basic information, user favorites, user profile, user relationship, user interest, user preferences, or user social connection.

3. The computer implemented method of claim 1, wherein the digital media items comprise digital images, digital albums or digital video.

4. The computer implemented method of claim 2, wherein the digital data relates to one or more of a person, a place, a landmark, a building, a business, a restaurant, an object, a figure, or an advertisement.

5. The computer implemented method of claim 2, wherein the digital data relates to one or more advertising module, database, digital media, recognition/region association component, feature/information display component, or information associated with digital media.

6. The computer implemented method of claim 1, wherein users can share posts, and posts that refer to and/or embedded within another post, with no additional digital media, links, or text.

7. The computer implemented method of claim 1, wherein posts and posts that refer to and/or embedded within another post are created through an API.

8. The computer implemented method of claim 1, wherein the user application is used with a user device for accessing one or more posts and/or posts that refer to and/or are embedded within another post.

9. The computer implemented method of claim 1, wherein posts comprise one or more documents, digital images, digital video, sounds, digital albums, graphics, augmented representation, links, events, articles, apps, text while also containing one, a plurality and/or combination of data, metadata, metatags, EXIF data, keyword tags, hashtags, comments, favorites, text, links, location, entities, objects, entries, places, and users.

10. The computer implemented method of claim 1 wherein posts that refer to and/or embedded within any part of another post contain referencing data.

11. The computer implemented method of claim 1 wherein up-level/down-level attachment and detachment defines programmed links between user created posts and digital media items; locally stored and/or web based; including posts that refer to and/or are embedded within another post.

12. A computer implement method for embedding posts within any part of another post, the method comprising:
providing a user application for creating posts that refer to previously created posts;
providing a database system for storing user created posts; and
creating and managing programmed links between user created posts, wherein users interacting with the user application can access posts that refer to and/or are embedded within another post.

13. The computer implemented method of claim 12, wherein the database system stores a plurality of data items each having associated digital data relating to one or more of user basic information, user favorites, user profile, user relationship, user interest, user preferences, or user social connection.

14. The computer implemented method of claim 12, wherein the digital media items comprise digital images, digital albums or digital video.

15. The computer implemented method of claim 14, wherein the digital data relates to one or more of a person, a place, a landmark, a building, a business, a restaurant, an object, a figure, or an advertisement.

16. The computer implemented method of claim 14, wherein the digital data relates to one or more advertising module, database, digital media, recognition/region association component, feature/information display component, or information associated with digital media.

17. The computer implemented method of claim 12, wherein users can share posts, and posts that refer to and/or embedded within another post, with no additional digital media, links, or text.

18. The computer implemented method of claim 12, wherein posts and posts that refer to and/or embedded within another post are created through an API.

19. The computer implemented method of claim 12, wherein the user application is used with a user device for accessing one or more posts and/or posts that refer to and/or are embedded within another post.

20. The computer implemented method of claim 12, wherein posts comprise one or more documents, digital images, digital video, sounds, digital albums, graphics, augmented representation, links, events, articles, apps, text while also containing one, a plurality and/or combination of data, metadata, metatags, EXIF data, keyword tags, hashtags, comments, favorites, text, links, location, entities, objects, entries, places, and users.

21. The computer implemented method of claim 12 wherein posts that refer to and/or embedded within any part of another post contain referencing data.

22. The computer implemented method of claim 12 wherein up-level/down-level attachment and detachment defines programmed links between user created posts and digital media items; locally stored and/or web based; including posts that refer to and/or are embedded within another post.

23. A system of managing posts for interacting with web based digital media items, comprising:
one or more user interface devices each operating using an application for creating posts that refer to web based digital media items and/or to previously created posts;
a database system for storing user created posts; and
a programmed processing system in operative communication with user interface devices and the database system for creating and managing programmed links between user created posts and web based digital media items, wherein users interacting with the user interface devices can access posts that refer to and/or are embedded within another post.

24. The system of claim 23, wherein the database system stores a plurality of data items each having associated digital data relating to one or more of user basic information, user favorites, user profile, user relationship, user interest, user preferences, or user social connection.

25. A system for embedding posts within any part of another post, comprising:
one or more user interface devices each operating using an application for creating posts that refer to previously created posts;
a database system for storing user created posts; and
a programmed processing system in operative communication with user interface devices and the database system for creating and managing programmed links between user created posts, wherein users interacting with the user application can access posts that refer to and/or are embedded within another post.

26. The system of claim 25, wherein the database system stores a plurality of data items each having associated digital data relating to one or more of user basic information, user favorites, user profile, user relationship, user interest, user preferences, or user social connection.
